(19) United States
(12) Patent Application Publication
(10) Pub. No.: US 2016/0306126 A1
(43) Pub. Date: Oct. 20, 2016

(54) TOOL FOR PREPARING A CABLE FOR TERMINATION

(71) Applicants: COMMSCOPE CONNECTIVITY BELGIUM BVBA, Kessel-Lo (BE); TYCO ELECTRONICS (SHANGHAI) CO., LTD., Shanghai (CN)

(72) Inventors: Danny Willy August VERHEYDEN, Gelrode (BE); Bart VOS, Geel (BE); Cristian-Radu RADULESCU, Liege (BE); Philip Alan MADDEN, Brasschaat (BE); Tim RUYTJENS, Mortsel (BE); Daokuan ZHANG, Shanghai (CN); Liming WANG, Shanghai (CN); Dong XUE, Shanghai (CN)

(21) Appl. No.: 15/102,207

(22) PCT Filed: Dec. 5, 2014
(86) PCT No.: PCT/CN2014/093134

§ 371 Date: Jun. 6, 2016

Related U.S. Application Data
(60) Provisional application No. 61/913,071, filed on Dec. 6, 2013.
(60) Provisional application No. 61/992,685, filed on May 13, 2014.

(51) Int. Cl. G02B 6/38; G02B 6/44; G02B 6/25

(52) U.S. Cl. CPC G02B 6/3898; G02B 6/25; G02B 6/4476; G02B 6/3887

(57) ABSTRACT

A tool for preparing the end of a fiber optic cable for termination to a fiber optic connector can include a hand-held tool capable of scoring the jacket of the cable and cutting the cable. The scoring and cutting operations can be performed in one action or motion. The scoring and cutting locations can be spaced by a predetermined distance to bare a predetermined length of optical fiber. The tool may include a staging area for holding a heat-shrink sleeve, clamp, and boot in alignment while the cable is being processed. The tool also may include a cutting component for cutting strength members of the cable; and a clamp docking station to align the cable with the cutting component.

### RELATED APPLICATION(S)

This application is a PCT International Patent application and claims priority to U.S. Patent Application Ser. No. 61/913,071, filed on 6 Dec. 2013, and 61/992,685, filed on 13 May 2014, the disclosures of which are incorporated herein by reference in their entireties.

### TECHNICAL FIELD

The present disclosure relates generally to telecommunications equipment. More particularly, the present disclosure relates to tools used to prepare an end of a fiber optic cable for termination to a fiber optic connector.

### BACKGROUND

Cable preparation processes are used to prepare a cable prior to terminating the cable with a fiber optic connector. The steps required to prepare a cable for connectorization are typically performed manually by a technician and often require the use of a number of different tools. The length of time required to prepare a cable for termination by a fiber optic connector as well as the precision of the preparation steps is highly dependent upon the skill of the technician preparing the cable for termination. In this regard, advancements are needed to simplify the cable preparation process so as to reduce the time required to perform cable preparation while concurrently providing more consistent and reliable results regardless of the skill of the operator.

### SUMMARY

One aspect of the present disclosure relates to a tool for preparing the end of a fiber optic cable for termination to a fiber optic connector. In certain examples, the tool can include a hand-held tool capable of scoring the jacket of the cable and cutting the cable. In certain examples, the scoring and cutting operations are performed in one action or motion. In certain examples, the scoring and cutting actions are performed such that the optical fiber of the cable extends a predetermined distance beyond the score location without requiring measurement. In certain examples, the tool can also include a cutting component for cutting strength members (e.g., aramid yarn) of the fiber optic cable. In certain examples, the tool can also include structure for mounting a boot, a shape memory sleeve (e.g., a heat-shrink sleeve) and/or a clamp. In certain examples, the clamp can be temporarily clamped on the fiber optic cable to limit axial movement between the optical fiber and the cable jacket during the preparation process.

In certain examples, the tool can include an actuator for simultaneously actuating the scoring and cutting operations. In certain examples, the actuator includes a primary pivotal actuator lever and a secondary pivotal actuator lever that are associated with the scoring operation and the cutting operation, respectively. The primary and secondary pivotal actuator lever are configured to be depressed into the tool body such that depression of the primary pivotal actuator lever causes simultaneous depression of the secondary pivotal actuator lever to simultaneously perform the scoring and cutting operations.

Another aspect of the present disclosure relates to a heating component configured for receiving a fiber optic connector. The heating component is configured to heat the connector so as to shrink a heat-shrink sleeve used to anchor the fiber optic connector relative to its corresponding fiber optic cable. The heating component may include a housing having a slot configured to receive at least portion (e.g., the heat-shrink sleeve) of the fiber optic connector; and one or more heating elements configured to transfer heat to the portion of the connector received in the slot. The heating elements may include Positive Temperature Coefficient (PTC) heaters. The heating elements are operable between a closed position in which the heating elements hold the heat-shrink sleeve therebetween and an open position in which the heating elements are spaced apart to release the sleeve. The heating elements may be biased to the closed position and configured to press the heat-shrink sleeve engaged therebetween as the sleeve shrinks during heating process.

The heating component may further a loading tray movable between an ejected position and an inserted position. In the ejected position, the loading tray is ejected from the housing and configured to receive the fiber optic connector with the heat-shrink sleeve outside the housing. In the inserted position, the loading tray is inserted into the housing to place the connector within the housing. Once the loading tray is inserted into the housing, the heating elements may be operated to engage the heat-shrink sleeve for heating process. The heating component may further include one or more batteries for providing power to the heating elements, and one or more fans configured to cool the portion of the connector heated by the heating elements. The heating component may further include a solenoid control system for controlling the loading tray and the heating elements. The heating component may be detachably mounted or docked to a connector installation tool configured to automatically install a fiber optic connector on the end of the cable.

A variety of additional aspects will be set forth in the description that follows. The aspects relate to individual features and to combinations of features. It is to be understood that both the forgoing general description and the following detailed description are explanatory only and are not restrictive of the broad inventive concepts upon which the examples disclosed herein are based.

### BRIEF DESCRIPTION OF THE DRAWINGS

FIG. 1 is a perspective view of a cable preparation tool in accordance with the principles of the present disclosure;

FIG. 2 is another perspective view of the cable preparation tool of FIG. 1;

FIG. 3 is a front view of the cable preparation tool of FIG. 1;

FIG. 4 is a back view of the cable preparation tool of FIG. 1;

FIG. 5 is a top view of the cable preparation tool of FIG. 1;

FIG. 6 is a bottom view of the cable preparation tool of FIG. 1;

FIG. 7 is a left end view of the cable preparation tool of FIG. 1;

FIG. 8 is a right end view of the cable preparation tool of FIG. 1;

FIG. 9A is a perspective view of another cable preparation tool in accordance with the principles of the present disclosure in a closed position;

FIG. 9B is a perspective view of the cable preparation tool of FIG. 9A in an open position;

FIG. 10A is another perspective view of the cable preparation tool of FIGS. 9A and 9B in the closed position;

FIG. 10B is another perspective view of the cable preparation tool of FIGS. 9A and 9B in the open position;

FIG. 11 is a perspective view of a heating component in accordance with the principles of the present disclosure;

FIG. 12 is another view of the heating component of FIG. 11;

FIG. 13 is a transverse cross-sectional view of a cable that can be prepared using components in accordance with the principles of the present disclosure;

FIG. 14 is a transverse, cross-sectional view of another cable that can be prepared using components in accordance with the principles of the present disclosure;

FIGS. 15-31 illustrate a sequence of steps for terminating the end of a fiber optic cable with a fiber optic connector, at least some of the steps involve using the cable preparation tool of FIG. 1, the heating component of FIG. 11 and a connectorization tool to connectorize the fiber optic cable of FIG. 13; and

FIGS. 32-45 illustrate another sequence of steps for terminating the end of a fiber optic cable with a fiber optic connector, at least some of the steps involve using the cable preparation tool of FIG. 9, the heating component of FIG. 11 and a connectorization tool to connectorize the fiber optic cable of FIG. 14.

FIG. 46 is a perspective view of another example cable preparation tool in accordance with the principles of the present disclosure;

FIG. 47 is another perspective view of the cable preparation tool of FIG. 46;

FIG. 48 is yet another perspective view of the cable preparation tool of FIG. 46;

FIG. 49 is yet another perspective view of the cable preparation tool of FIG. 46;

FIG. 50 is a cross-sectional view of the cable preparation tool of FIG. 46 in a first position;

FIG. 51 is a cross-sectional view of the cable preparation tool of FIG. 46 in a second position;

FIGS. 52, 53A and 53B illustrate another example heating component in accordance with the principles of the present disclosure.

FIGS. 53C and 53D illustrate an example heating elements used in the heating component in accordance with the principles of the present disclosure.

FIGS. 54-55 illustrate yet another example heating component in accordance with the principles of the present disclosure.

FIGS. 56A-56G illustrate different types of blades used in the cable preparation tool according to the principles of the present disclosure.

FIGS. 57A and 57B illustrate an example operation of the blades.

FIGS. 58A and 58B illustrate example operations of the V-shaped blades as shown in FIG. 56A.

FIGS. 59A and 59B illustrate example operations of the U-shaped blades as shown in FIGS. 56B-56F.

FIGS. 60A-60G illustrate an example heater use case for use with the heating component.

FIG. 61 is a perspective view of another example cable preparation tool in accordance with the principles of the present disclosure.

FIG. 62 is a cross sectional view of the cable preparation tool of FIG. 61.

FIG. 63 is an exploded view of the cable preparation tool of FIG. 61.

FIG. 64 illustrates an example first cutting structure.

FIG. 65 is an enlarged view of the first cutting structure of FIG. 64.

FIG. 66 illustrates an example scissor blade of the first cutting structure of FIG. 64.

FIG. 67 illustrates an example combination of scissor blades of the first cutting structure of FIG. 64.

FIG. 68 illustrates an example second cutting structure.

FIGS. 69A-69C illustrate an example cable clamp.

FIGS. 70A-70E illustrate an example operation of the cable clamp of FIGS. 69A-69C.

FIG. 71 illustrates an example scoring blade of a scoring structure of FIG. 61.

FIGS. 72A and 72B illustrate an example structure for preventing a cable from being blocked in a blade of the scoring structure.

### DETAILED DESCRIPTION

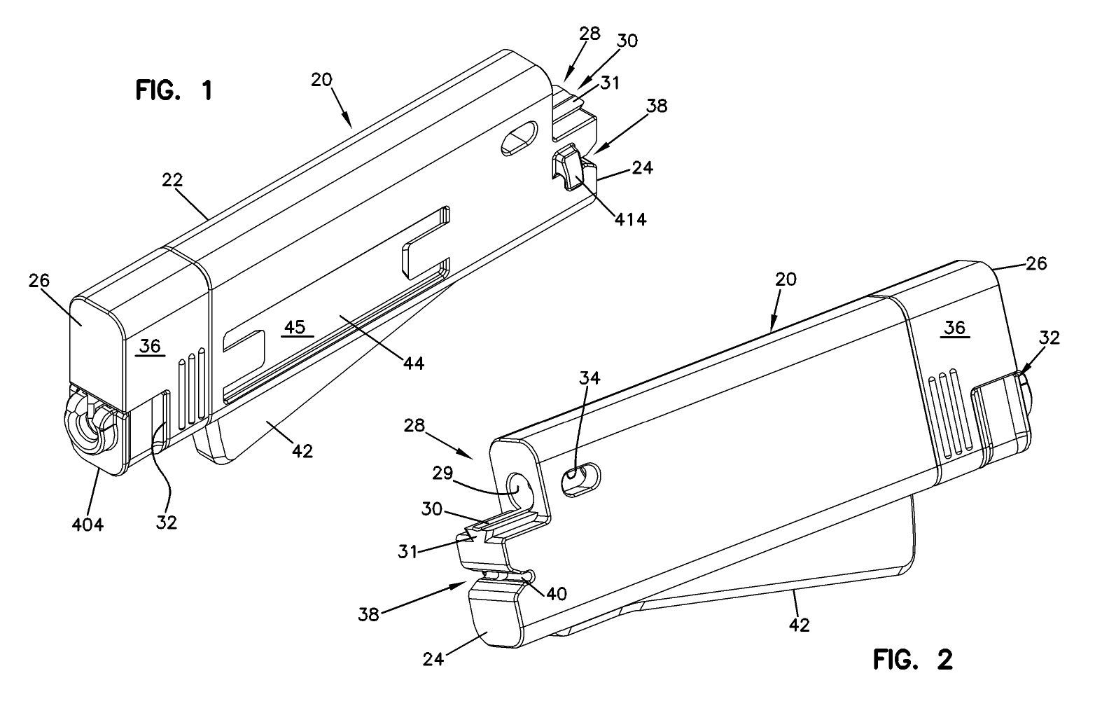

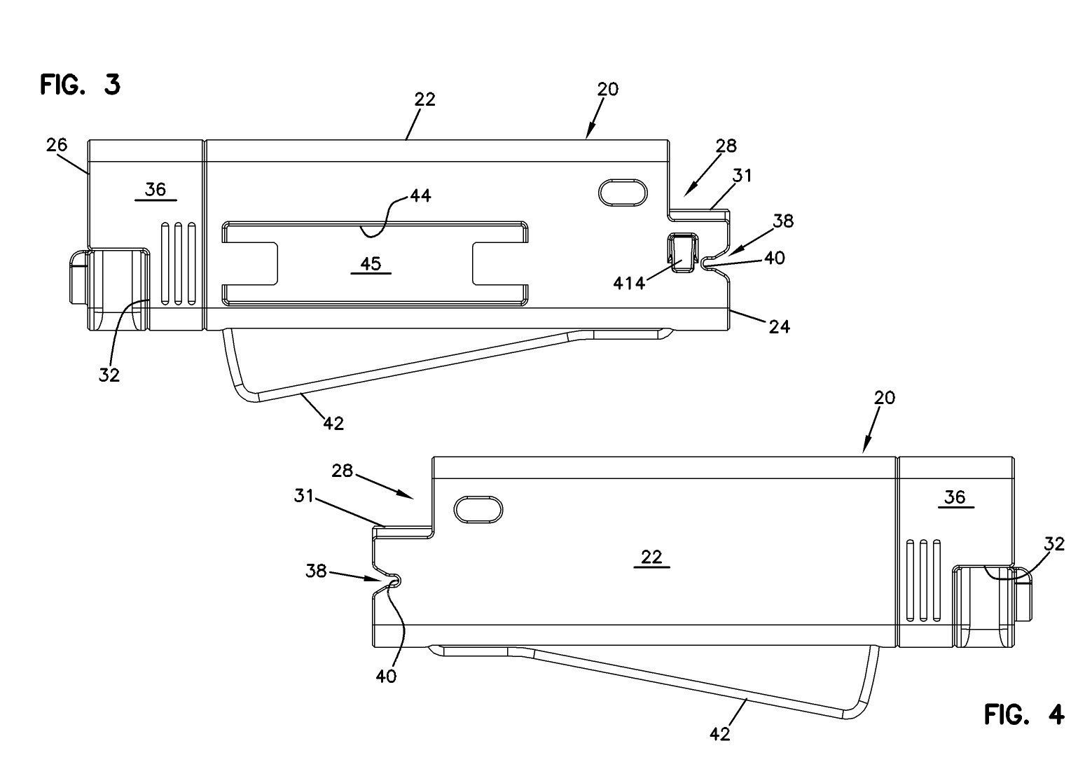

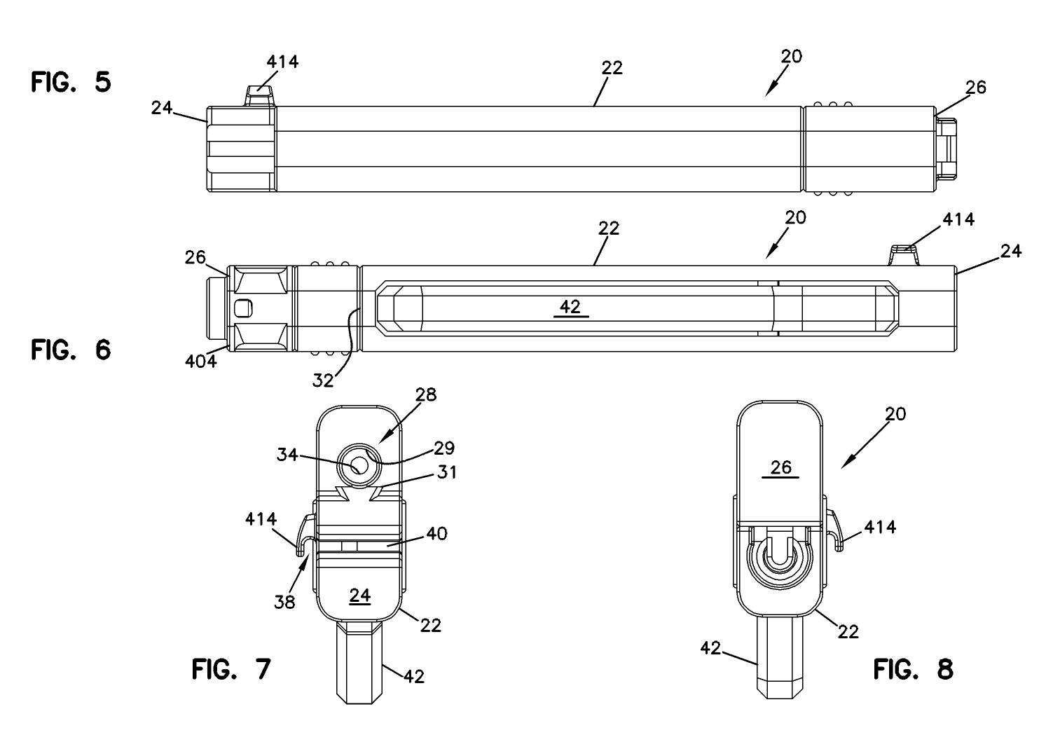

FIGS. 1-8 illustrate a cable preparation tool 20 in accordance with the principles of the present disclosure. The cable preparation tool 20 is configured for preparing the end of a fiber optic cable such that the fiber optic cable can be terminated by a fiber optic connector. The cable preparation tool 20 includes a housing 22 that is sized to be hand-held. In the depicted example, the housing 22 is generally rectangular in shape and has an elongated length that extends between a first end 24 and a second end 26. The cable preparation tool 20 includes a component pre-assembly location 28 positioned at the first end 24 of the housing. The component pre-assembly location 28 includes a sleeve receptacle 29 positioned within the housing 22 for receiving and holding a heat-shrink sleeve. The component pre-assembly location 28 also includes a clamp mounting location (also referred to herein as a clamp mounting pocket) 30 positioned at the first end 24 of the housing 22 directly above the sleeve receptacle 29. The clamp mounting location 30 can include a retaining structure such as a dovetail-shaped projection 31 that mates with a corresponding dovetail-shaped groove in the clamp (e.g., see clamp 404 of FIG. 1). The cable preparation tool 20 further includes a clamp storage location 32 located at the second end 26 of the housing 22. The clamp storage location can include a clamp retaining structure. The cable preparation tool 20 further includes a cable receiving passage 34 that extends through the housing 22 lengthwise between the first and second ends 24, 26. The cable receiving passage 34 aligns with the sleeve receptacle 29 and the clamp mounting location 30 and extends to a cable viewing location 36. In an example, the viewing location 36 includes a window defined by the housing 22. In another example, a portion of the tool housing 22 is transparent.

The cable preparation tool 20 further includes structure for cutting and scoring a fiber optic cable. For example, the cable preparation tool 20 includes a first cutting structure disposed within the housing 22 and a scoring structure positioned within the housing 22. The first cutting structure and the scoring structure can be internally positioned within the housing 22 and can include for more movable blades that are able to perform the desired cutting and/or scoring function. For example, the first cutting structure can include one or more movable blade that is positioned at a desired spacing along the cable receiving passage 34 from the scoring structure and that is movable against a stop structure or across another blade for severing the cable at a desired location. The severing location provided by the first cutting structure is preferably located a first spacing along the passage 34 from the scoring location.

As used herein, a “cable scoring” structure is defined as a structure capable of fully or partially cutting through a jacket of a cable to provide a cut or weakened location in the jacket that facilitates stripping of the jacket. One example of a cable score is a ring cut that extends partially or fully through the cable jacket. The scoring structure can include one or more blades that score the jacket with a ring-cut without cutting the optical fiber or strength members of the fiber optic cable. The blades of the scoring structure typically do not extend into the cable deeper than an inner diameter of the cable jacket. As described above, the scoring location is spaced a predetermined distance from the first cutting location such that after cutting and scoring, the end portion of the jacket that extends beyond the ring cut (i.e., score line) can be removed from the cable with the remaining optical fiber and the strength members extending the predetermined length beyond the ring cut location (which defines the new end of the cable jacket). The desired predetermined length of optical fiber that extends beyond the score location can be provide without requiring the technician to perform a separate measurement.

The cable preparation tool 20 can further include a second cutting structure adapted for severing the fiber optic cable and/or for severing the strength members of the fiber optic cable. In the depicted example, the second cutting structure 38 is located at the first end 24 of the housing 22. The second cutting structure includes a slot 40 for receiving the fiber optic cable and/or the strength members of the fiber optic cable, and one or more blades that are movable relative to the slot 40 for severing the fiber optic cable or strength members positioned within the slot 40.

In certain examples, the first cutting structure, the scoring structure and the second cutting structure are all actuated by a common actuator 42. In one example, the actuator 42 includes a handle that is positioned at a side of the housing 22 and that is actuated by manually pressing the handle into the housing 22. The handle can be pivotally movable relative to the housing 22. In one example, depression of the handles causes the first cutting structure, the second cutting structure and the scoring structure to be concurrently actuated.

The cable preparation tool 20 further includes a docking station 44 in the form of a receptacle 45 defined at a major side of the housing 22. The docking station 44 is in general alignment with the second cutting structure 38. In one example, the handling dock 44 is configured to receive and hold a clamp used to fix the cable jacket relative to the optical fiber of the cable during the cable preparation process.

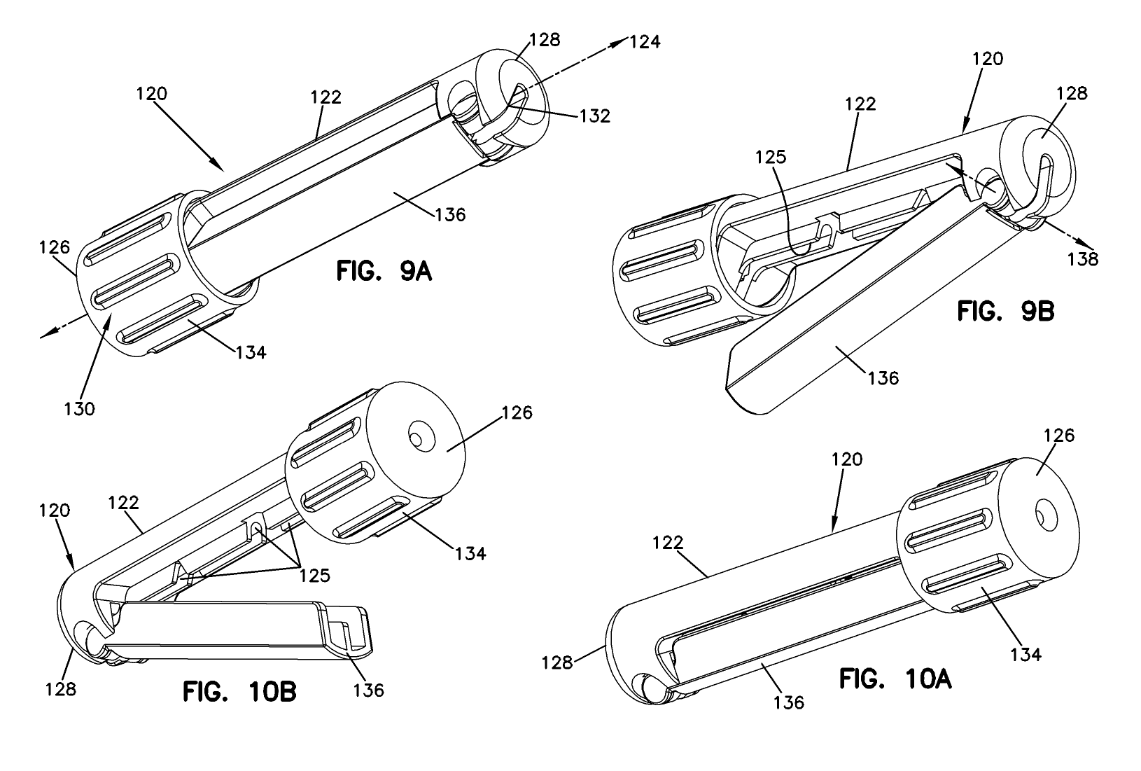

FIGS. 9A, 9B, 10A, and 10B show another cable preparation tool 120 in accordance with the principles of the present disclosure. The cable preparation tool 120 is sized to be held in a technician's hand and therefore can be referred to as a “hand-held” tool. The cable preparation tool 120 includes an elongate main body 122 that is elongated along an axis 124. The elongated main body 122 includes a first end 126 positioned opposite from a second end 128. The cable preparation tool 120 includes a cable scoring structure 130 mounted at the first end 126 of the elongated main body 122 and a cable cutting structure 132 positioned adjacent the second end 128 of the elongated main body 122. The cable scoring structure 130 is depicted including a rotary actuator 134 such a rotary sleeve mounted at the first end 126 of the main body 122. The rotary actuator 134 can be manually rotated about the axis 124. In certain examples, the rotary actuator 134 can be configured to rotate or otherwise move a scoring blade circumferentially about the axis 124 so as to score a cable pre-loaded into the cable preparation tool 120.

The cable cutting structure 132 is depicted including an actuator in the form of a pivotal handle 136. The pivotal handle 136 is pivotally connected to the main body 122 adjacent the second end 128 of the main body 122. The pivotal handle 136 is movable relative to the main body 122 about a pivot axis 138. The pivotal handle 136 can be moved relative to the main body 122 about the axis 138 between a closed position (see FIGS. 9A and 10A) and an open position (see FIGS. 9B and 10B). A cutting blade can be attached to the pivotal handle 136 or otherwise moved by the pivotal handle 136. The cutting blade can be configured to sever an optical cable loaded within the cable preparation tool 120 when the pivotal handle 136 is moved from the open position to the closed position.

The cable can be loaded into the cable preparation tool 120 by inserting the cable into a cable receiving passage 125 that extends lengthwise through the tool 120. In one example, the passage 125 aligns along the axis 124 and extends completely through the tool 120. In certain examples, a predetermined spacing is defined between the scoring location provided by the cable scoring structure 130 and the cutting location defined by the cable cutting structure 132. Thus, the tool can prepare a cable with a predetermined length of optical fiber and/or strength members that extend beyond the score location without requiring a manual measurement by the technician.

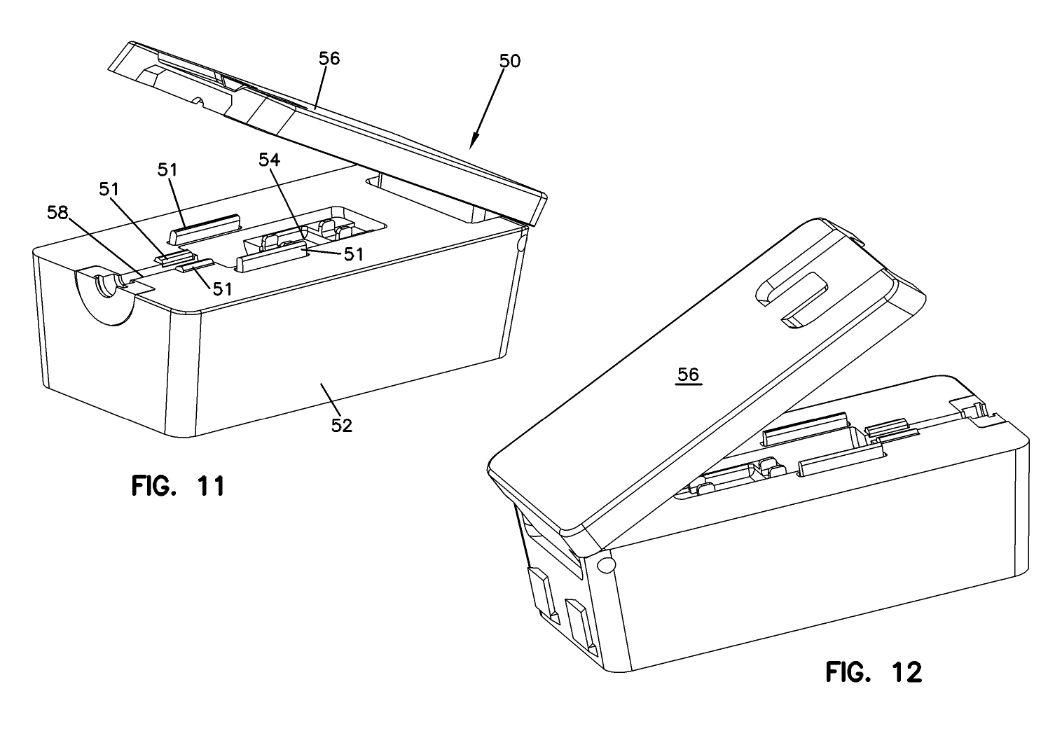

FIGS. 11 and 12 show an example heating component 50 (e.g., a portable oven, heater, etc.) in accordance with the principles of the present disclosure. The heating component 50 includes a base 52 enclosing one or more heating elements 51 (e.g., resistive heating elements or other heating elements). In certain examples, heating elements can be powered by electricity provided by batteries mounted within the base 52. In other examples, the component 50 can include a power cord. The base 52 further includes a connector receptacle 54 provided at a top side of the base 52. The connector receptacle 54 has an open top side that is open when a cover 56 of the heating component 50 is moved relative to the base 52 to an open position. The base 52 further includes a slot 58 at the top side of the base 52. Slot 58 has an open top side and is configured for receiving the fiber optic cable and a heat-shrink sleeve when the connector of the fiber optic cable is positioned within the connector receptacle 54. In certain examples, the heating elements 51 are positioned so as to generally align with or otherwise be adjacent to a heat-shrink sleeve of the fiber optic connector when the fiber optic connector has been loaded into the connector receptacle 54.

By loading the fiber optic connector into the connector receptacle 54, closing the cover 56, and activating the heating elements, the heating component 50 functions as a portable oven for heating at least the heat-shrink tube to a temperature suitably high for causing the heat-shrink tube to shrink down upon the connector and the fiber optic cable jacket so as to secure the fiber optic connector to the fiber optic cable. In certain examples, the heat-shrink tube includes heat sensitive adhesive provided therein. In certain examples, the heat-shrink tube is made of a heat memory material that shrinks when heated to a predetermined temperature. In certain examples, a temperature sensitive adhesive within the heat-shrink tube is activated at a temperature less than or equal to the temperature required to shrink the heat-shrink tube. In certain examples, the heat-shrink tube and the adhesive provided therein function to secure strength members of the fiber optic cable to the fiber optic connector so as to enhance the axial pull strength of the interface between the fiber optic cable and the fiber optic connector. In this way, the fiber optic connector is securely anchored to the fiber optic cable. The oven, through the positioning of the heating elements, can provide localized heating to the heat shrink sleeve without apply substantial heat to the majority of the connector. The heating component 50 can also include a clamp receptacle for receiving a clamp secured to the fiber optic cable.

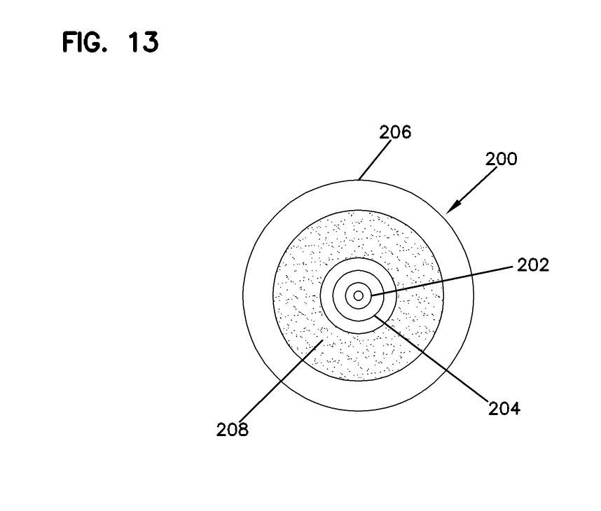

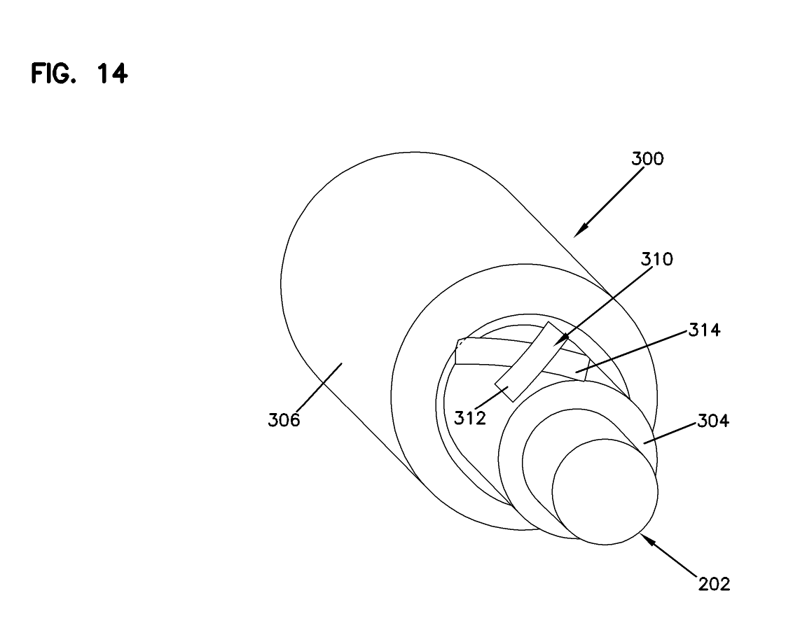

FIG. 13 is a transverse cross-sectional view of an example cable 200 that can be prepared for connection using equipment in accordance with the present disclosure. The cable 200 includes an optical fiber 202 surrounded by a buffer layer 204 (e.g., a loose buffer layer, a tight buffer layer or a semi-type buffer layer). The optical fiber can include a core, a cladding layer that surrounds the core, and a polymeric coating layer. The cable 200 further includes an outer jacket 206 and a tensile reinforcing layer 208 positioned between the buffer layer 204 and the jacket 206. In certain examples, the tensile reinforcing layer 208 includes a plurality of strands of reinforcing material. In one example, the reinforcing material can include reinforcing yarns such as aramid yarns.

FIG. 14 illustrates another fiber optic cable 300 suitable for being prepared for connectorization with equipment in accordance with the principles of the present disclosure. The cable 300 includes an optical fiber 202. In one example, the optical fiber 202 can include a core, a cladding layer surrounding the core, and a polymeric coating layer surrounding the cladding layer. In certain examples, the core has an outer diameter generally in the range of 8 to 12 microns, the cladding layer has an outer diameter in the range of 110 to 140 microns, and the coating layer has an outer diameter in the range of 200 to 270 microns. The cable 300 further includes a buffer layer 304 that surrounds the optical fiber 302. In one example, the buffer layer 304 has an outer diameter less than 1200 microns, or in the range of 500 to 1200 microns, or in the range of 700 to 100 microns, or about 900 microns. In certain examples, the buffer layer 304 is a tight buffer layer including a low smoke zero halogen material. In certain examples, the cable 300 further includes an outer jacket 306. In certain examples, the outer jacket 306 includes a material such as a low smoke zero halogen material. In certain examples, the outer jacket 306 has an outer diameter less than 3 millimeters, or less than 2.5 millimeters, or less than 2.2 millimeters, or about 2 millimeters.

The cable 300 further includes a tensile reinforcing layer 310 positioned between the outer jacket 306 and the buffer layer 304. In certain examples, the tensile reinforcing layer 310 includes a plurality of reinforcing yarns, filaments or like structures. In certain examples, the tensile reinforcing layer 310 includes two contra-helically wound strands of tensile reinforcing material. In certain examples, the contra-helically wound strands of tensile reinforcing material include first and second reinforcing strands 312, 314 (shown schematically in FIG. 14) that are wrapped in opposite helical directions about the circumference of the buffer layer 304. In certain examples, the outer jacket 306 and the buffer layer 304 are bonded together. In other examples, the cable 300 includes an intermediate layer disposed between the strength layer 310 and the buffer layer 304 or the outer jacket 306. In certain examples, the intermediate layer can be bonded to the buffer layer 304 or the jacket 306 to embed the strength layer 310 therebetween. In certain examples, the fiber 302 is a single mode fiber.

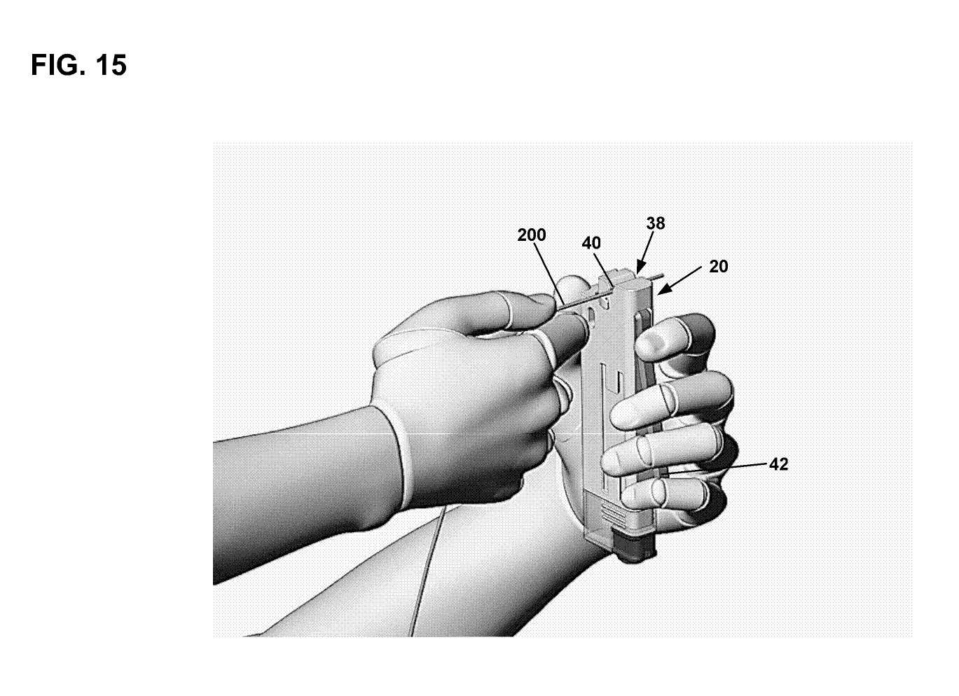

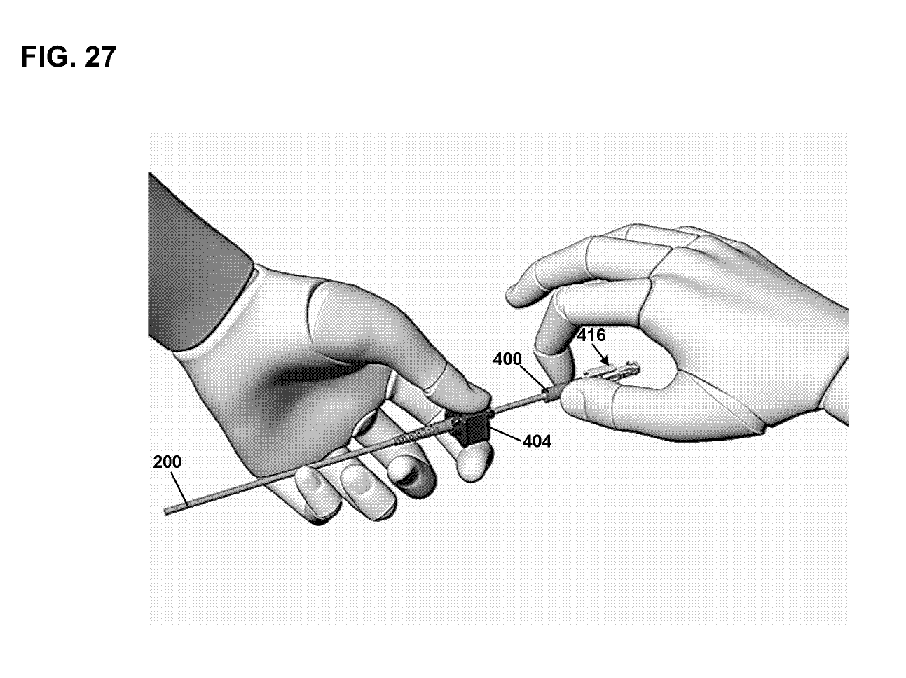

FIGS. 15-31 illustrate a series of process steps for connectorizing the fiber optic cable 200 of FIG. 13 using the cable preparation tool 20 of FIGS. 1-8 (and the operations illustrated in FIGS. 15-31), the heating component 50 of FIGS. 11 and 12 and a connectorization tool. Referring to FIG. 15, the fiber optic cable 200 is initially severed using the cable preparation tool 20 so as to ensure that ends of the optical fiber 202, the jacket 206 and the strength members 208 are all generally aligned with one another. As shown at FIG. 15, the cable 200 can be cut by inserting the cable 200 into the slot 40 of the second cutting structure 38. Once the cable 200 has been inserted into the slot 40, the second cutting structure 38 is actuated by depressing the actuator 42 thereby causing the cable 200 to be severed.

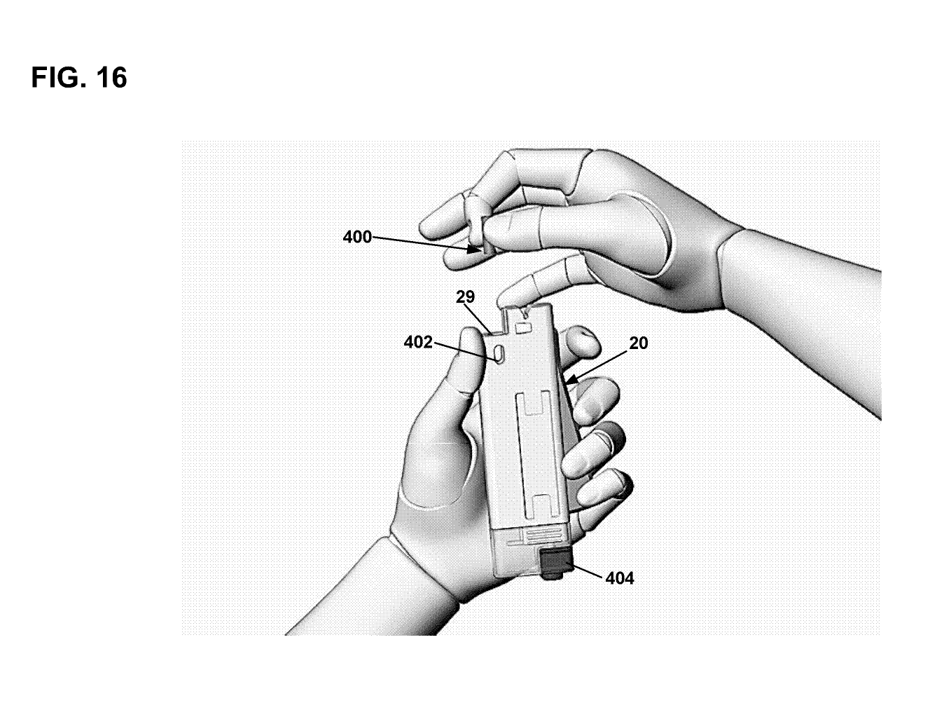

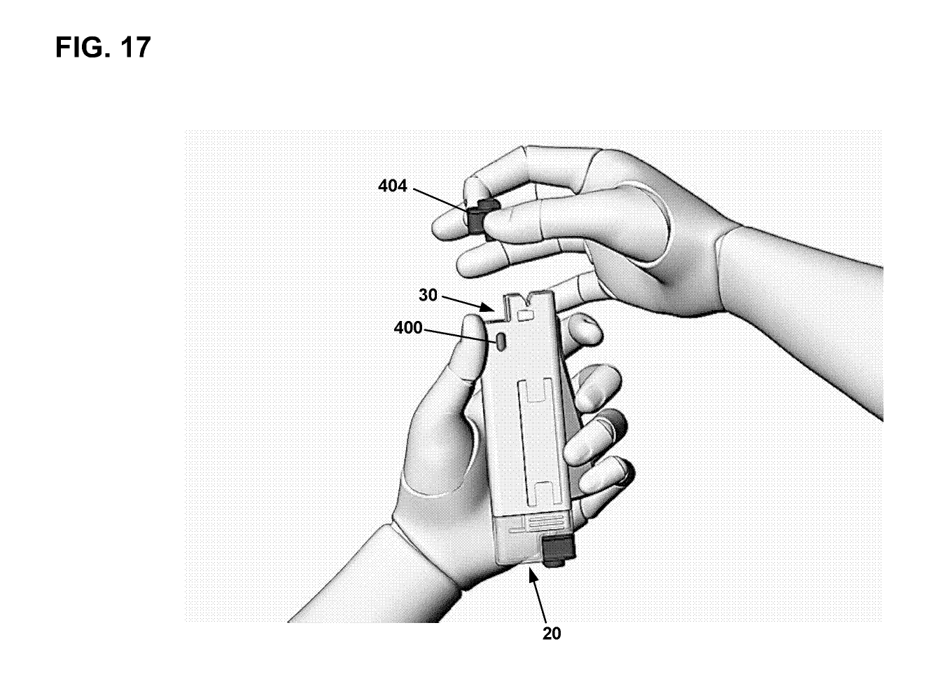

After initially severing the cable 200 as shown at FIG. 15, various components can be loaded onto the cable preparation tool 20. For example, a heat-shrink sleeve 400 can be loaded into the sleeve receptacle 29 of the cable preparation tool 20 (see FIG. 16). The cable preparation tool 20 can include a window 402 that aligns with the sleeve receptacle 29 for providing the technician with a visual indication that the heat-shrink sleeve 400 has been properly inserted within the sleeve receptacle 29. When the heat-shrink sleeve 400 has been properly inserted within the sleeve receptacle 29, the heat-shrink sleeve 400 is visible through the viewing window 402 (see FIG. 17).

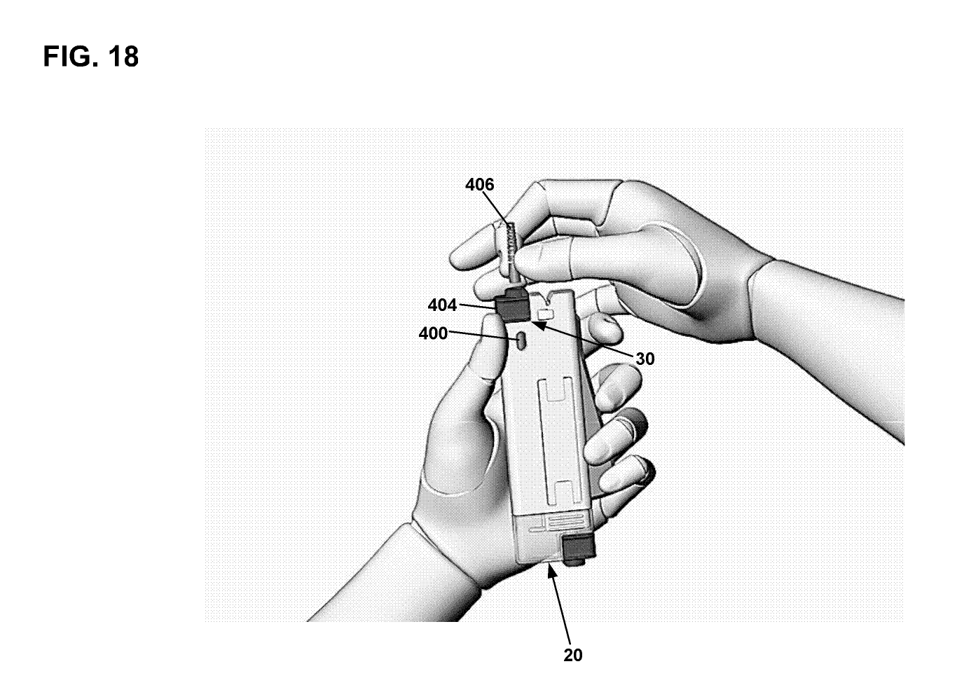

After loading the heat-shrink tube 400 into the sleeve receptacle 29, a cable clamp 404 can be loaded at the clamp mounting location 30 directly above the pre-loaded heat-shrink sleeve 400. For example, the clamp 404 can be removed from storage 32 and loaded at the clamp mounting location 30. In FIGS. 17-24, an extra clamp 404 is shown mounted to the clamp storage 32. FIG. 17 shows the clamp 404 in the process of being loaded at the clamp mounting location 30, and FIG. 18 shows the clamp 404 properly mounted at the clamp mounting location 30. A sliding interlock interface such as a tongue and groove interface can be used to secure the clamp 404 at the clamp mounting location 30. The tongue and groove can have lengths that extend parallel to the cable receiving passage 34.

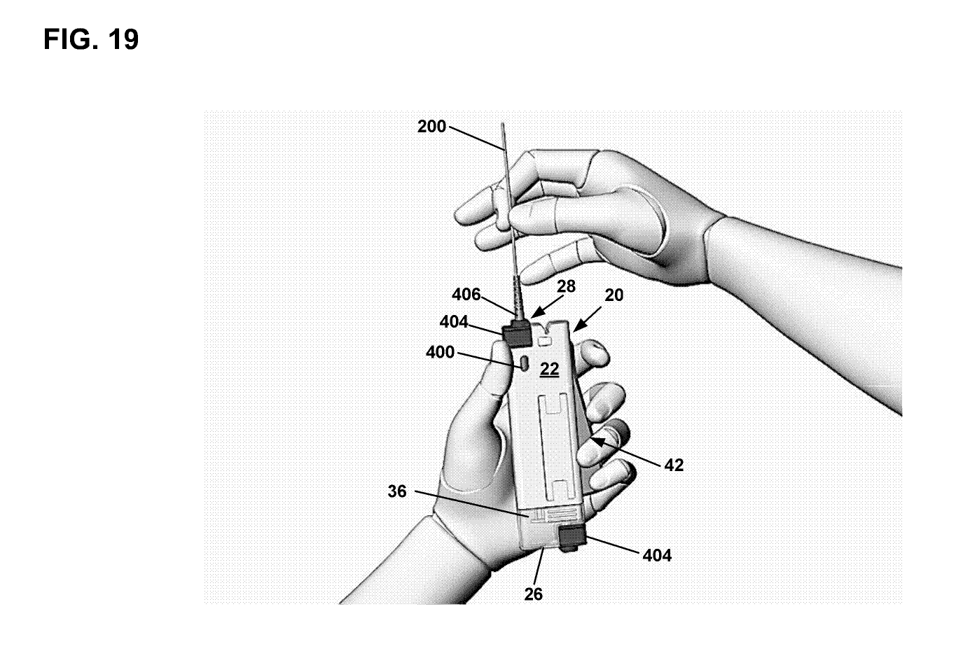

Once the clamp 404 has been loaded at the clamp mounting location 30, a connector boot 406 can be loaded into the clamp 404. FIG. 18 shows the connector boot 406 in the process of being loaded into the cable clamp 404. FIG. 19 shows the cable boot 406 loaded within the cable clamp 404. It will be appreciated that when the heat-shrink sleeve 400, the cable clamp 404 and the connector boot 406 are loaded at the component pre-assembly location 28, each of the components defines a through-passage in alignment with the cable receiving passage 34 of the cable preparation tool 20.

Once the heat-shrink sleeve 400, the cable clamp 404 and the boot 406 have been assembled at the component pre-assembly location 28 of the cable preparation tool 20, the pre-cut cable 200 can be inserted through the aligned components into the cable receiving passage 34 of the cable preparation tool 20 (see FIG. 19). In certain examples, the cable 200 is inserted into the cable receiving passage 34 until the pre-cut end of the cable 200 is visible through the cable viewing location 36 adjacent the second end 26 of the housing 22. The clamp 404 can then be actuated to clamp the cable such that the jacket 206 and the fiber 204 are axially locked relative to one another. The clamp 404 can also apply a clamping or other type of retention force to the shrink-fit tube 400 and the boot 406 such that the cable 200, the clamp 404, the heat-shrink sleeve 400 and the connector boot 406 can all be moved together as a unit.

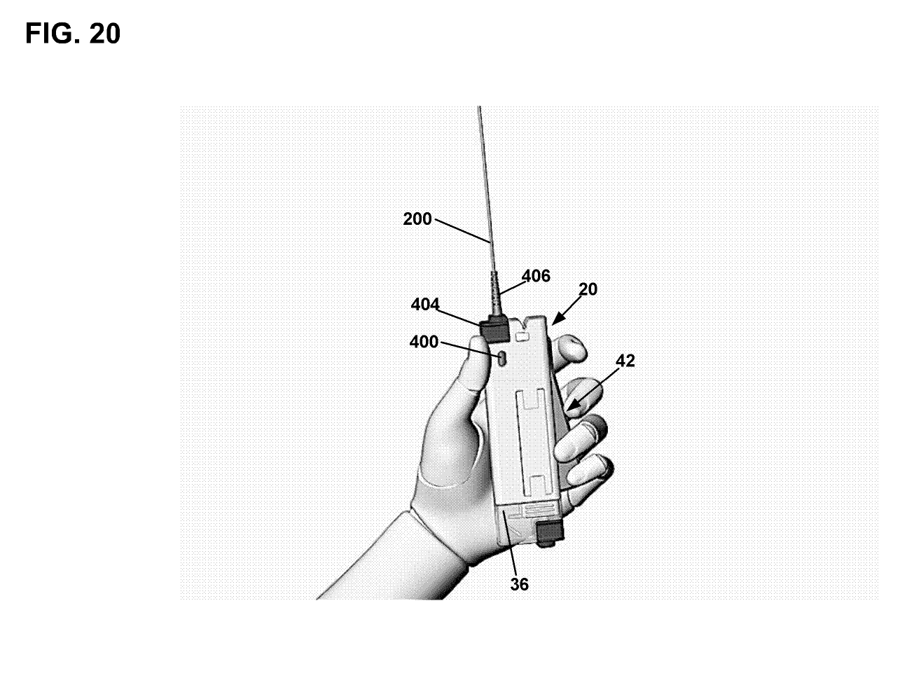

Once the cable 200 has been inserted into the cable receiving passage a sufficient distance that the end of the fiber optic cable 200 is visible at the cable viewing location 36 and the clamp 404 has been actuated, the actuator 42 can be actuated so as to cause the cable 200 to be severed by the first cutting structure of the cable preparation tool 20 and concurrently scored by the cable scoring structure of the cable preparation tool 20. It will be appreciated that the cable scoring structure scores the jacket 206 of the fiber optic cable 200 with a ring-cut that circumferentially cuts the jacket 206 without cutting the strength layer 208 or the buffer tube 204. FIG. 20 shows the actuator 42 being actuated so as to sever the cable 200 and score the jacket 206 of the cable 200.

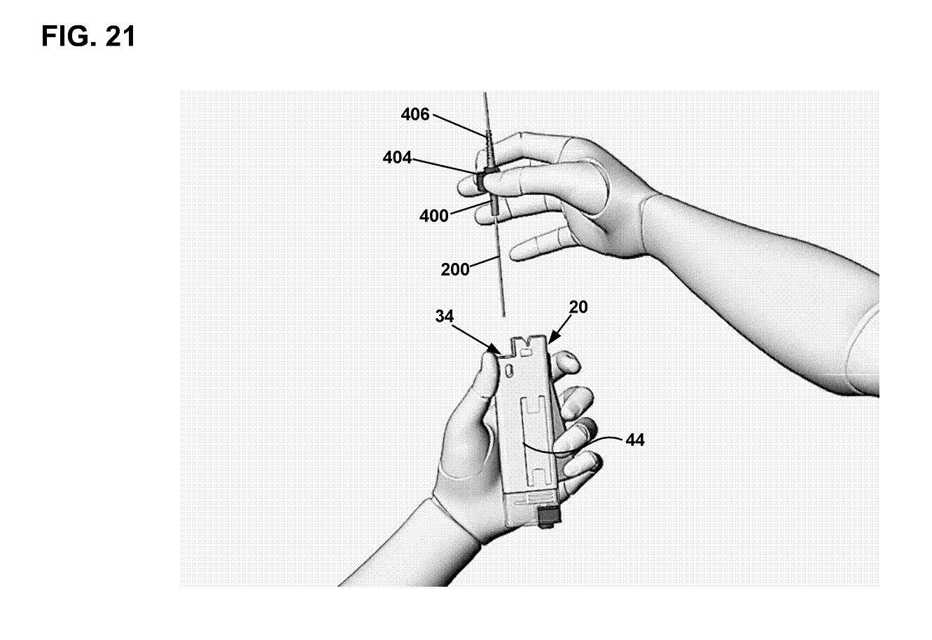

After the severing and scoring action of FIG. 20, the fiber optic cable 200 can be removed from the cable receiving passage 34 by grasping the clamp 404 and drawing the fiber optic cable 200 from the cable receiving passage 34 (see FIG. 21). It will be appreciated that during this removal process, the fiber optic cable 200, heat-shrink sleeve 400, the clamp 404 and the boot 406 are all moved together as a unit.

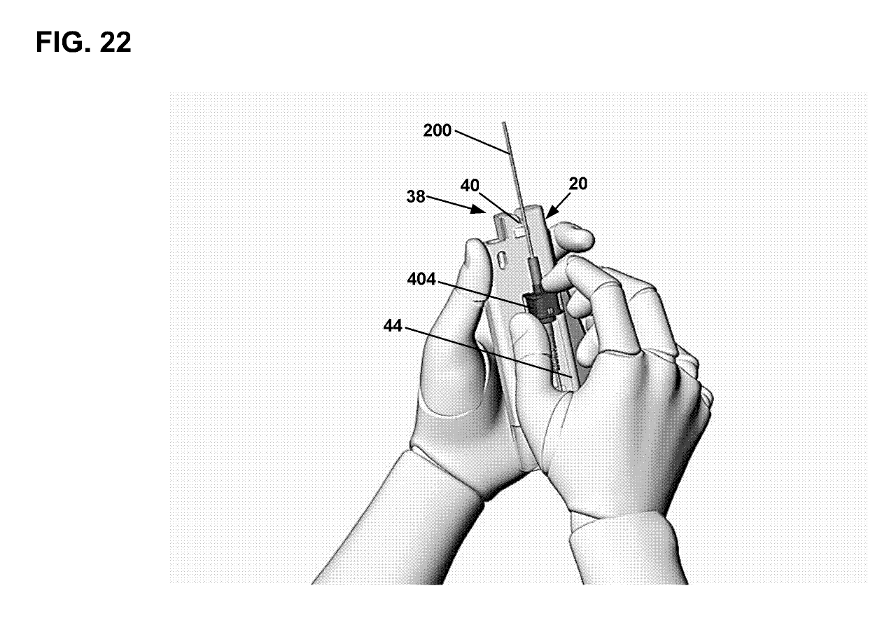

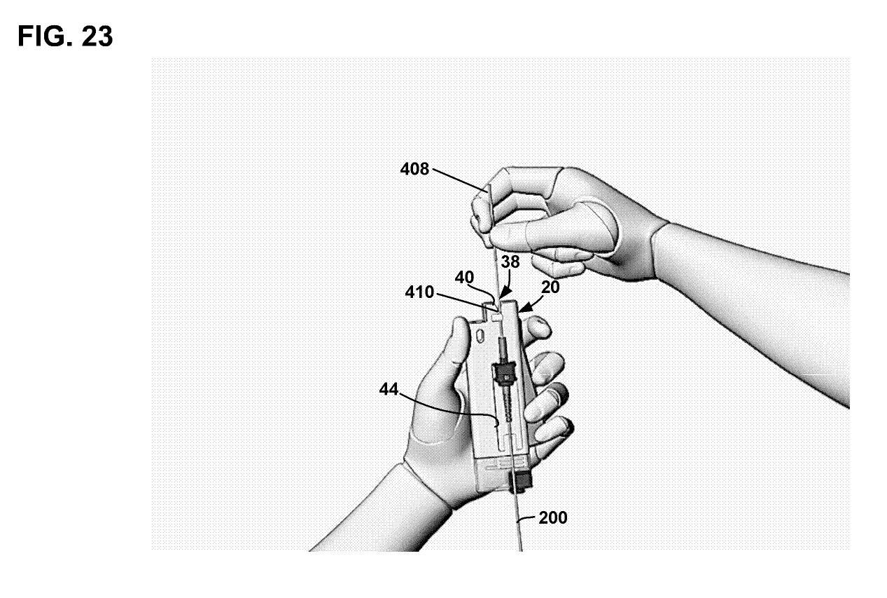

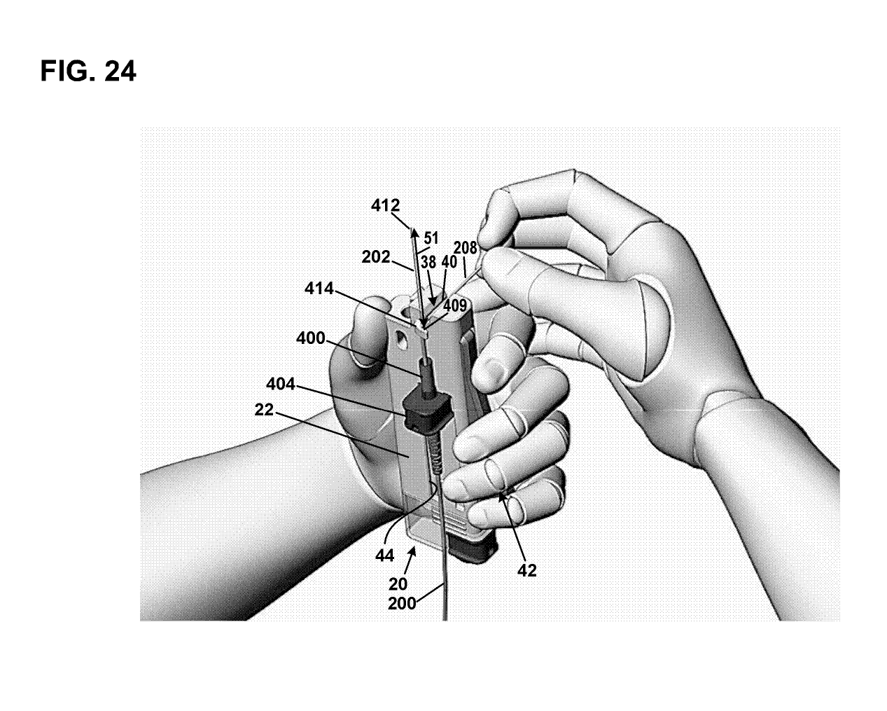

Once the fiber optic cable 200 has been removed from the cable receiving passage 34, the clamp 404 is loaded into the docking receptacle 44 with the end portion of the cable 200 projecting upwardly from the docking station 44. As shown at FIG. 22, the cable 200 generally aligns with the slot 40 of the second cutting station 38 when the clamp 404 is mounted at the docking station 44. With the clamp 404 held at the docking station 44, an end portion 408 of the jacket 206 can be pulled axially from the end of the cable 200 as shown at FIG. 23. It will be appreciated that a ring-cut 410 provided by the scoring structure facilitates allowing the end portion 408 of the jacket 206 to be easily pulled from the end of the cable 200. As shown at FIG. 24, a predefined spacing S1 is defined between the ring-cut 410 (defining the new end 409 of the jacket 206) and an end 412 of the optical fiber 202. This spacing S1 corresponds to the spacing defined between the scoring structure and the first cutting structure within the cable preparation tool 20.

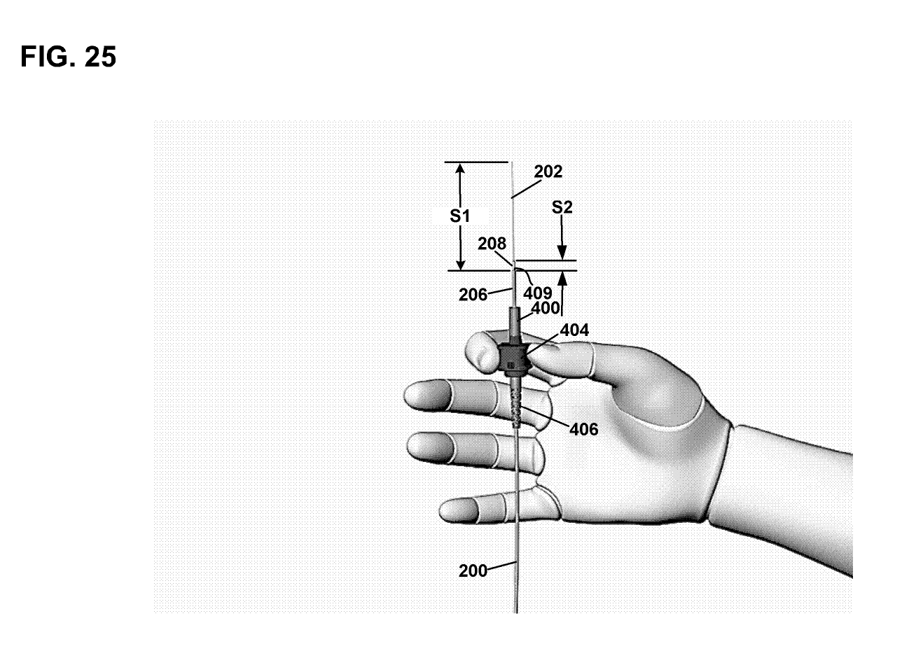

Referring still to FIG. 24, once the end portion 408 of the jacket 206 has been removed from the cable 200, the strength layer 208 and the optical fiber 202 are exposed and the strength layer 208 can be separated from the optical fiber 202 and directed through the slot 40 of the second cutting structure 38. During this process, the clamp 404 continues to be held at the docking station 44 and a hook 414 integrated with the housing 22 can be used to maintain alignment of the end of the cable 200 with the slot 40. With the strength layer 208 positioned within the slot 40, the second cutting structure 38 is manually actuated by the actuator 42 thereby severing the strength layer 208. Thereafter, the cable assembly is removed from the cable preparation tool 20 as shown at FIG. 25.

Referring to FIG. 25, the heat-shrink sleeve 400, the clamp 404 and the boot 406 continue to be mounted on the fiber optic cable 200. Additionally, the end of the fiber optic cable 200 has been prepared such that the optical fiber 202 extends the predetermined spacing S1 from the end 409 of the jacket 206 and the strength layer 208 projects a predetermined spacing S2 beyond the end 409 of the jacket 206.

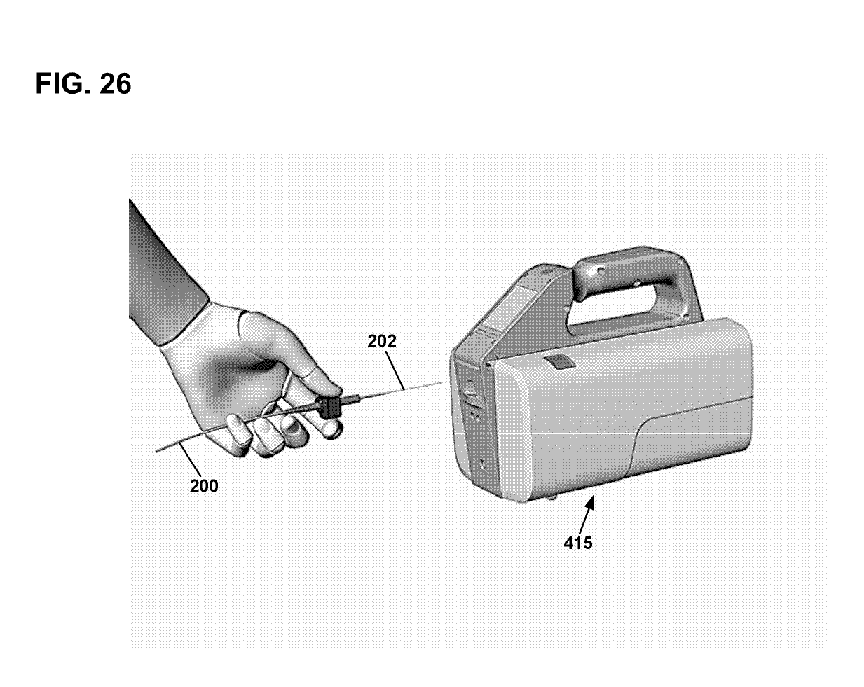

As shown at FIG. 26, the prepared end of the fiber optic cable 200 is then inserted into a connector installationtool 415 that automatically installs a fiber optic connector 416 on the end of the cable 200. An example connectorization tool 415 is disclosed at U.S. patent application Ser. No. 14/000,345 that is hereby incorporated by reference in its entirety (see alsoPCT Publication No. WO2012/112344). The connector installation tool 415 can be configured to cleave the optical fiber, strip the buffer layer and other coatings from the optical fiber, clean the optical fiber, plasma treat an end face of the optical fiber and attach the connector to the optical fiber 202.

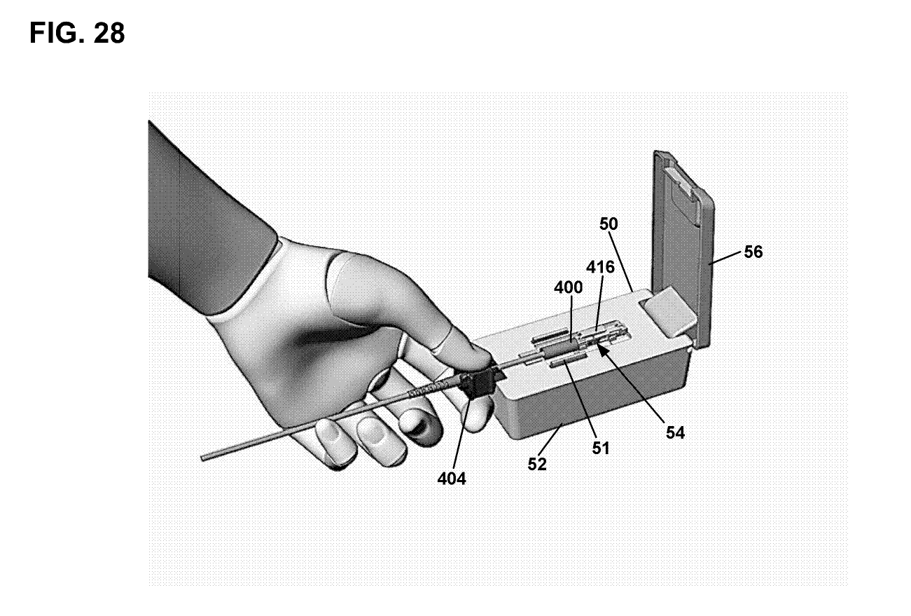

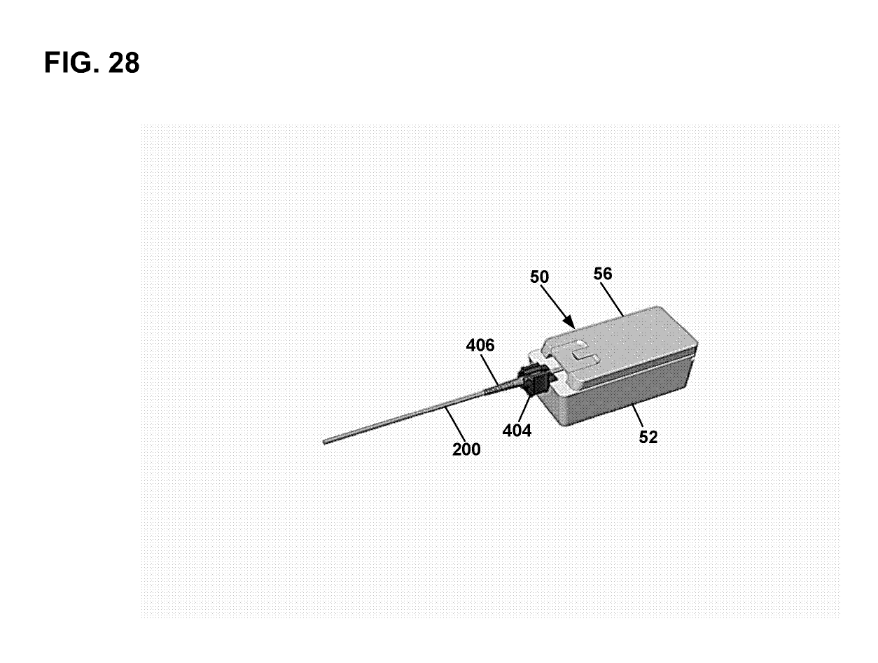

During the insertion process, the cable 200 can be easily handled by grasping the clamp 404. Once a connector 416 has been installed at the end of the fiber optic cable 200 by the connectorization tool 415, the heat-shrink sleeve 400 is disconnected from the clamp 404 and slid toward the connector 416 until the sleeve 400 overlaps a rear end portion of the connector 416. In this configuration, the protruding portions of the strength layer 208 are positioned between the interior of the heat-shrink sleeve 400 and the exterior of the rear portion of the connector body. The connector 416 is then loaded into the connector receptacle 54 of the heating component 50 as shown at FIG. 28. The base 52 of the heating component 50 can also include a notch or receptacle for receiving the clamp 404. With the connector 416 positioned within the connector receptacle 54, the heat-shrink sleeve 400 is also positioned within the connector receptacle 54 and can align with the heating elements 51 of the heating component 50. After loading the connector 416 into the connector receptacle 54, the cover 56 of the heating component 50 is closed as shown at FIG. 29 and the heating component 50 is activated thereby heating the heat-shrink sleeve 400 to a temperature sufficiently high to shrink the heat-shrink sleeve 400 and toactivatethe adhesive within the heat-shrink sleeve 400. The heat-shrink sleeve 400 thereby shrinks down upon the exterior of the jacket 206 and also shrinks down against the rear portion of the fiber optic connector 416 thereby bonding or otherwise securing the exposed end portions of the strength layer 208 to the body of the connector 416. The heat-shrink tube 400 also bonds to the jacket 206. In this way, the connector 416 is securely attached to the cable 200.

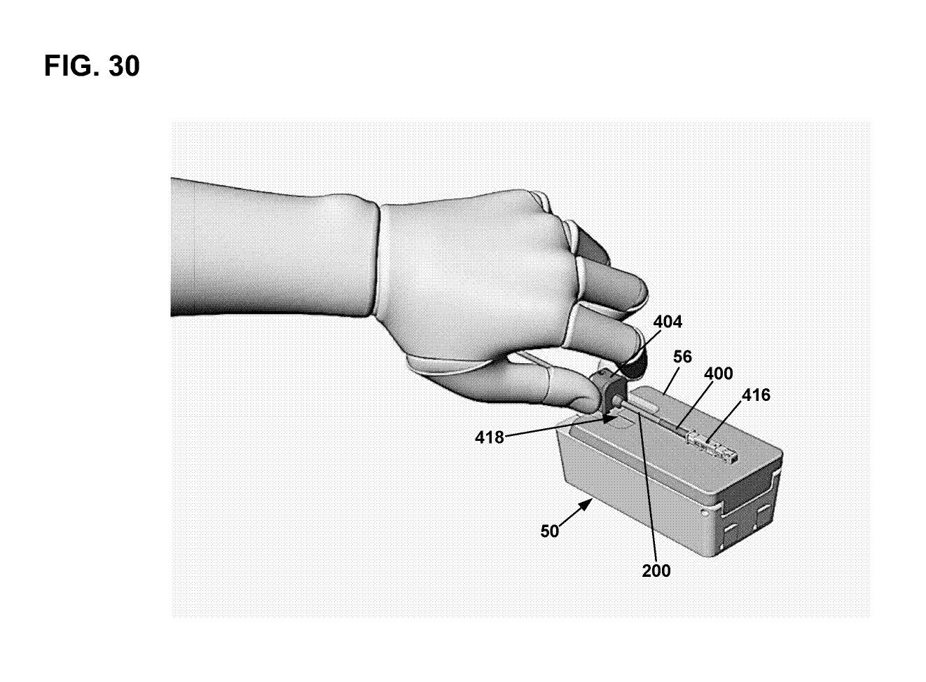

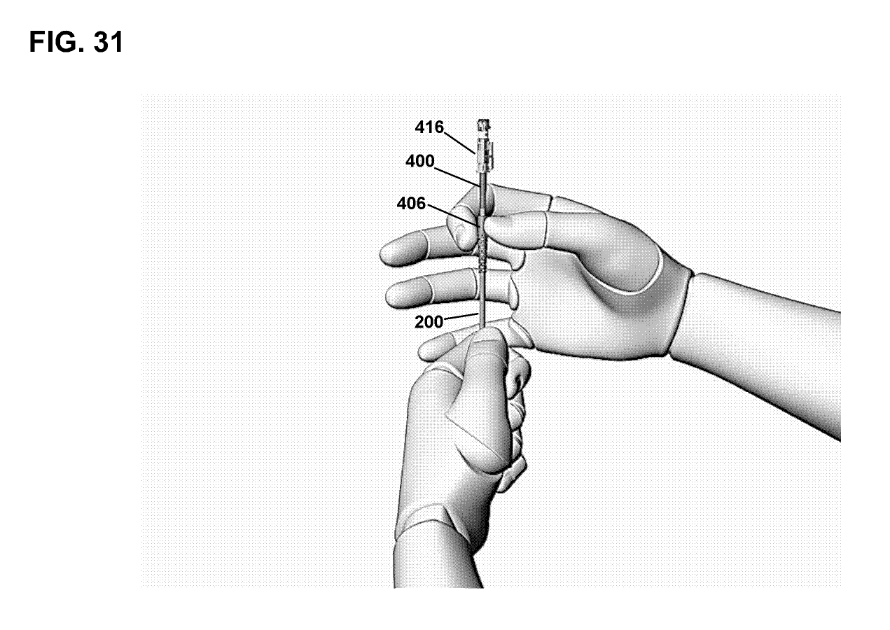

After heating, the connector assembly can be removed from the heating component 50 and cooled. Thereafter, the clamp 404 can be removed from the cable 200. As shown at FIG. 30, a clamp disengagement tool 418 can be incorporated into the top side of the cover 56 of the heating component 50. By engaging the clamp 404 with the disengagement tool 418, the clamp 404 can be disengaged from the cable 200. Thereafter, the boot 406 can be slid up over the heat-shrink sleeve 400, as shown at FIG. 31, to complete the termination process.

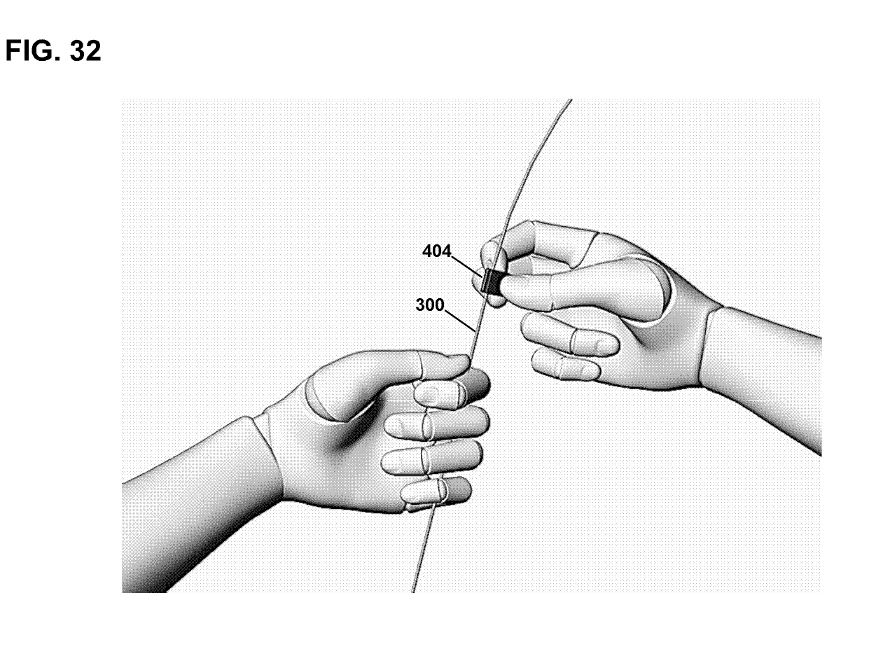

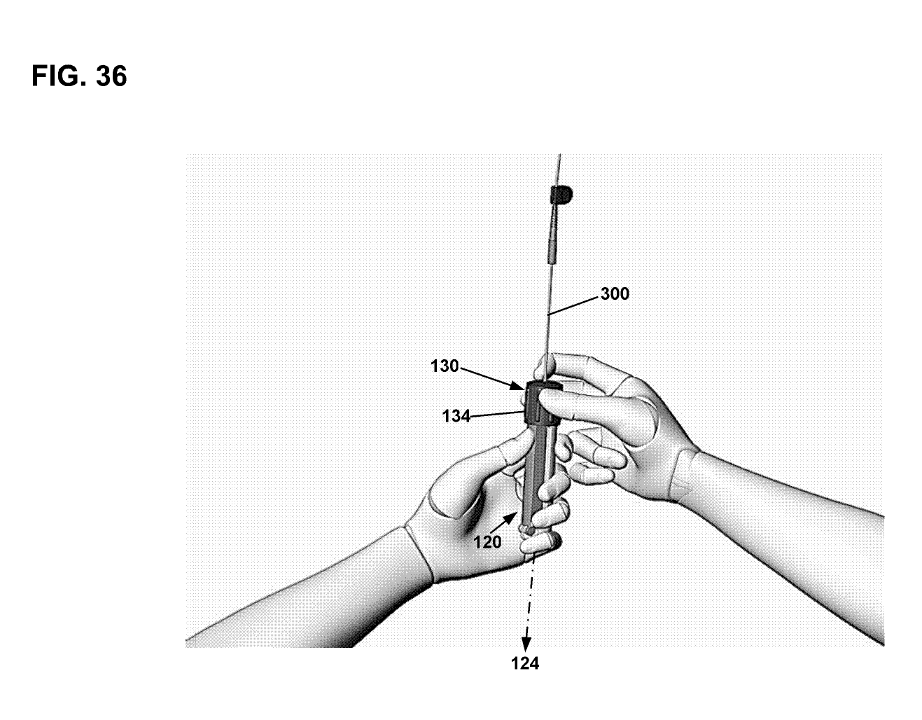

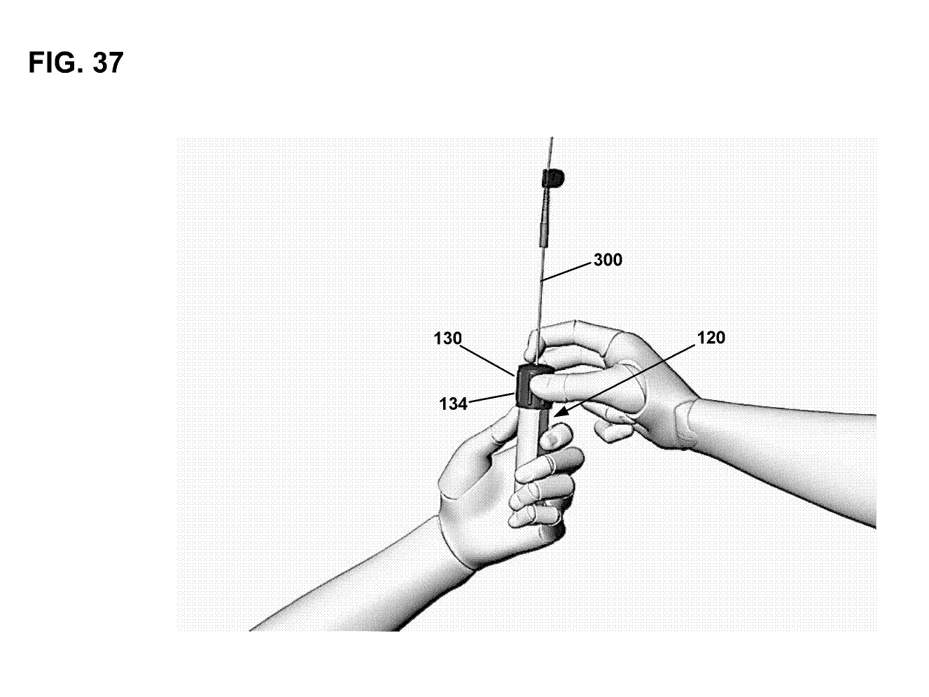

FIGS. 32-45 illustrate another sequence of steps for connectorizing a fiber optic cable. The sequence of steps depicted by FIGS. 32-45 includes use of the cable preparation tool 120 of FIGS. 9A, 9B, 10A, and 10B. The process steps also involve use of the heating component 50 of FIGS. 11 and 12 as well as the connectorization tool 115. Additionally, the process steps relate to preparing the cable 300 of FIG. 14 for termination to a fiber optic connector 416. As indicated above, the fiber optic cable 300 includes a reinforcing layer 310 disposed and optionally bonded between the outer jacket 306 and the buffer layer 304. This bonded configuration allows the strength layer 310 to be cut concurrently with the jacket 306 and the tight buffer 304 in a scoring operation.

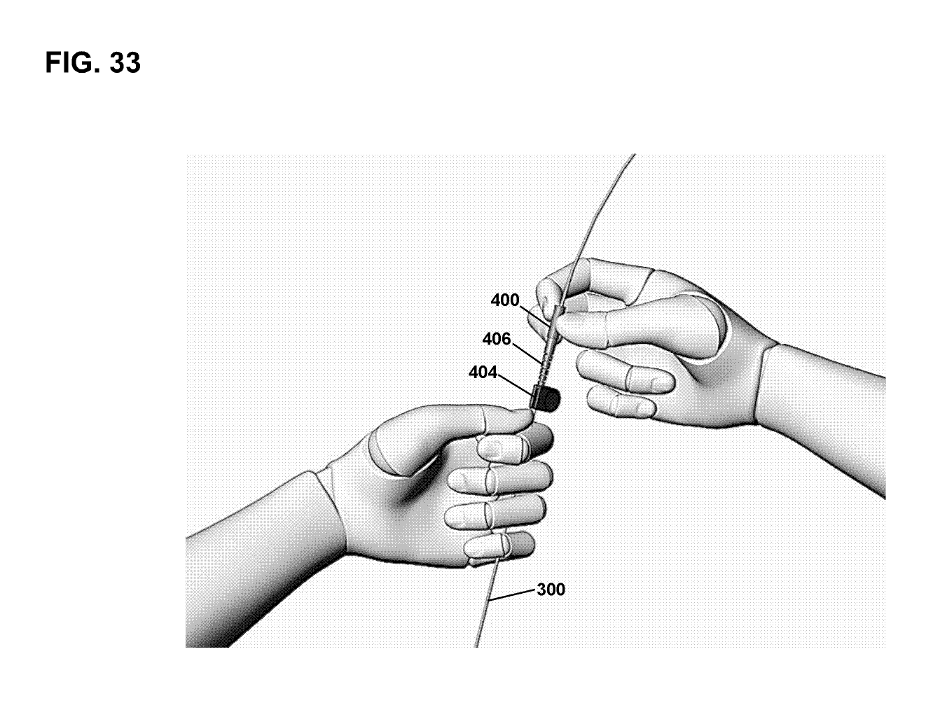

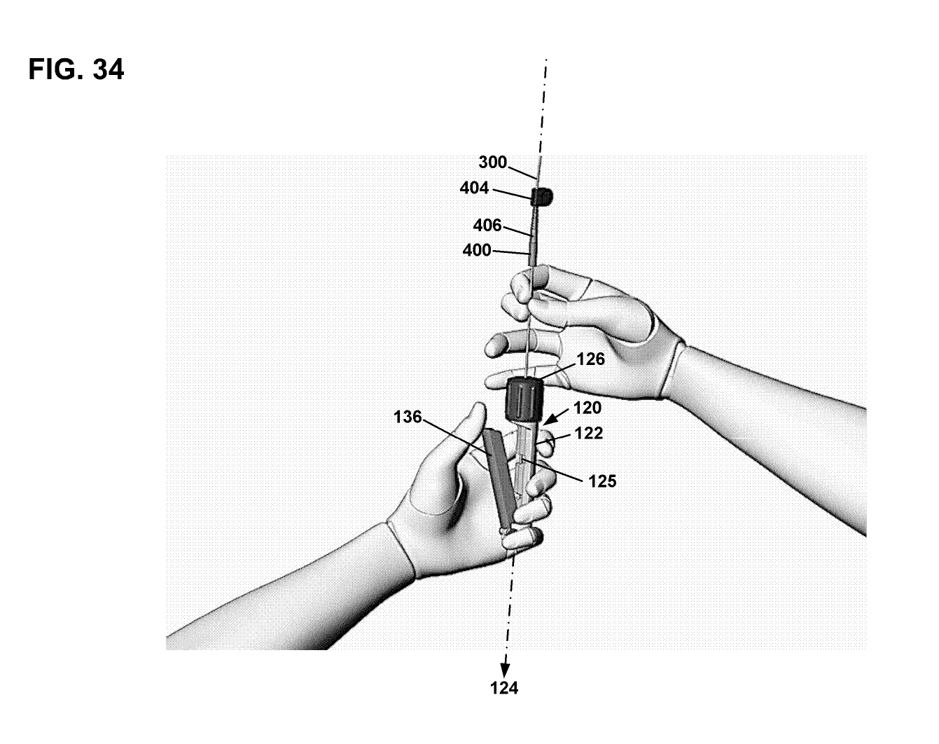

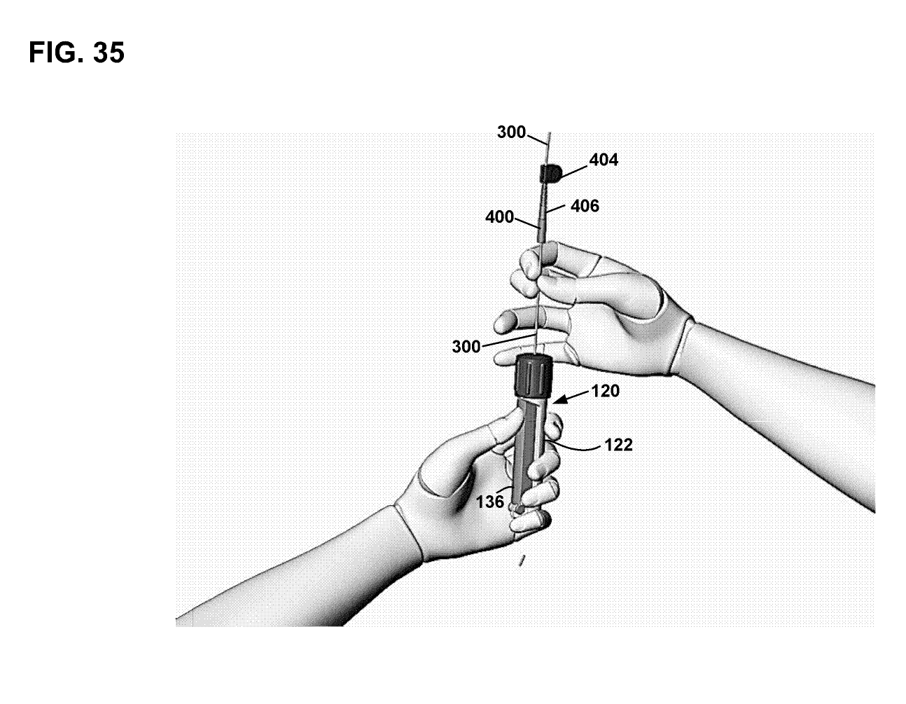

Referring to FIG. 32, the clamp 404 is initially installed on the cable 300. Next, as shown at FIG. 33, the boot 406 and the heat-shrink sleeve 400 are loaded onto the cable 300 above the clamp 404. Next, the cable 300 is inserted into the cable preparation tool 120 along the axis 124. For example, the cable 300 can be inserted along the passage 125 that extends through the length of the cable preparation tool 120 from the first end 126 of the main body 122 to the second end 128 of the main body 122. The insertion process continues until the end of the fiber optic cable 300 projects outwardly beyond the second end 128 of the tool body 122. It will be appreciated that the pivotal handle 136 is in the open position as shown at FIG. 34 during the cable insertion process. Once the cable 300 has been inserted through the length of the cable preparation tool 120, the pivotal handle 136 is actuated by closing the pivotal handle 136 thereby causing the cable cutting structure 120 to sever the end of the fiber optic cable 300 as shown at FIG. 35. Thereafter, the rotary actuator 134 of the cable scoring structure 130 is rotated about the axis 124 causing the cable scoring structure 130 to cut a ring about the cable 300. In certain examples, the blade of the cable scoring structure 130 is configured to cut the ring to a depth that extends through the jacket 306, the strength layer 310 and the buffer layer 304. Thus, all of such layers are cut during the scoring process.

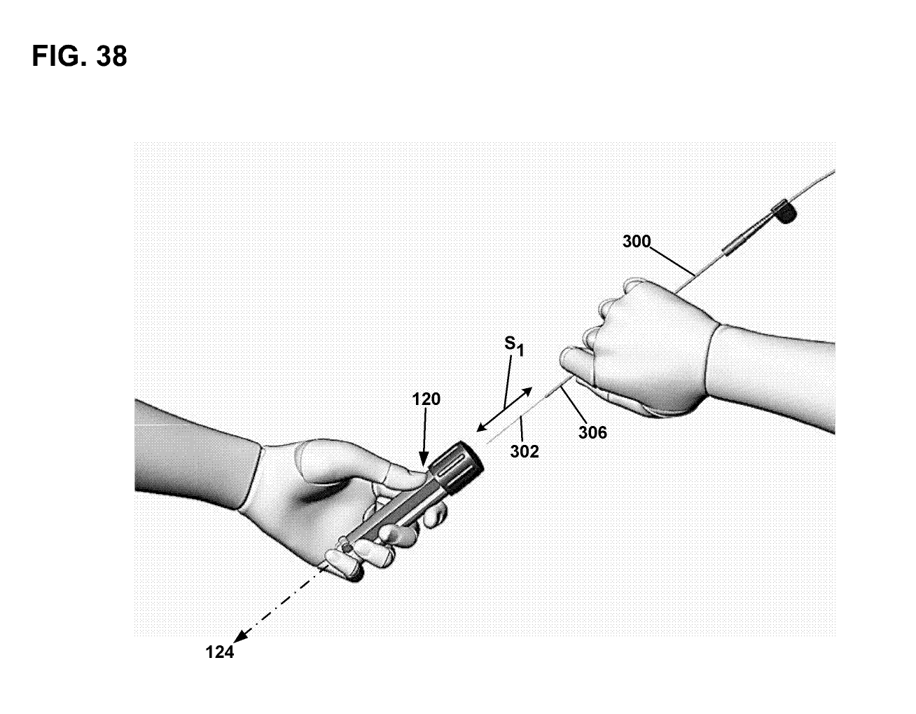

After the scoring process has been completed, the fiber optic cable 300 can be removed from the cable preparation tool 120 as shown at FIG. 38. As the cable 300 is pulled from the cable termination tool 120, the blades of the scoring structure 130 retain/engage the cable 300 to prevent the end portions of the jacket 306, the strength layer 310, and the buffer layer 304 from being removed from the cable preparation tool 120 as the cable 300 is withdrawn from the too1120. Thus, the outer layers are automatically stripped from the end of the cable 300 as the cable 300 is pulled from the cable preparation tool 120 along the axis 124. After stripping, the optical fiber 302 of the cable 300 extends a predetermined spacing S1 beyond the jacket 306, the strength layer 310, and the tight buffer layer 304. The length of the spacing S1 is established by the spacing defined between the cable scoring structure 130 and the cable cutting structure 132 within the cable preparation tool 120.

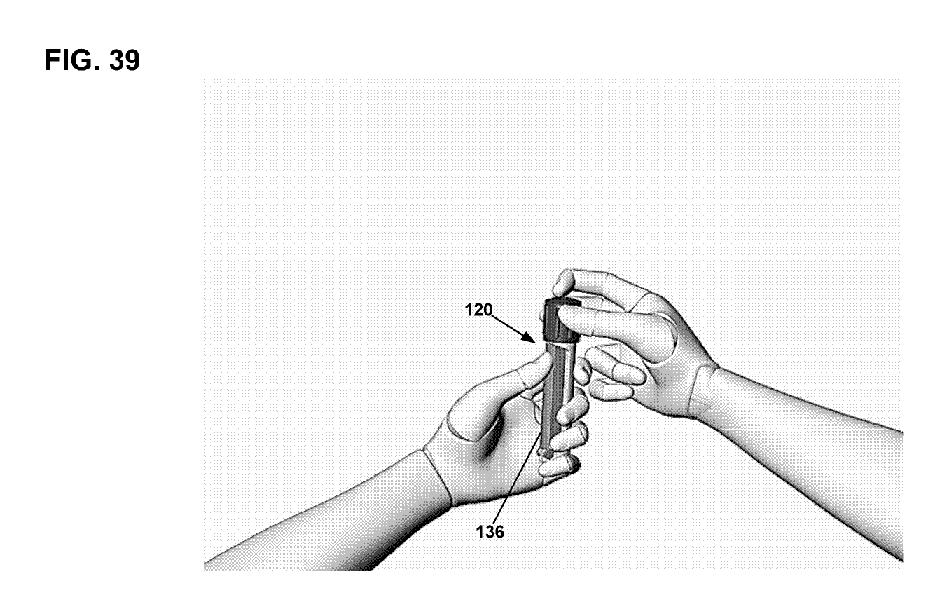

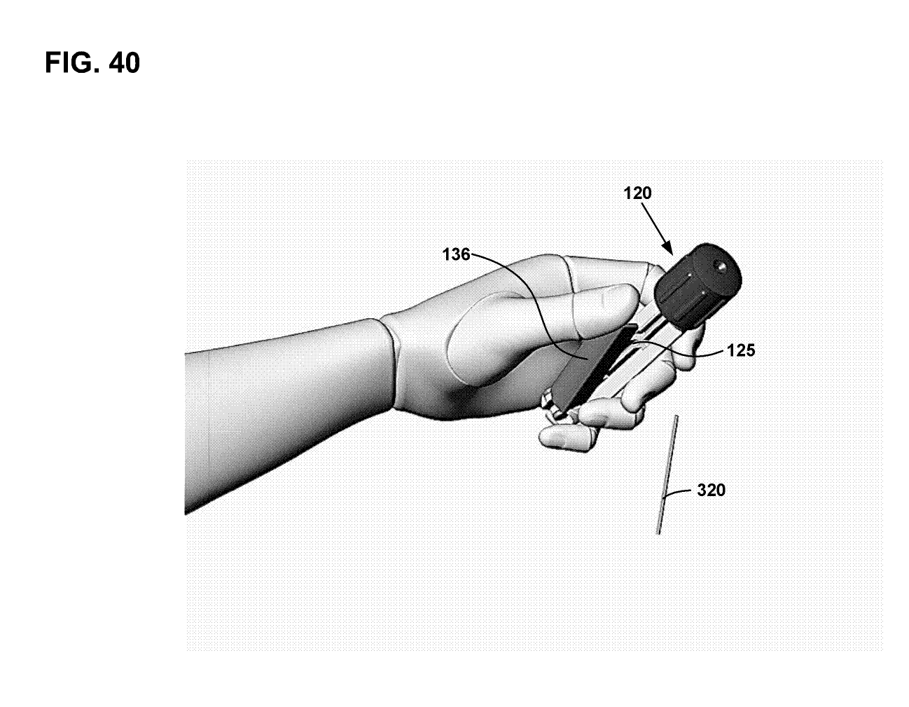

As shown at FIGS. 39 and 40, a stripped segment 320 of the fiber optic cable 300 can be removed from the cable preparation tool 120 by opening the pivotal handle 136 to provide access to the interior of the cable passage 125. It will be appreciated that the stripped segment 320 includes the jacket 306, the strength layer 310 and the tight buffer layer 304.

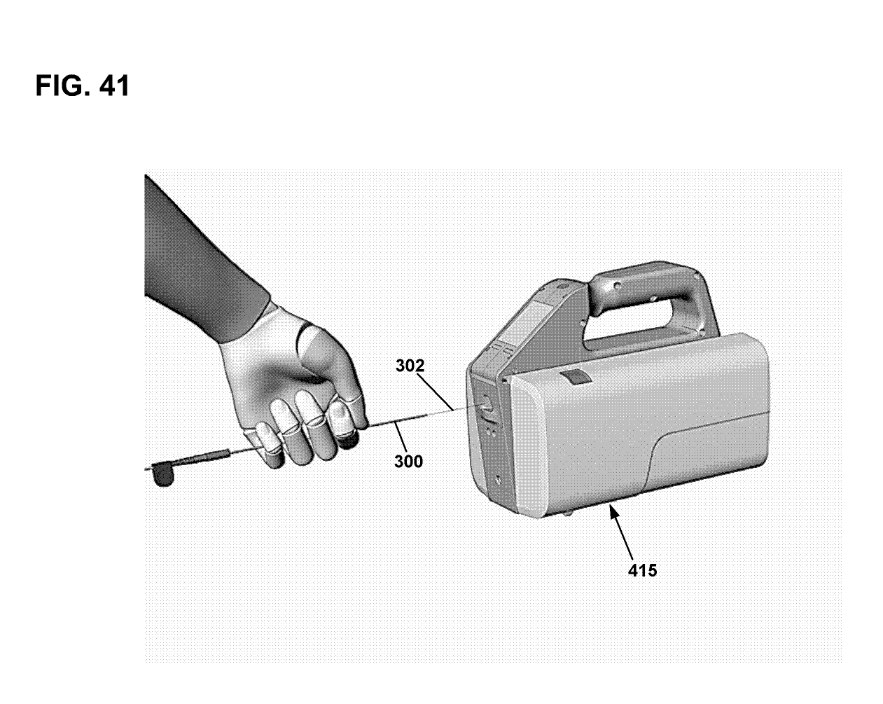

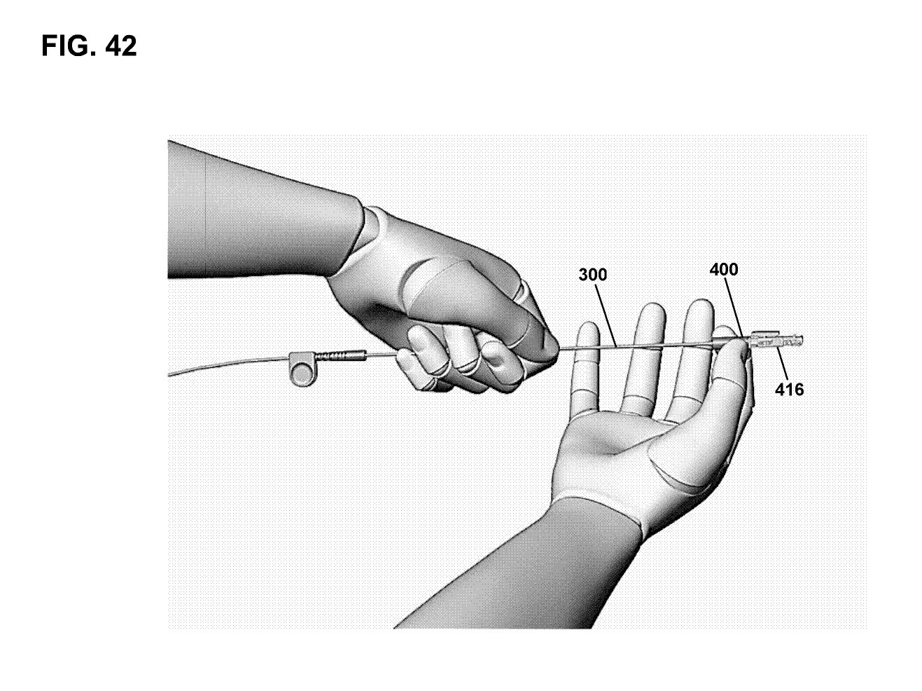

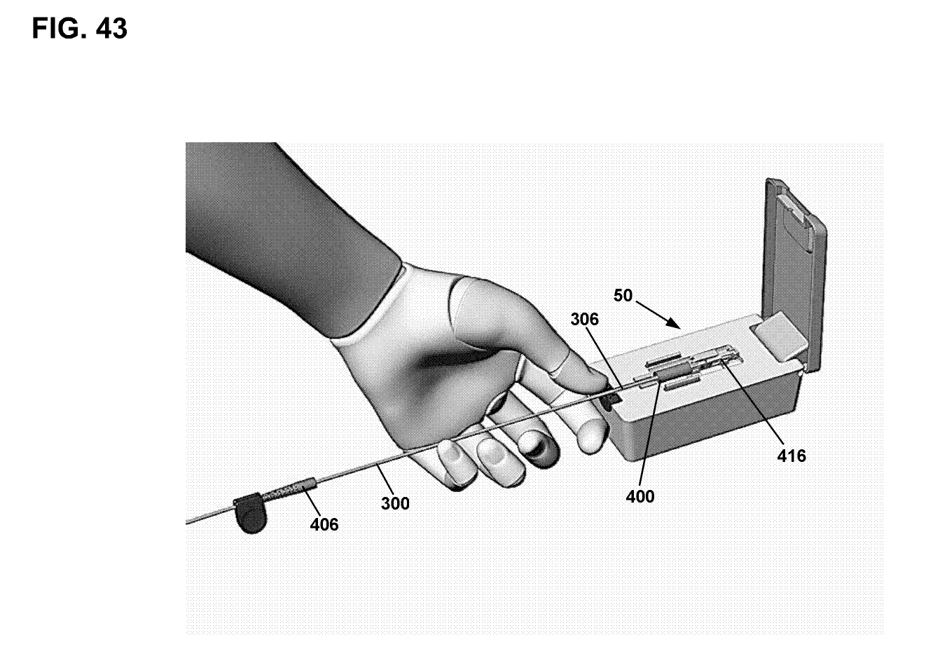

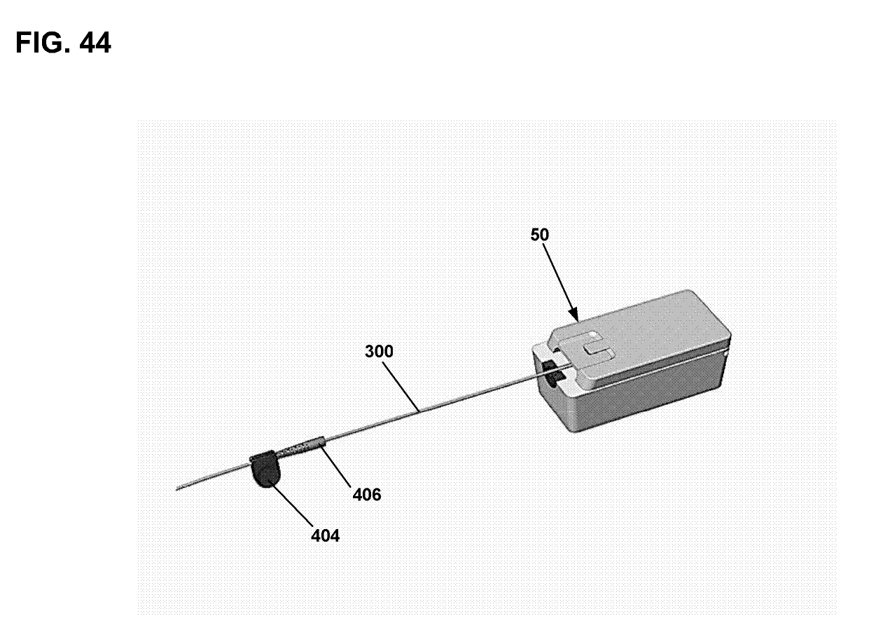

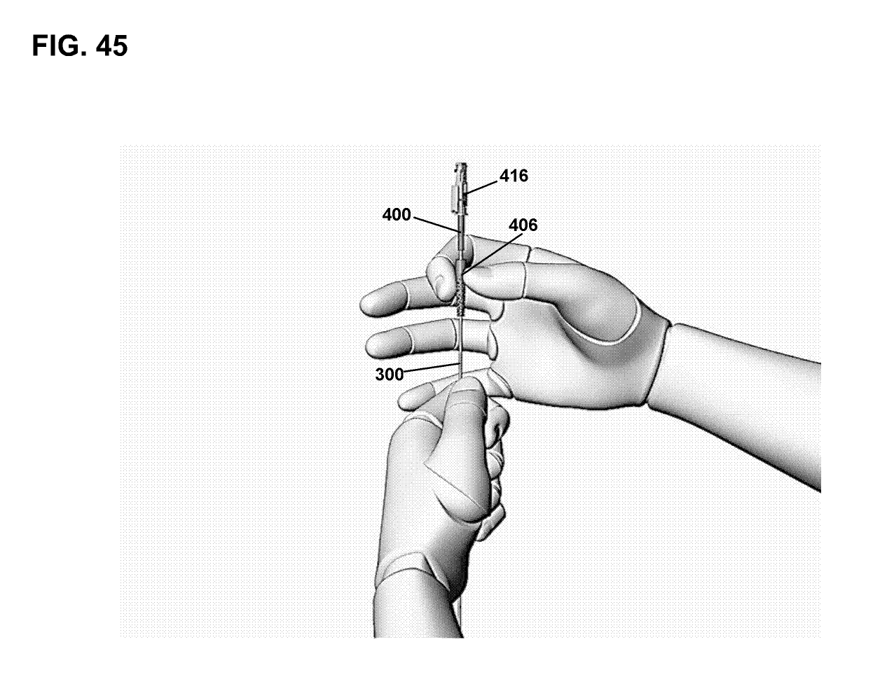

After the stripping operation has been completed, the prepared end of the fiber optic cable 300 is inserted into the connectorization tool 115 as shown at FIG. 41. The connector installation tool 415 can be configured to cleave the optical fiber 302, strip the buffer layer and other coatings from the optical fiber 302, clean the optical fiber 302, plasma treat an end face of the optical fiber 302, and attach the connector 416 to the optical fiber 302. Once the connector 416 has been installed on the fiber 302, the cable and connector assembly is removed from the connectorization tool 415 and the heat-shrink sleeve 400 is slid up and over a rear portion of the connector as shown at FIG. 42. Next, the connector and cable assembly is loaded into the heating component 50 as shown at FIG. 43 and heated as shown at FIG. 44. During the heating process, the heat-shrink sleeve 400 is shrunk down and adhesive within the heat-shrink sleeve 400 is activated thereby bonding the heat-shrink tube 400 to the rear end of the connector body and to the exterior of the cable jacket 306. The cable end connector assembly is then removed from the heating component 50 and the boot 406 is slid into position over the heat-shrink sleeve 400 as shown at FIG. 45. The process is completed by removing the clamp 404 from the cable.

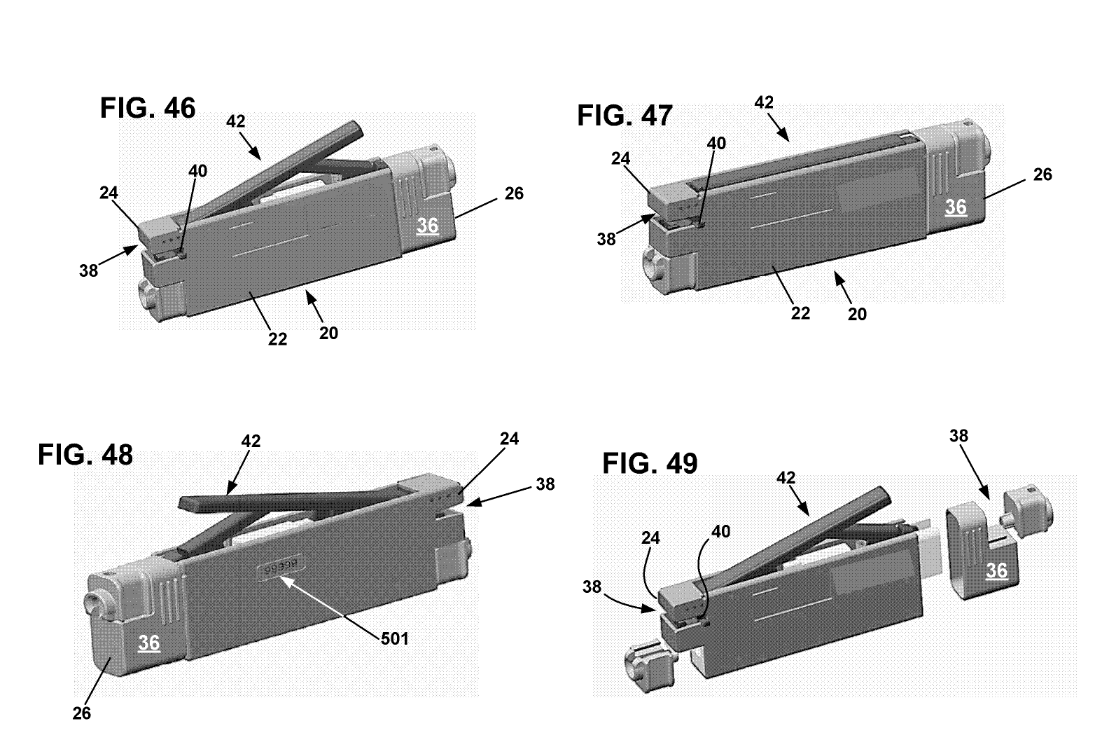

FIGS. 46-49 illustrate another example cable preparation tool 20 in accordance with the principles of the present disclosure. As many of the concepts and features are similar to the cable preparation tool shown in FIGS. 1-8, the description for the first example is hereby incorporated by reference for the this example. Where like or similar features or elements are shown, the same reference numbers will be used where possible. The following description for this example will be limited primarily to the differences between the first example and the subject example.

In this example, the common actuator 42 includes a handle portion 502 and a support portion 504. As described above, the common actuator 42 is actuated by manually pressing the handle portion 502 into the housing 22. The support portion 504 is configured to be supported by a spring member against a portion within the housing and collapsible into the housing 22 as the handle portion 502 is pressed into the housing 22.

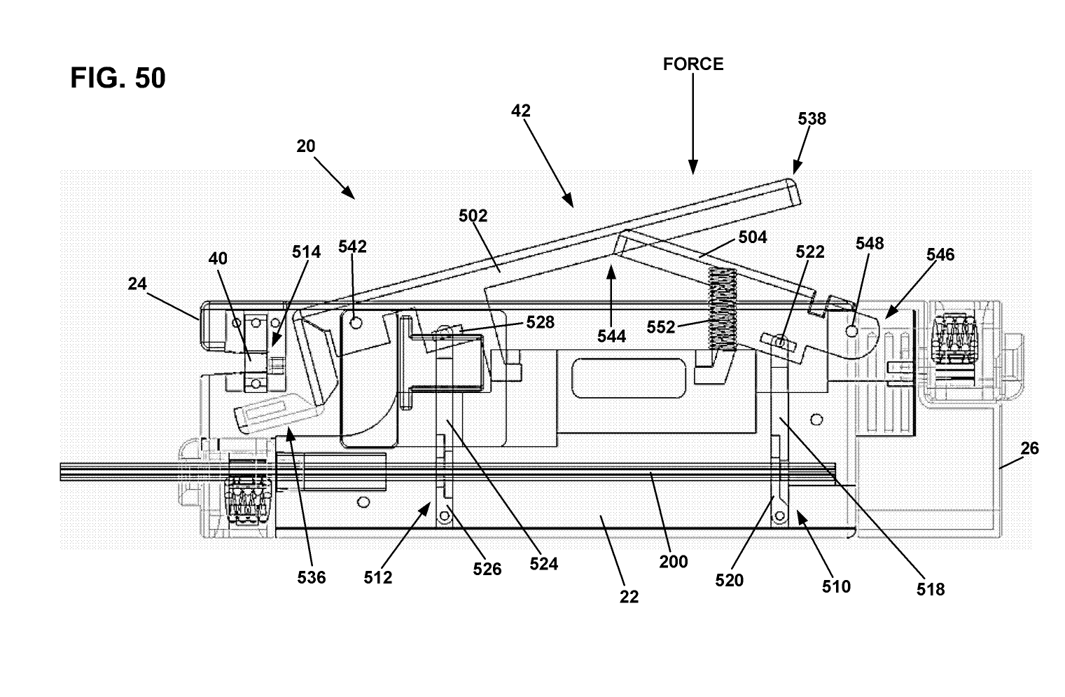

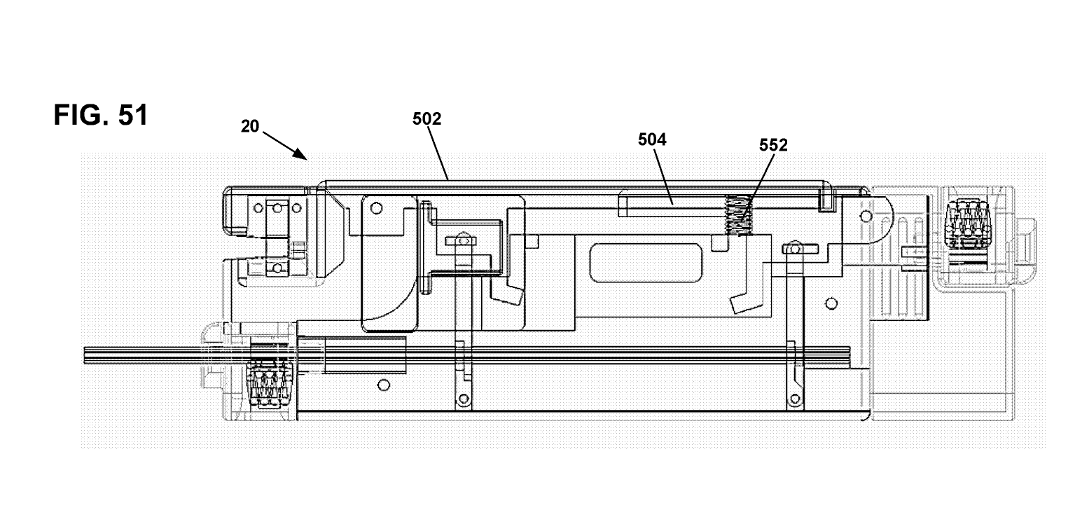

In some examples, the common actuator 42 includes a counter 501 arranged on the side of the housing 22. The counter 501 operates to detect the number of uses or operations of the cable preparation tool 20, thereby notifying a cycle or period for replacing components, such as the blades and the spring member, within the cable preparation tool 20. In some embodiments, the counter 501 is configured to count the number of operations of the common actuator 42. The counter 501 can be either an electronics counter or a mechanical counter. In some embodiments, the common actuator 42 includes sensors configured to detect the displacement or operation of the common actuator 42, a spring member 552 (FIGS. 50 and 51), and/or several cutting or scoring structures 510, 512 and 514 (FIGS. 50 and 51).

FIGS. 50 and 51 are cross-sectional views of the cable preparation tool 20 of FIGS. 46 and 47, respectively. In FIG. 50, the cable preparation tool 20 is in a non-actuated position (i.e., a raised position), and in FIG. 51, the cable preparation tool 20 is in an actuated position (i.e., a lowered position). In the non-actuated position, the common actuator 42 is in a raised position, as shown in FIGS. 46 and 50, so that cables are inserted into suitable locations of the housing 22 for cutting, scoring and/or severing, and removed from the locations of the housing 22 after cutting, scoring and/or severing. In the actuated position, the common actuator 42 is in a lowered position, as shown in FIGS. 47 and 51, so that cables are cut, scored and/or severed by the tool 20.

The handle portion 502 of the common actuator 42 has a forward end 538 and a rearward end 536 and is pivotally connected to the housing 22 at a first actuator hinge 542 so that the handle portion 502 is rotatable about the first actuator hinge 542 between the non-actuated position (i.e., the raised position) and the actuated position (i.e., the lowered position). The first actuator hinge 542 is spaced apart from the rearward end 536 so that, as the handle portion 502 is pressed down with respect to the first actuator hinge 542, the rearward end 536 is moved upward, or vice versa.

The support portion 504 of the common actuator 42 has a forward end 544 and a rearward end 546 and is pivotally connected to the housing 22 at a second actuator hinge 548 so that the support portion 504 is rotatable about the second actuator hinge 548 between the non-actuated position (i.e., the raised position) and the actuated position (i.e., the lowered position). The forward end 544 of the support portion 504 is slidably engaged with the handle portion 502 at the underneath of the handle portion 502 so that, as the handle portion 502 is pressed down, the support portion 504 is also pressed down by the handle portion 502.

The cable preparation tool 20 further includes a spring member 552 engaged between the housing 22 and the support portion 504 of the common actuator 42. In some examples, the spring member 552 is a compression coil spring that biases the support portion 504 (and thus the handle portion 502) toward the non-actuated position (i.e., the raised position).

The cable preparation tool 20 includes a first cutting structure 510, a scoring structure 512, and a second cutting structure 514.

The first cutting structure 510 operates to cut the cable 200. In some embodiments, the first cutting structure 510 is configured for pigtail cutting. The first cutting structure 510 is disposed within the housing 22. The first cutting structure 510 is operably connected to the support portion 504 of the common actuator 42. In some examples, the first cutting structure 510 includes a first movable blade 518 and a first fixed blade 520 configured to be engaged with the first movable blade 518 to cut the cable 200 inserted into the housing 22. In the depicted example, the first fixed blade 520 is fixed on the inner bottom surface of the housing 22, and the first movable blade 518 is pivotally connected to the support portion 504 at a first hinge 522. When the cable preparation tool 20 is in the non-actuated position, the cable 200 is inserted into the housing 22 and placed on the first fixed blade 520 while the first movable blade 518 is located over the first fixed blade 520. As described below, as the support portion 504 is pressed down, the first movable blade 518 moves down toward the first fixed blade 520 so that the cable 200 is engaged between the first movable blade 518 and the first fixed blade 520. As the support portion 504 is further pressed down, the cable 200 is cut by engagement between the first movable blade 518 and the first fixed blade 520.

The scoring structure 512 operates to score the jacket of the cable 200. In some embodiments, the scoring structure 512 is configured for jacket cutting. The scoring structure 512 is disposed within the housing 22. The scoring structure 512 is operably connected to the handle portion 502 of the common actuator 42. In some examples, the scoring structure 512 includes a second movable blade 524 and a second fixed blade 526 configured to be engaged with the second movable blade 524 to score the cable 200 inserted into the housing 22. In the depicted example, the second fixed blade 526 is fixed on the inner bottom surface of the housing 22, and the second movable blade 524 is pivotally connected to the handle portion 502 at a second hinge 528. The second hinge 528 is arranged between the first actuator hinge 542 and the forward end 538 of the handle portion 502. When the cable preparation tool 20 is in the non-actuated position, the cable 200 is inserted into the housing 22 and placed on the second fixed blade 526 while the second movable blade 524 is located over the second fixed blade 526. As described below, as the handle portion 502 is pressed down, the second movable blade 524 moves down toward the second fixed blade 526 so that the cable 200 is engaged between the second movable blade 524 and the second fixed blade 526. As the handle portion 502 is further pressed down, the jacket of the cable 200 is scored by engagement between the second movable blade 524 and the second fixed blade 526.

As depicted, the first cutting structure 510 is spaced apart from the scoring structure 512 at a distance D along a longitudinal axis. In some embodiments, the distance D is adjustable as necessary to satisfy different configurations about the length of the cable being cut out and/or the length of the cable jacket being scored.

The second cutting structure 514 operates to sever the cable 200 and/or the strength members of the cable 200. In some embodiments, the second cutting structure 514 is configured for cutting strength members, such as aramid yarns. Similar to the second cutting structure 38 as shown in FIGS. 1-8, the second cutting structure 514 is located at the first end 24 of the housing 22 with the slot 40 for receiving the cable 200 and/or the strength members of the cable 200. In some examples, similar to the first cutting structure 510, the second cutting structure 514 includes a third movable blade and a third fixed blade configured to be engaged with the third movable blade to sever the cable 200 inserted into the slot 40. In the depicted example, the third fixed blade is fixed around the slot 40, and the third movable blade is configured to be operated by the handle portion 502 as the handle portion 502 is pressed down from the non-actuated position to an actuated position (FIG. 51). For example, the third movable blade is operated by a rearward end 536 of the handle portion 502 that moves upward toward the slot 40 as the handle portion 502 is pressed down. As such, as the handle portion 502 moves from the non-actuated position to the actuated position, the third movable blade is engaged with the third fixed blade so that the cable 200 is severed at the slot 40.

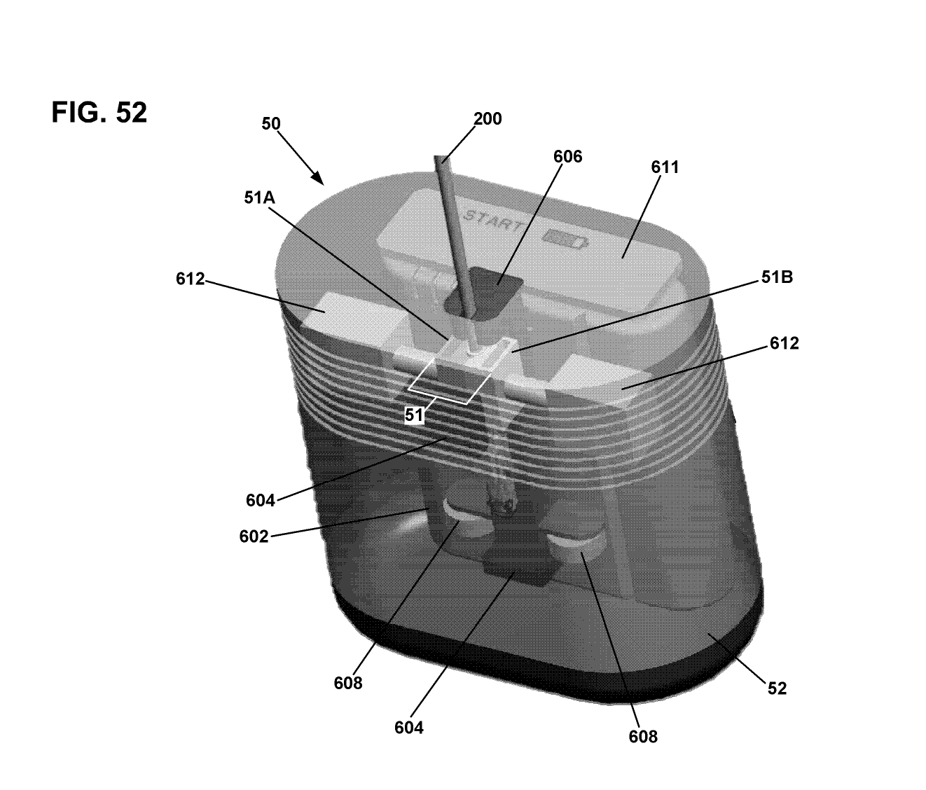

Although the configurations and features shown in FIGS. 51 and 52 are illustrated for the cable preparation tool 20 of FIGS. 46-49, the same configurations and features are also applicable to the cable preparation tool 20 of FIGS. 1-8 in the same or substantially similar manner.

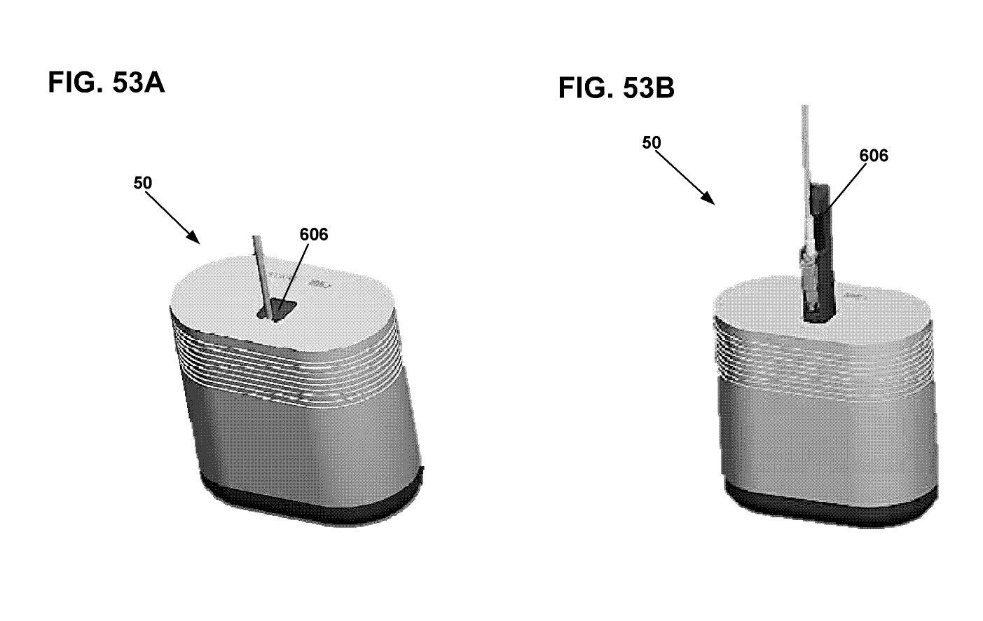

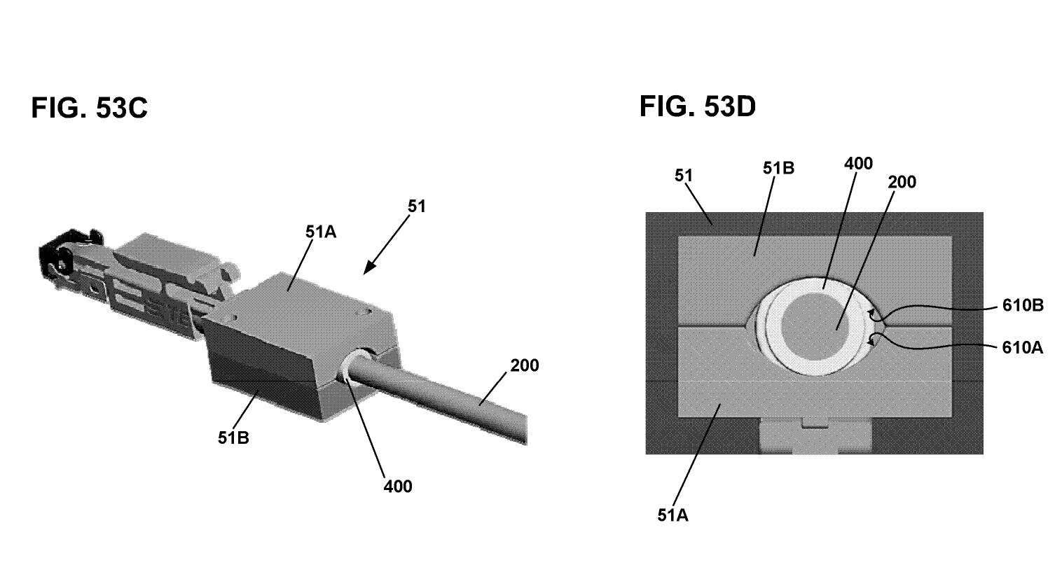

FIGS. 52-53 illustrate another example heating component 50 in accordance with the principles of the present disclosure. As many of the concepts and features are similar to the first example heating component 50 shown in FIGS. 11 and 12, the description for the first example is hereby incorporated by reference for this example. Where like or similar features or elements are shown, the same reference numbers will be used where possible. The following description for this example will be limited primarily to the differences between the first example and the subject example.

In this example, as in the first example, the heating component 50 includes a main housing and a heating arrangement. The main housing defines an interior heating chamber configured to receive a fiber optic connector arrangement, and includes a passage for routing the fiber optic cable 200 from the interior heating chamber out of the main housing. The heating arrangement is positioned at the interior heating chamber and configured to heat the heat-shrink sleeve 400 without heating the connector 416. In some embodiments, the heating arrangement includes one or more heating elements 51. The heating elements 51 can be of any type suitable for the purpose as described above. For example, the heating elements 51 include Positive Temperature Coefficient (PTC) heaters. As illustrated in FIGS. 53C and 53D, the heating component 50 includes two heating elements 51A and 51B that are complementary to each other for physically contacting the cable 200 and transferring heat to the cable 200. In some examples, the heating elements 51A and 51B are opposingly arranged, and the heat-shrink sleeve or tube 400 fits the opposing heating elements 51A and 51B during heating. The heating elements 51A and 51B are configured to incorporate PTC heaters therein and have cylindrical or rounded contact surfaces 610A and 610B, respectively. In some embodiments, the PTC heaters can be embedded in the heating elements 51A and 51B. In other embodiments, the PTC heaters can be attached to outer surfaces of the heating elements 51A and 51B. In some embodiments, the heating elements M A and MB are made of aluminum for efficiently transferring heat from the PTC heaters to the rounded contact surfaces 610A and 610B. The heating elements 51A and 51B are operated between a closed position and an open position. In the closed position, as depicted in FIGS. 53C and 53D, the two heating elements 51A and 51B are abutted to each other with the heat-shrink sleeve 400 engaged therebetween. In the closed position, the heat-shrink sleeve 400 is held by the two heating elements 51A and 51B and heated through the rounded contact surfaces 610A and 610B by the heat generated the PTC heaters therein. In the open position, the two heating elements 51A and 51B are spaced apart to release the sleeve 400. As described below, the heating elements 51A and 51B are biased to the closed position by compression force and move into the open position by the operation of a second solenoid control system 612.

As in the first example, the heating component 50 includes one or more batteries 602 for providing power to the heating elements 51 and other electronic components.

In some examples, the heating component 50 includes one or more fans 604 configured to cool the fiber optic connector heated by the heating elements 51. For example, the fan 604 operates to cool the heat shrink sleeve 400 before the loading tray 606 can be moved from the loaded position to the ejected position.

In the depicted example, the heating component 50 includes a loading tray 606 configured to receive the fiber optic connector outside the base 52 and place the fiber optic connector within the base 52. The loading tray 606 is configured to be ejected from, or pushed into, the heating component 50 on the top side thereof. The loading tray 606 is movable between a first position (e.g., a pushed-in position as in FIG. 53A) and a second position (e.g., an ejected position as in FIG. 53B). In the first position, as illustrated in FIG. 53A, the loading tray 606 is received into, or pushed into, the heating component 50 so that the fiber optic connector is placed within the heating component 50. In the second position, as illustrated in FIG. 53B, the loading tray 606 is extended or ejected outside the heating component 50 to receive the fiber optic connector therein. In some examples, the loading tray 606 is operated between the first and second positions by a first solenoid control system 608.

The heating component 50 includes first and second solenoid control system 608 and 612. The first solenoid control system 608 is configured to control the loading tray 606 between the first and second positions. In some embodiments, the loading tray 606 is biased to remain in the second position (i.e., the ejected position). In some embodiments, the loading tray 606 is spring biased to the second position by a spring mechanism. In this case, when the loading tray 606 is pushed into the heating component 50, the first solenoid control system 608 is activated to hold the loading tray 606 in the firstposition (i.e., the pushed-in position). As such, when the first solenoid control system 608 is in an activated condition, the loading tray 606 is in the firstposition, and when the first solenoid control system is not in an activated condition, the loading tray 606 is in the secondposition.

The second solenoid control system 612 is configured to control the heating elements 51A and 51B. In some embodiments, all of the heating elements 51A and 51B are movable and actuated by the second solenoid control system 612. In other embodiments, one of the heating elements 51A and 51B is movable by the second solenoid control system 612 and the other heating element is fixed. In some embodiments, the two heating elements 51A and 51B are biased tothe closed position (as shown in FIGS. 53C and 53D) so that the two heating elements 51A and 51B exerts compression force on the heat-shrink sleeve 400 engaged therebetween to improve heat transfer to the engaged sleeve 400. Thus, as the heat-shrink sleeve 400 shrinks between the heating elements 51A and 51B during heating process, the heating elements 51A and 51B become closer to each other by the biasing or compression force. In some embodiments, the two heating elements 51A and 51B is spring biased to the closed position by a spring mechanism such that the heating elements 51A and 51B can automatically move together as the heat shrink sleeve 400 shrinks. In this case, when the second solenoid control system 612 is not in an activated condition, the heating elements 51A and 51B remains in the closed position, and as the second solenoid control system 612 is activated, the heating elements 51A and 51B moves to the open position. In some embodiments, as the loading tray 606 is ejected outside the heating component 50 by deactivating the first solenoid control system 608, the second solenoid control system 612 is activated to move the heating elements 51A and 51B into the open position so that the sleeve 400 is released from the heating elements M A and MB. In other examples, the first and second solenoid control systems 608 and 612 are operated in different manners.

The heating component 50 can further includes a control board 611 configured to display the status of several components of the heating components 50 (such as the status of the heating elements 51, the status of the batteries 602, and the position of the loading tray 606). In some embodiments, the control board 611 can also receive input or instruction of the user of the heating component 50.

In some examples, the heating component 50 is operated automatically. In other examples, at least some processes of the heating component 50 are performed automatically. For example, an operator loads the fiber optic connector (including the heat-shrink sleeve 400) to the loading tray 606 in the second position (i.e., in the extended position outside the heating component 50) and pushes the loading tray 606 into the heating component 50. Then, the heating component 50 automatically operates to lock the loading tray 606 within the heating component 50 and activates heating process. In some embodiments, the heating component 50 operates two pieces of the heating elements 51 (51A and 51B) into the closed position so that the heating elements 51A and 51B are biased toward the heat-shrink sleeve 400 until the heating elements 51 are physically in contact with the heat-shrink sleeve 400, and increases the temperature of the heating elements 51 at a predetermined temperature. In some examples, the heating elements 51 are heated up at a contact surface temperature of 200° C. The heating component 50 is operated to maintain the heating process for a predetermined amount of time. In some example, the heating process is maintained for 25 seconds. Then, the heating component 50 operates the heating elements 51 into theopen position (in which the two heating elements 51A and 51B are spaced apart) to release the heat-shrink sleeve 400, and runs the fans 604 to cool the heated sleeve 400 and/or the heated heating elements 51 for a predetermined time. In some examples, the heated sleeve 400 and/or the heating elements 51 are cooled down below 50° C. by operating the fans 604 for about 75 seconds. After the fans 604 are controlled to stop, the loading tray 606 is automatically ejected from the heating component 50 so that the operator can take out the connector 416 with the sleeve 400 from the loading tray 606.

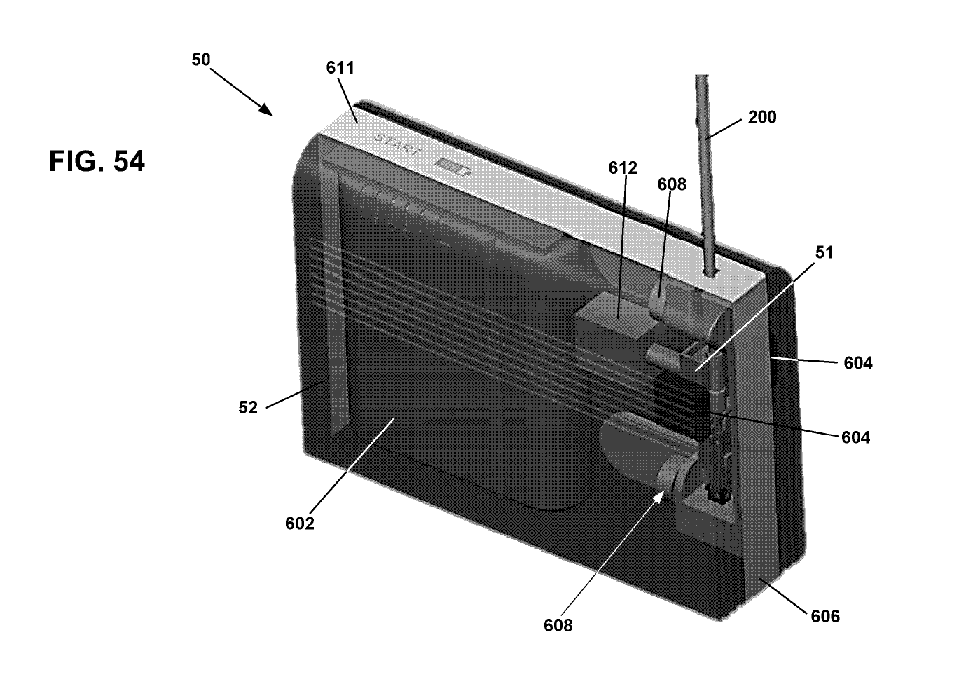

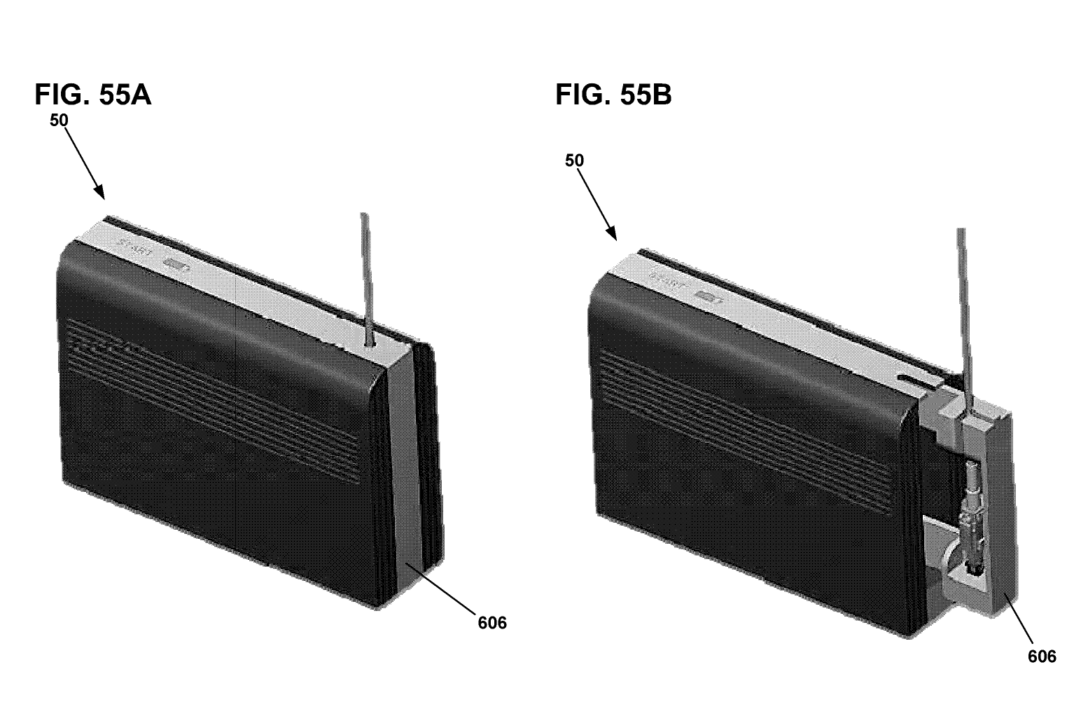

FIGS. 54 and 55 illustrate another example heating component 50 in accordance with the principles of the present disclosure. As many of the concepts and features are similar to the first example heating component 50 shown in FIGS. 11 and 12 and the second example heating component 50 shown in FIGS. 52 and 53, the description for this example heating component 50 is omitted for brevity purposes. The description for the first and second examples is hereby incorporated by reference for this example. Where like or similar features or elements are shown, the same reference numbers will be used where possible.

In the depicted example of FIGS. 54 and 55, the loading tray 606 is configured to move between the first and second positions at the side of the heating component 50. In some embodiments, the heating component 50 includes one piece of the heating element 51 operated by the second solenoid system 612.

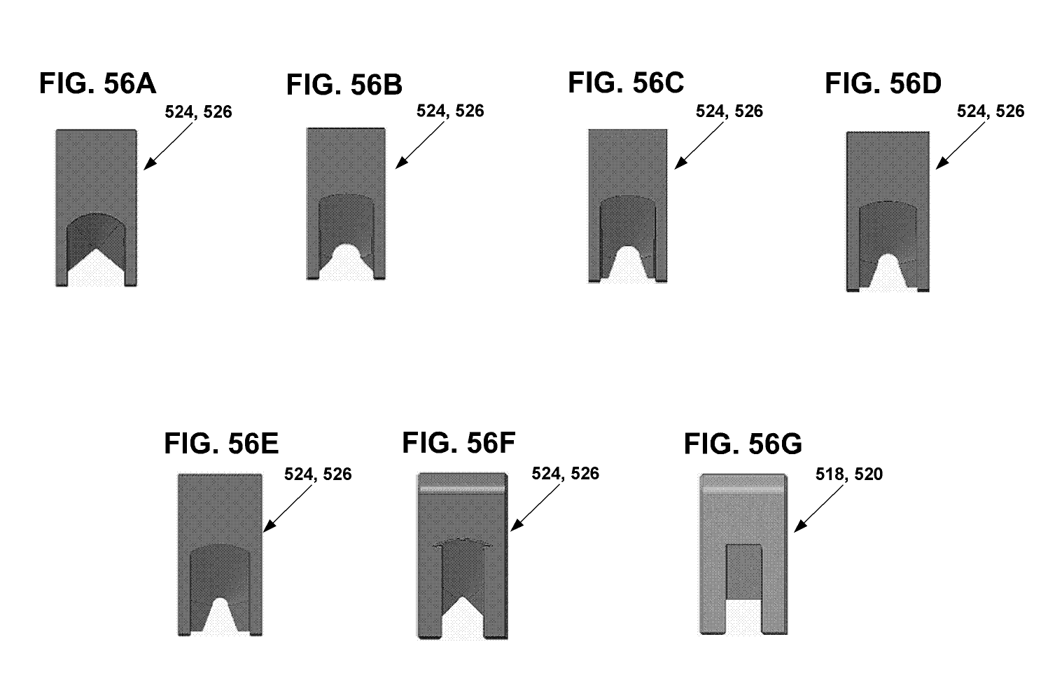

FIGS. 56A-56G illustrate different types of blades used in the cable preparation tool 20 according to the principles of the present disclosure. For example, FIG. 56A depicts an example V-shaped blade for scoring the jacket of the cable. FIGS. 56B-56F illustrate example U-shaped blades with different configurations and/or sizes, which are configured to score the jacket of the cable. FIG. 56G shows an example blade configured to completely cut the cable.

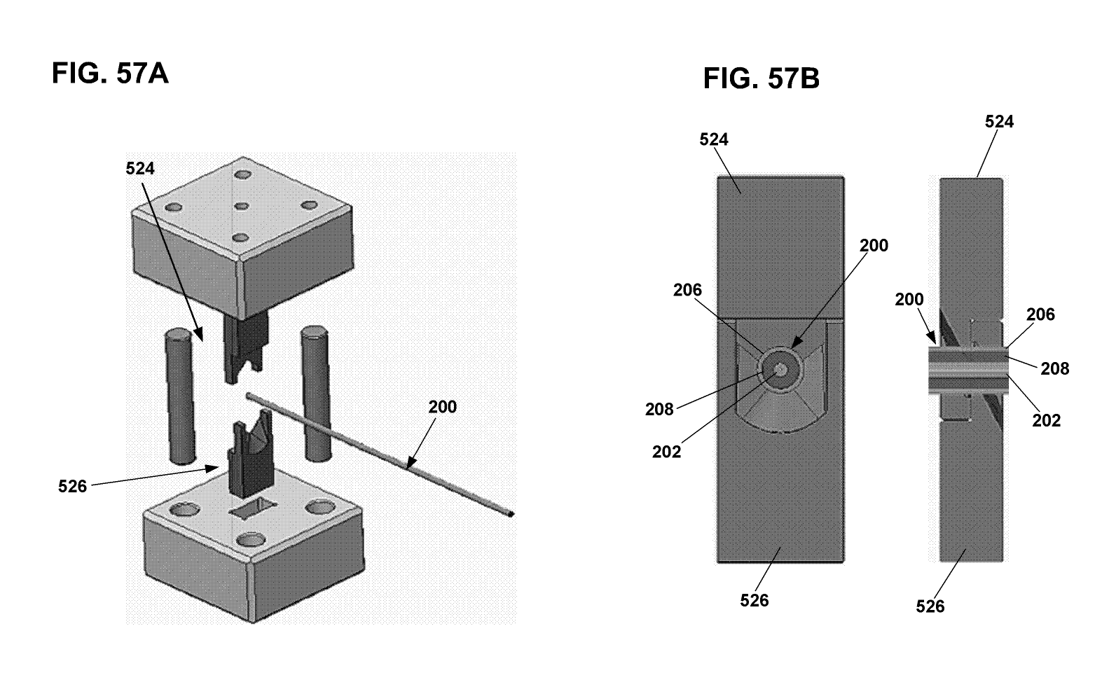

FIGS. 57A and 57B illustrate an example operation of the blades in general. The principle and concept illustrated in FIGS. 57A and 57B are applicable to the first cutting structure, the scoring structure, the second cutting structure, and other structures for cutting, severing and/or scoring as illustrated in the present disclosure.

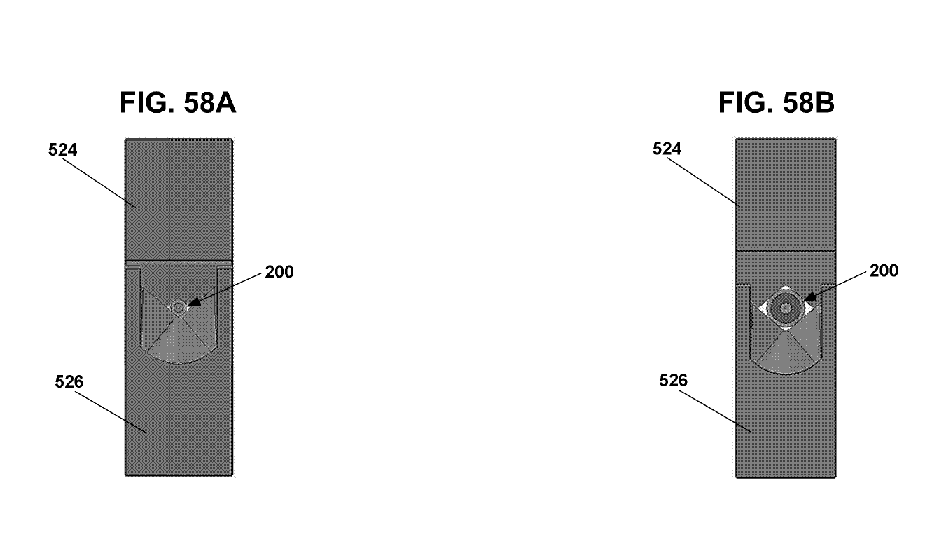

FIGS. 58A and 58B illustrate example operations of the V-shaped blades as shown in FIG. 56A. As depicted, the V-shaped blades can be used to score the jackets of the cables with different diameters.

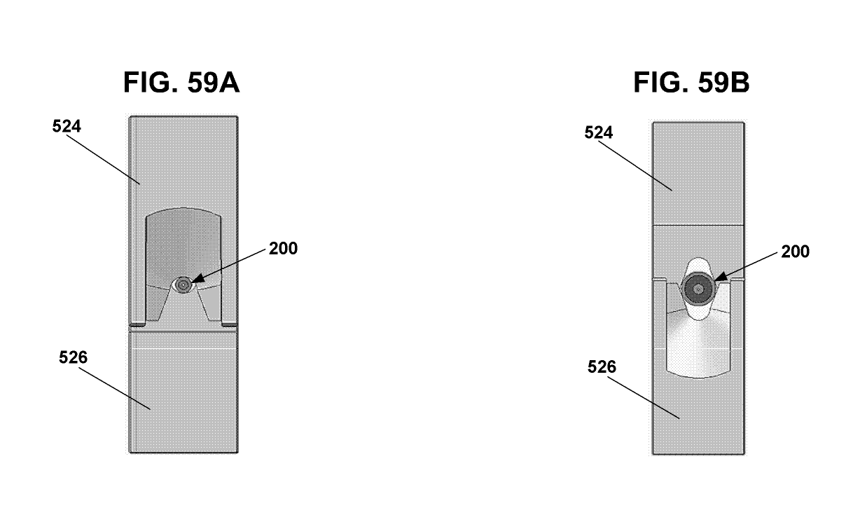

FIGS. 59A and 59B illustrate example operations of the U-shaped blades as shown in FIGS. 56B-56F. As depicted, the U-shaped blades can be used to score the jackets of the cables with different diameters.

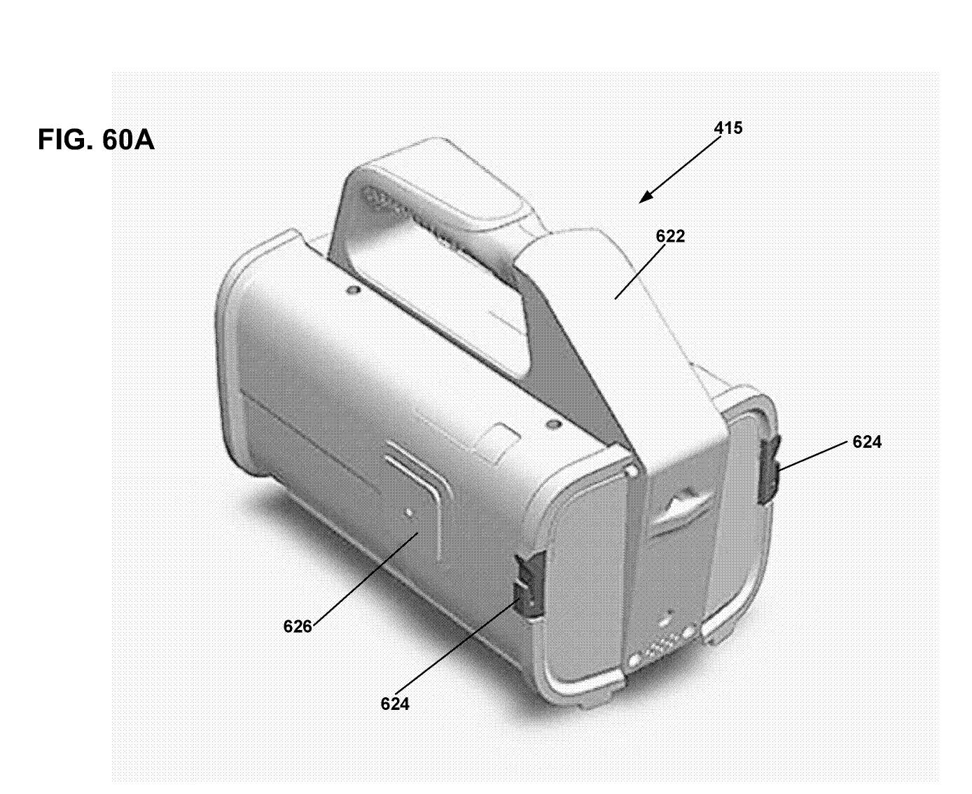

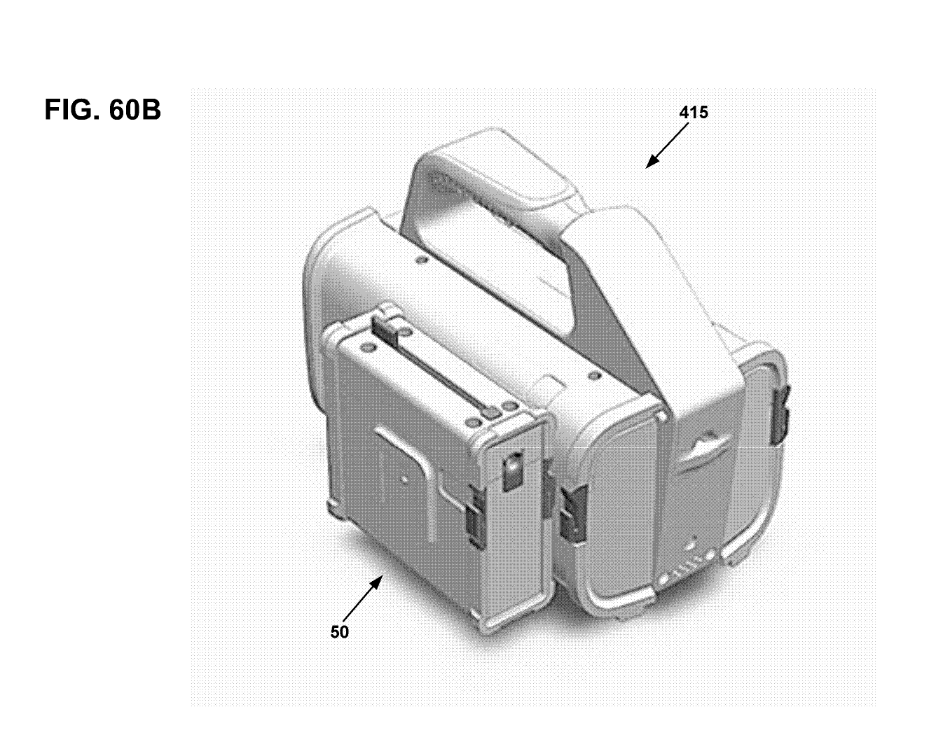

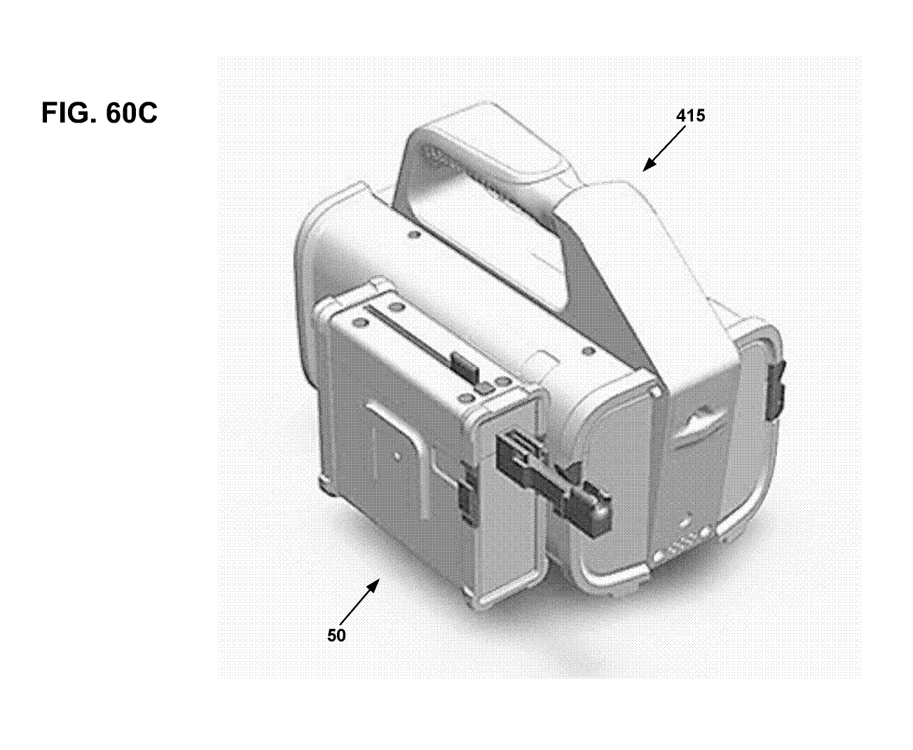

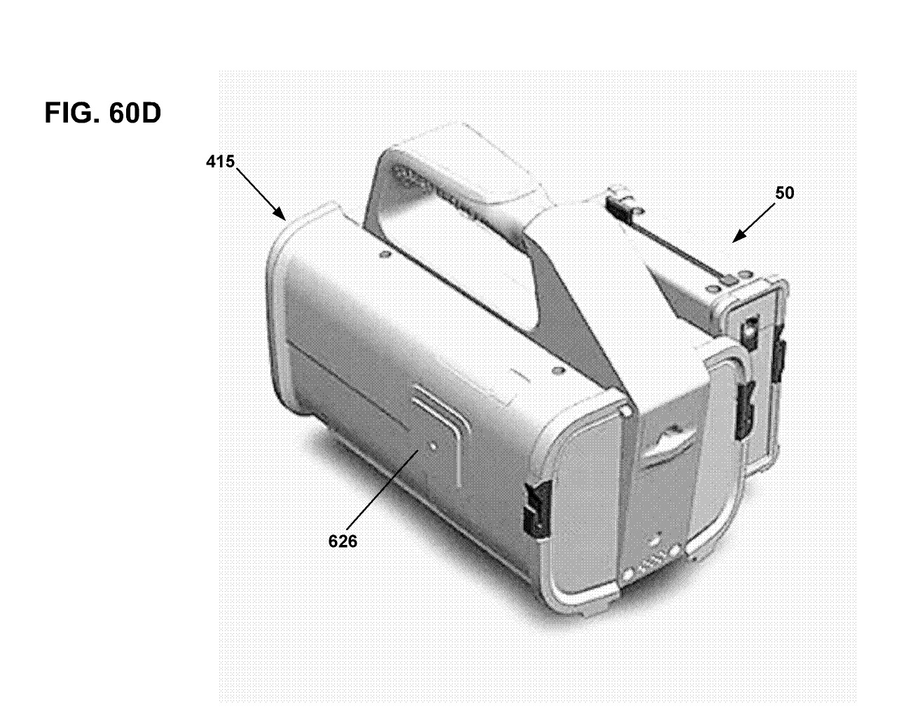

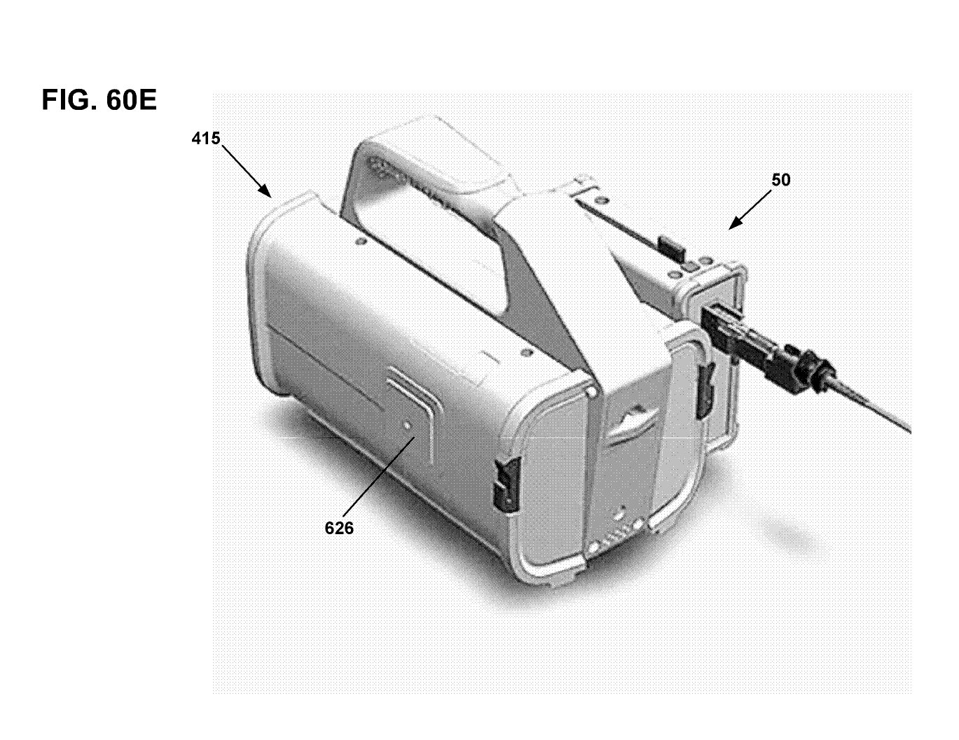

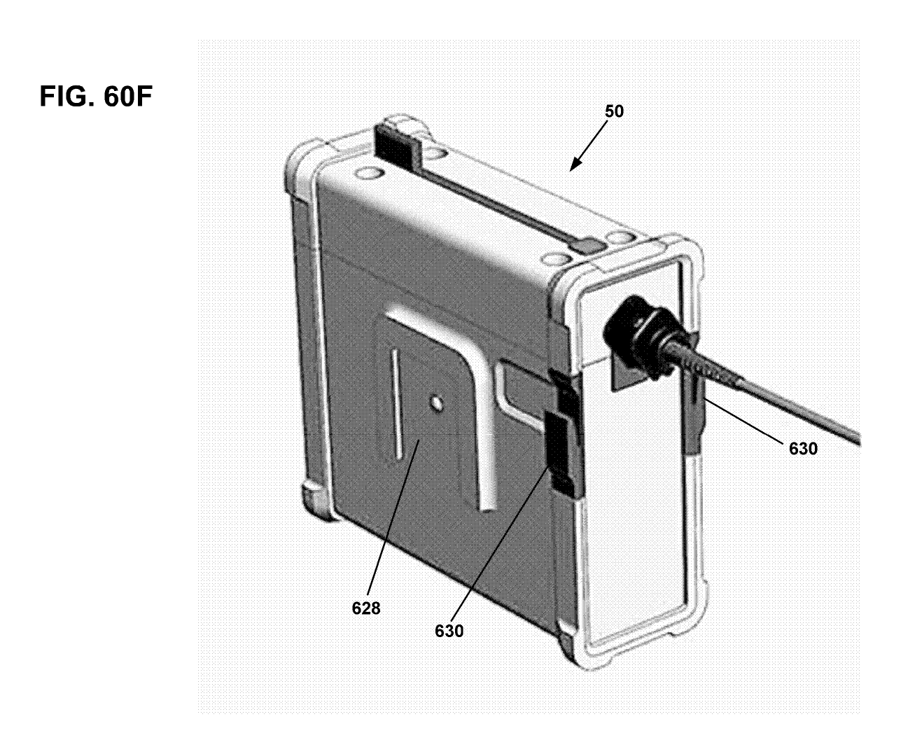

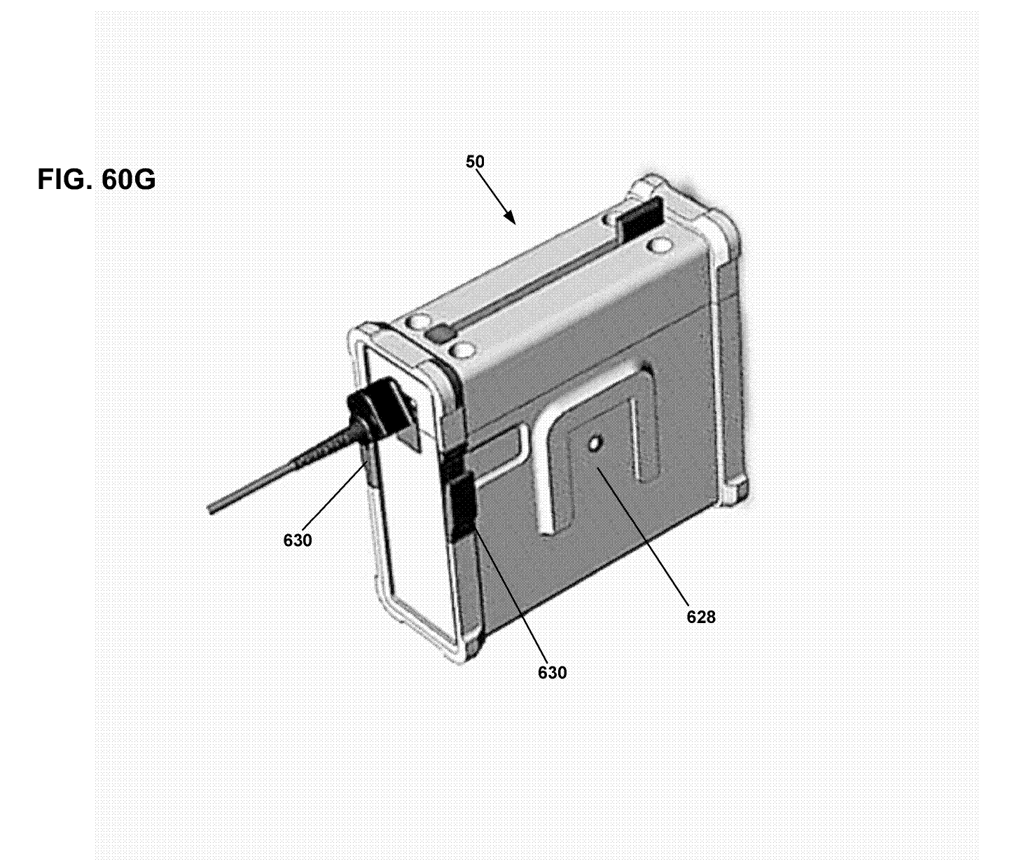

FIGS. 60A-60G illustrate an example connector installation tool 415 for use with the heating component 50. As depicted, the heat-shrink sleeve 405 is configured to engage and support the heating component 50 on one or more sides thereof. In some embodiments, the connector installation tool 415 includes a handle 622, one or more cable clips 624, and a first mounting device 626. The cable clips 624 are configured to hold a cable thereon for several purposes. For example, the operator can temporarily clip a portion of the cable to the cable clip 624 when managing another cable. The first mounting device 626 is configured to detachably engage a second mounting device 628 of the heating component 50 so that the heating component 50 is mounted or docked to the connector installation tool 415. In the depicted example, the first mounting device 626 is arranged on both sides of the connector installation tool 415.

The heating component 50 includes the second mounting device 628 configured to be detachably coupled to the first mounting device 626 of the connector installation tool 415. In the depicted example, the second mounting device 628 is arranged on both sides of the heating component 50. In some examples, the heating component 50 includes one or more cable clips 630 that have the same functionality as the cable clips 624 of the connector installation tool 415.

According to the principles of the present disclosure, the cable preparation tool 20, as illustrated and described above, is used for any type of fiber optic cables, such as fiber pigtails, optimized pigtails, butterfly cables, Pico cables, and round drop cables. In some examples, the cable preparation tool 20 is modified to be suitable for different cable types.

According to the principles of the present disclosure, the predetermined spacing defined between the scoring location provided by the cable scoring structure 130 and the cutting location defined by the cable cutting structure 132, or the longitudinal distance D between the first cutting structure 510 and the scoring structure 512, may be adjusted according to different specifications about the cable length that is to be cut by the first cutting structure and/or is scored by the scoring structure 512. Further, the blades used for the first cutting structure 510 and the scoring structure 512 are replaceable and interchangeable so as to meet several specifications about cable termination.

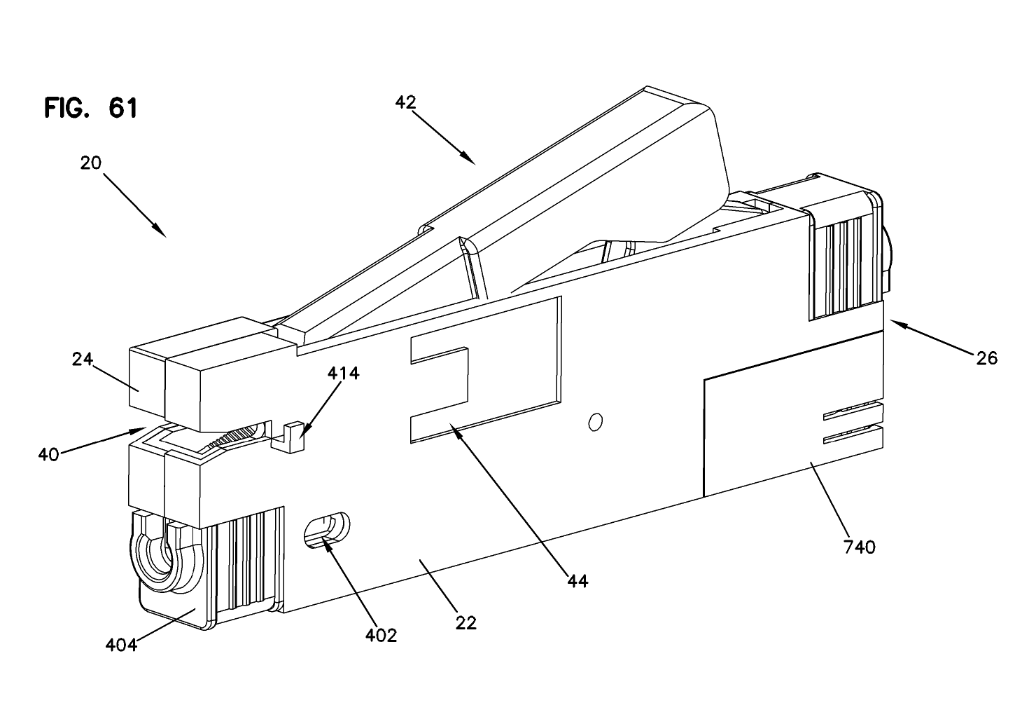

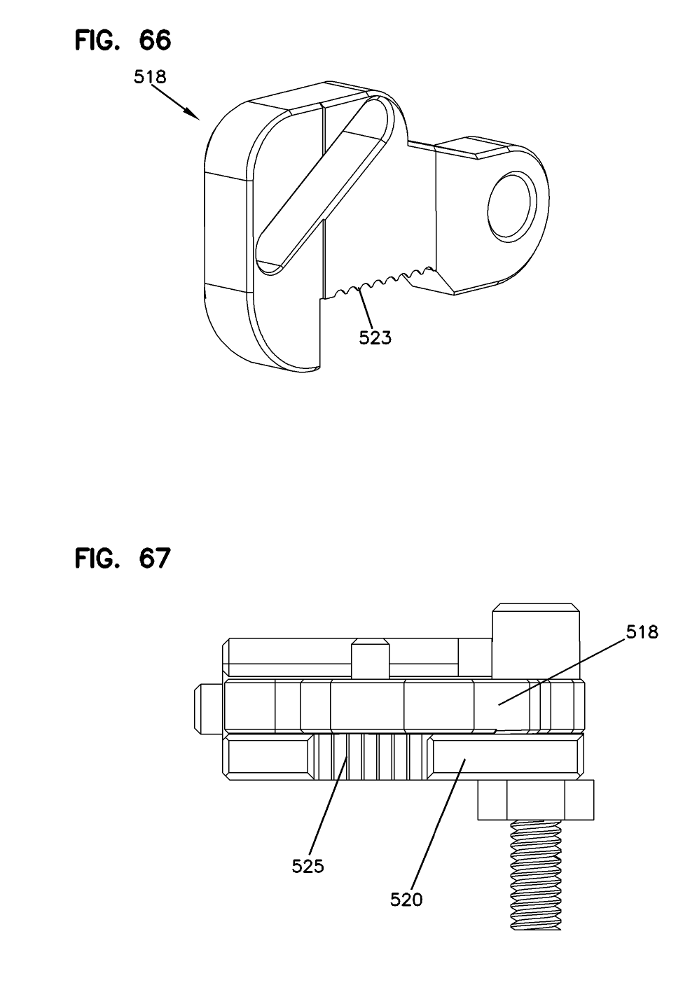

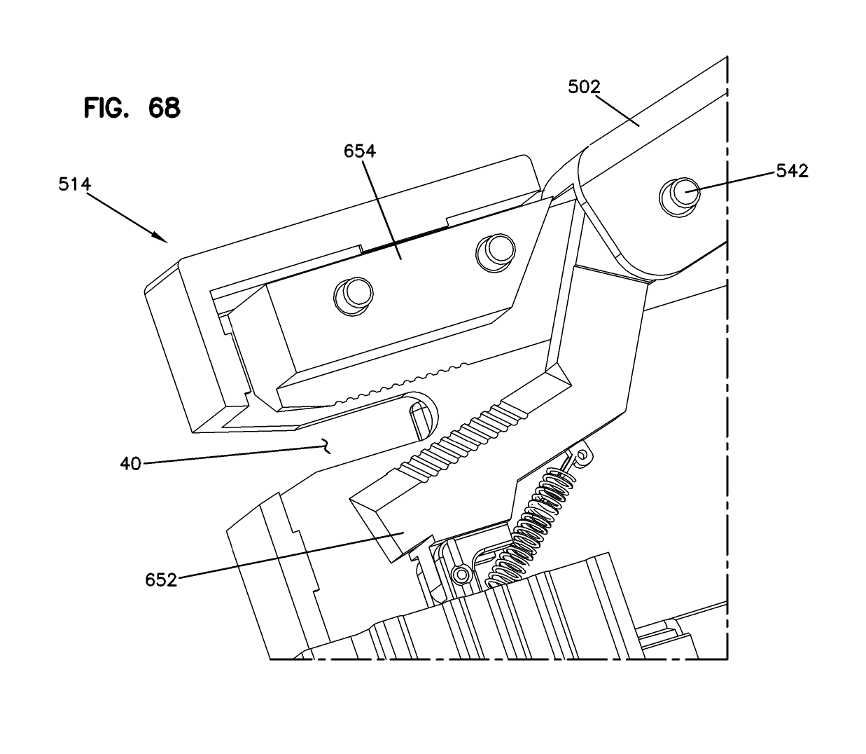

FIGS. 61-72 illustrate another example cable preparation tool 20 in accordance with the principles of the present disclosure. As many of the concepts and features are similar to the cable preparation tool shown in FIGS. 46-51 (including the operations as illustrated in FIGS. 15-31), the description for the example of FIGS. 46-51 is hereby incorporated by reference for the this example. Where like or similar features or elements are shown, the same reference numbers will be used where possible. The following description for this example will be limited primarily to the differences between the first example and the subject example.

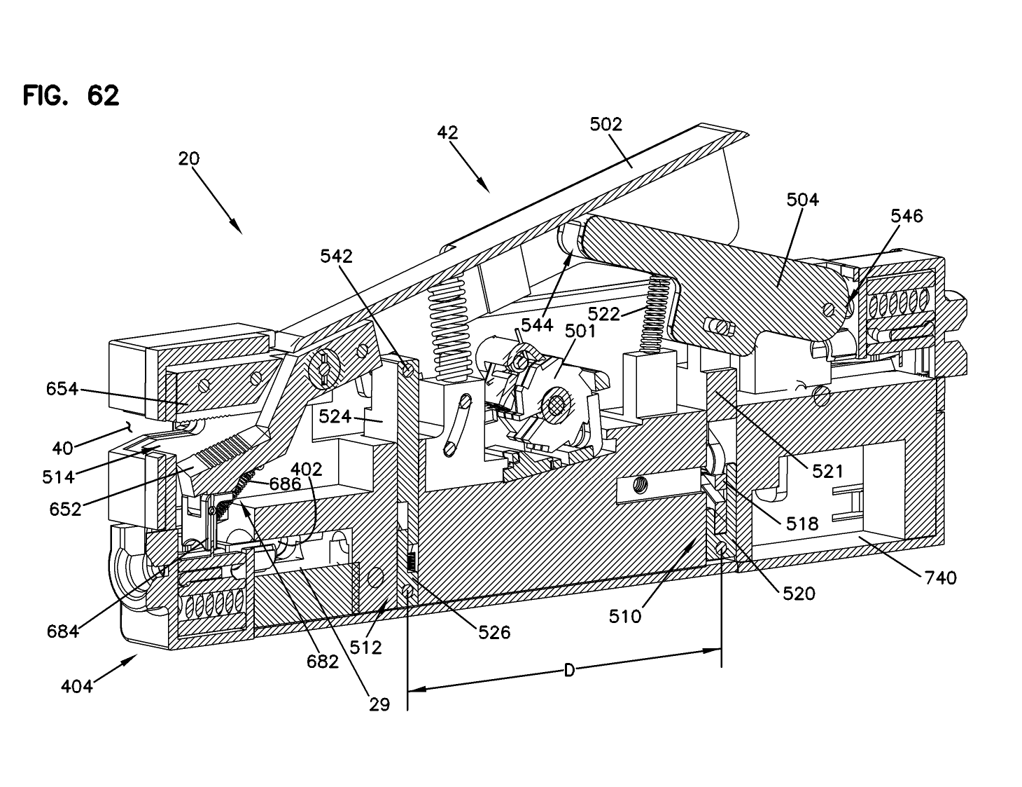

Referring to FIGS. 61-63, the actuator 42 includes the handle portion (also referred to herein as a primary pivotal actuator lever) 502 and the support portion (also referred to herein as a secondary pivotal actuator lever) 504. The primary and secondary pivotal actuator lever 502 and 504 are configured to be depressed into the housing (also referred to herein as a tool body) 22. As described above, the actuator 42 is actuated by manually pressing the primary pivotal actuator lever 502 into the housing 22. As primary pivotal actuator lever 502 is depressed into the housing 22, the secondary pivotal actuator lever 504 is simultaneously depressed into the housing 22 due to a relative arrangement or position of the primary and secondary pivotal actuator levers 502 and 504, as illustrated in FIG. 62. The primary and secondary pivotal actuator levers 502 and 504 are spring-biased toward a non-depression orientation (i.e., the non-actuated position or raised position), as illustrated in FIGS. 61-63. As the configurations of the primary and secondary pivotal actuator levers 502 and 504 are similar to the cable preparation tool 20 as illustrated in FIGS. 46-51, the detailed description of the primary and secondary pivotal actuator levers 502 and 504 are omitted for brevity purposes.

As described above, the cable preparation tool 20 includes a first cutting structure 510, a scoring structure 512, and a second cutting structure 514.

The first cutting structure 510 operates to cut the cable 200 in various types, such as pigtail cutting. The first cutting structure 510 is operated as the second pivotal actuator lever 504 is depressed into the housing 22. The second pivotal actuator lever 504 is pivotally coupled to the first cutting structure 510. The first cutting structure 510 can include a first movable blade (also referred to herein as a scissor blade) 518 and a fixed blade 520 configured to engage the first movable blade 518 to cut the cable 200 inserted into the housing 22. In the depicted example, the fixed blade 520 is fixed on the inner bottom side of the housing 22, and the first movable blade 518 is pivotally connected to the secondary pivotal actuator lever 504 through an intermediate slide link 521.

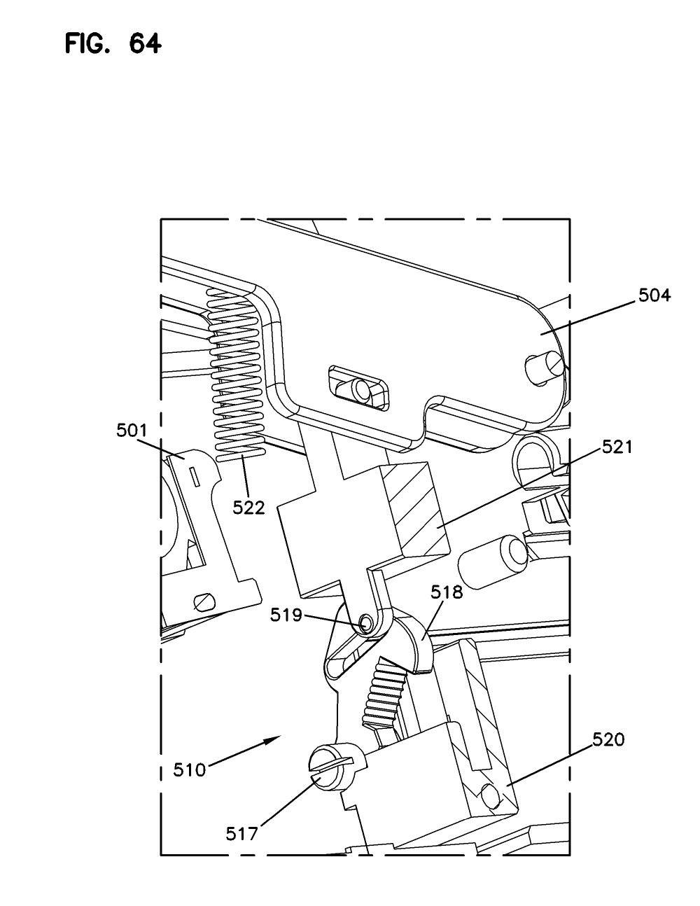

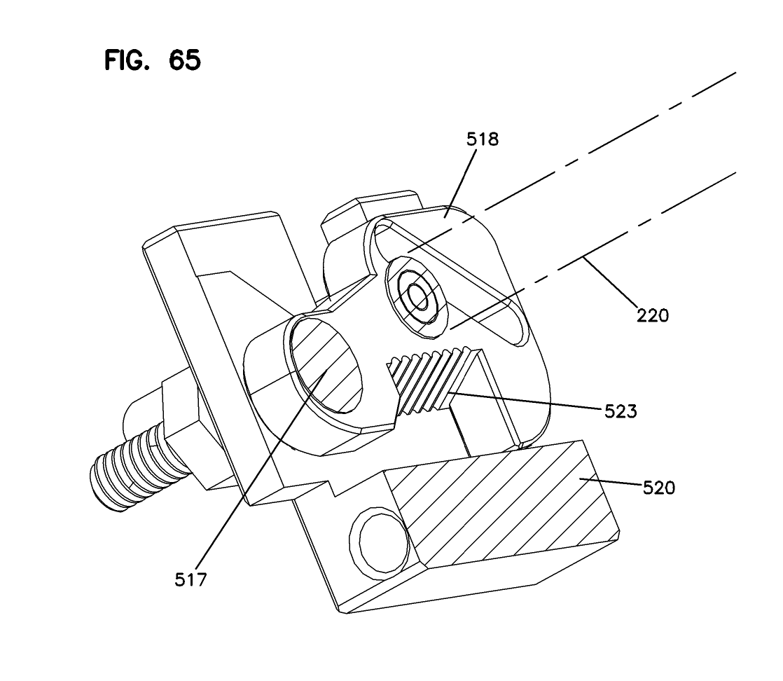

Referring to FIGS. 64-67, the first cutting structure 510 is illustrated and described in more detail. As illustrated, the secondary pivotal actuator lever 504 is pivotally coupled to the scissor blade 518 of the first cutting structure 510 by the intermediate slide link 521 and pivotally moves the scissor blade 518 between a retracted position (FIG. 64) and a cutting position (FIG. 65). When the cable preparation tool 20 is in the non-actuation orientation, the scissor blade 518 is in the retracted position so that the cable 200 is inserted into the housing 22 and placed between the fixed blade 520 and the scissor blade 518. As the secondary pivotal actuator lever 504 is depressed, the intermediate slide link 521 linearly slides down to actuate the scissor blade 518 that is pivotally coupled to the intermediate slide link 521, thereby moving the scissor blade 518 down (from the retracted position to the cutting position) toward the fixed blade 520 and engaging the fixed blade 520 to cut the cable 200.

The scissor blade 518 is pivotally connected at a hinge 517 so as to pivotally operate relative to the fixed blade 510 between the retracted position and the cutting position. The intermediate slide link 521 is pivotally connected to the scissor blade 518 at a hinge 519 and pivotally connected to the secondary pivotal actuator lever 504 at a hinge 522 such that depression of the secondary pivotal actuator lever 504 actuates a linear operation of the intermediate slide link 521, which is then transferred to a pivotal operation of the scissor blade 518 between the retracted and cutting positions relative to the fixed blade 520. By using the intermediate slide link 521, the scissor blade 518 can be made smaller than a long flexible lever as shown in FIGS. 50-51.

As illustrated in FIGS. 64-66, the scissor blade 518 includes a serrated edge 523. The serrated edge 523 can be saw-toothed. The serrated edge 523 can help easily cut the cable 200 including its strength members (e.g., aramid yarns).

Referring to FIG. 67, the fixed blade 520 includes a serrated section 525 adjacent the serrated edge 523 of the scissor blade 518. The scissor blade 518 and the fixed blade 520 are relatively arranged such that the serrated edge 523 of the scissor blade 518 and the serrated section 525 of the fixed blade 520 are interfered therebetween as the cable 200 is cut by engagement between the scissor blade 518 and the fixed blade 520.

Referring again to FIGS. 61-63, the scoring structure 512 operates to score the jacket of the cable 200. The scoring structure 512 is operably connected to the primary pivotal actuator lever 502. The scoring structure 512 includes a movable scoring blade (also referred to herein as a first scoring blade) 524 and a fixed scoring blade (also referred to herein as a second scoring blade) 526 configured to be engaged with the movable scoring blade 524 to score the cable 200 inserted into the housing 22. In the depicted example, the fixed scoring blade 526 is fixed on the inner bottom side of the housing 22, and the movable scoring blade 524 is directly pivotally connected to the primary pivotal actuator lever 502 at a hinge 528. As such, the primary pivotal actuator lever 502 is pivotally coupled to the first scoring blade 524 of the scoring structure 512 and linearly moves the first scoring blade 524 between a retracted position and a scoring position relative to the fixed scoring blade 526. In other examples, the movable scoring blade 524 can be pivotally connected to the primary pivotal actuator lever 502 by an intermediate slide link.

Referring again to FIGS. 62-64 and 68, the second cutting structure 514 operates to sever the cable 200 and/or the strength members (e.g., aramid yarns) of the cable 200. The second cutting structure 514 can be positioned adjacent to an open ended notch (e.g., the slot 40) defined by the tool body (i.e., the housing 22) such that the cable 200 and/or the strength members of the cable 200 is inserted into the open ended notch and severed by the second cutting structure 514. For example, the second cutting structure 514 is located at the first end 24 of the housing 22 with the slot 40 for receiving the cable 200 and/or the strength members of the cable 200.

As described in FIGS. 23 and 24, the second cutting structure 514 can be used to cut excess length of strength members corresponding to a stripped portion of the cable jacket. For example, once the end portion 408 of the jacket 206 has been removed from the cable 200, the strength layer 208 and the optical fiber 202 are exposed and the strength layer 208 can be separated from the optical fiber 202 and directed through the slot 40 of the second cutting structure 38. With the strength layer 208 positioned within the slot 40, the second cutting structure 514 (similarly to the second cutting structure 38) is manually actuated by the actuator 42 thereby severing the strength layer 208. Thereafter, the cable assembly is removed from the cable preparation tool 20 as shown at FIG. 25. In some examples, clamp 404 can be loaded into the docking receptacle 44 (including the hook 414) once the fiber optic cable 200 has been removed from the cable receiving passage 34.

The second cutting structure 514 includes a movable scissor blade 652 and a fixed scissor blade 654 configured to engage the movable scissor blade 652 to sever the cable 200 inserted into the slot 40. The movable scissor blade 652 is pivotally coupled to the primary pivotal actuator lever 502 such that the second cutting structure 514 is actuated when the primary pivotal actuator lever 502 is depressed. The fixed scissor blade 654 can be fixed adjacent the slot 40, and the movable scissor blade 652 is configured to be pivotally actuated by the primary pivotal actuator lever 502 as the primary pivotal actuator lever 502 is depressed from the non-depression orientation to the depression orientation.

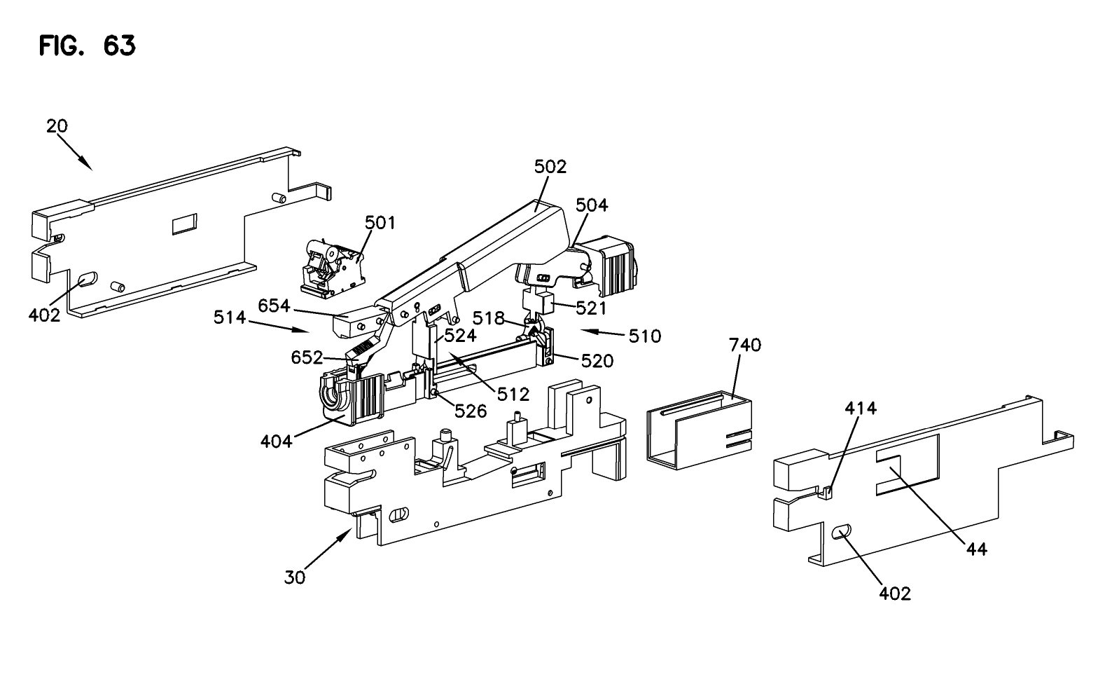

Referring to FIGS. 61-63 and 69-70, the cable preparation tool 20 further includes a cable clamp 404 for clamping the cable 200 (including one or more jackets, strength members, and fibers thereof) while the cable 200 is severed and/or scored by the first cutting structure 510 and/or the scoring structure 512. The cable clamp 404 can be received at a cable clamp mounting pocket 30 (FIG. 63) defined by the housing 22 to be in alignment with the cable passage.

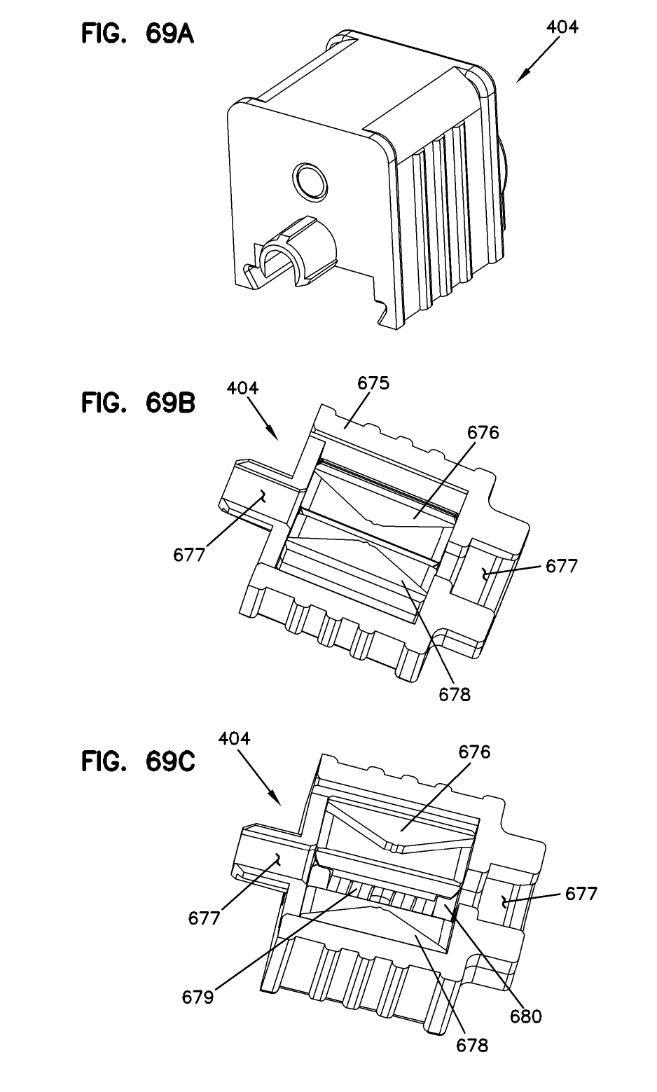

As illustrated in FIGS. 69B and 69C, the cable clamp 404 is movable between an open position (FIG. 69C) and a clamping position (FIG. 69B). In some examples, the cable clamp 404 is a spring biased toward the clamping position. For example, the cable clamp 404 includes a clamp body 675 defining a cable port 677. The clamp body 675 contains two interlocking prongs 676 and 678 and a spring element 680 that is wedged between the prongs 676 and 678 to draw the prongs 676 and 678 shut. In the open position, the prongs 676 and 678 are spaced apart to form a cable passageway 679, which is aligned with the cable port 677, through which the cable 200 is inserted. In the clamping position, the prongs 676 and 678 are closed to clamp the cable 200.

As illustrated in FIG. 62, the cable preparation tool 20 includes a cable clamp holding and release mechanism 682. The cable clamp holding and release mechanism 682 operates to move the cable clamp 404 to the open position when the cable clamp 404 is loaded into the cable clamp mounting pocket 30, hold the cable clamp 404 in the open position, and release the cable clamp 404 to allow the cable clamp 404 to move to the clamping position when the actuator 42 is depressed.

In some examples, the cable clamp holding and release mechanism 682 is integrated with the second cutting structure 512. The cable clamp holding and release mechanism 682 can include a clamp engagement element 684 coupled to the second cutting structure 512. For example, the clamp engagement element 684 can be pivotally coupled to the movable scissor blade 652 of the second cutting structure 512. A spring element 686 can be connected between the clamp engagement element 684 and the movable scissor blade 652 to bias the clamp engagement element 684 in position relative to the movable scissor blade 652.

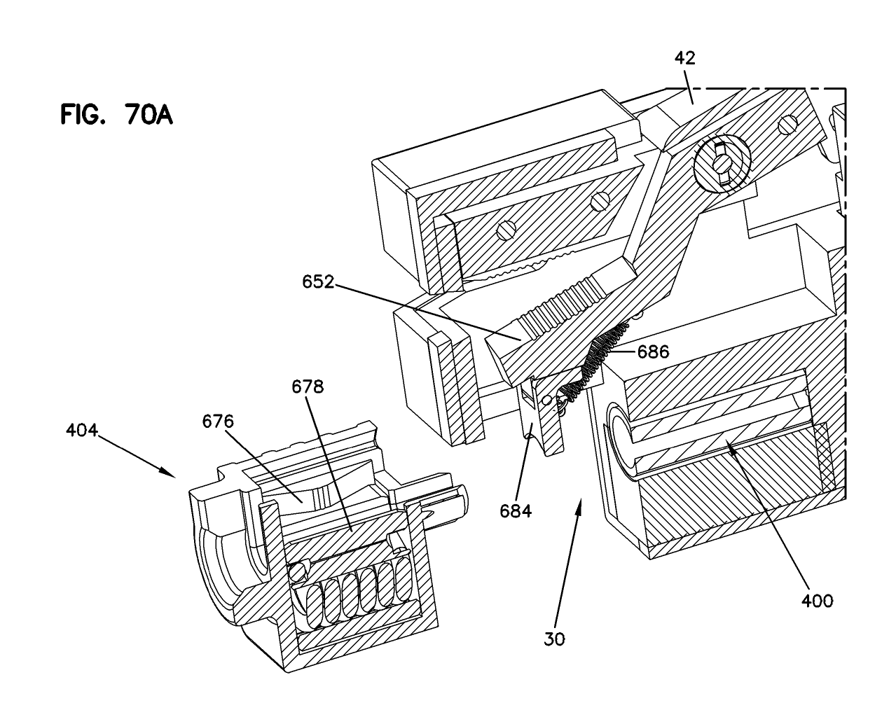

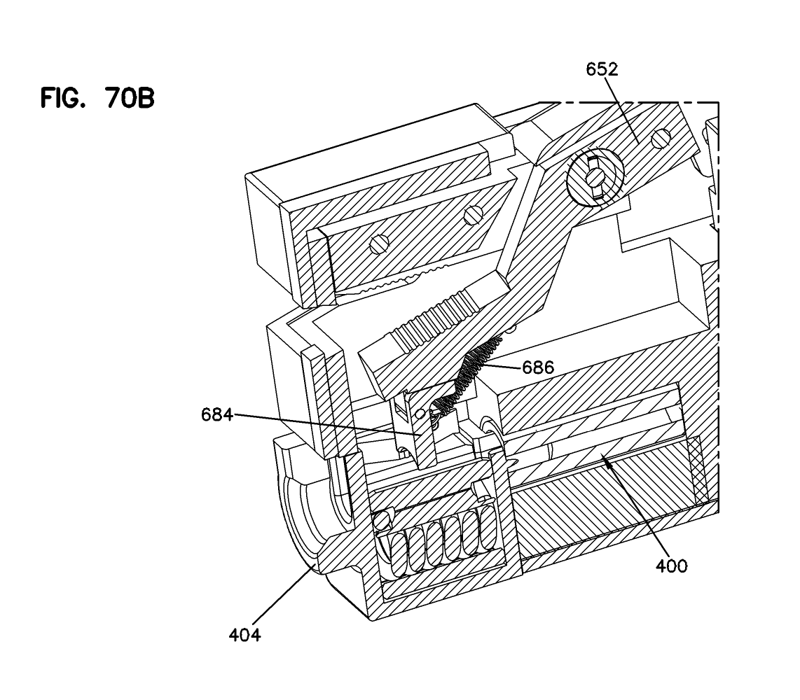

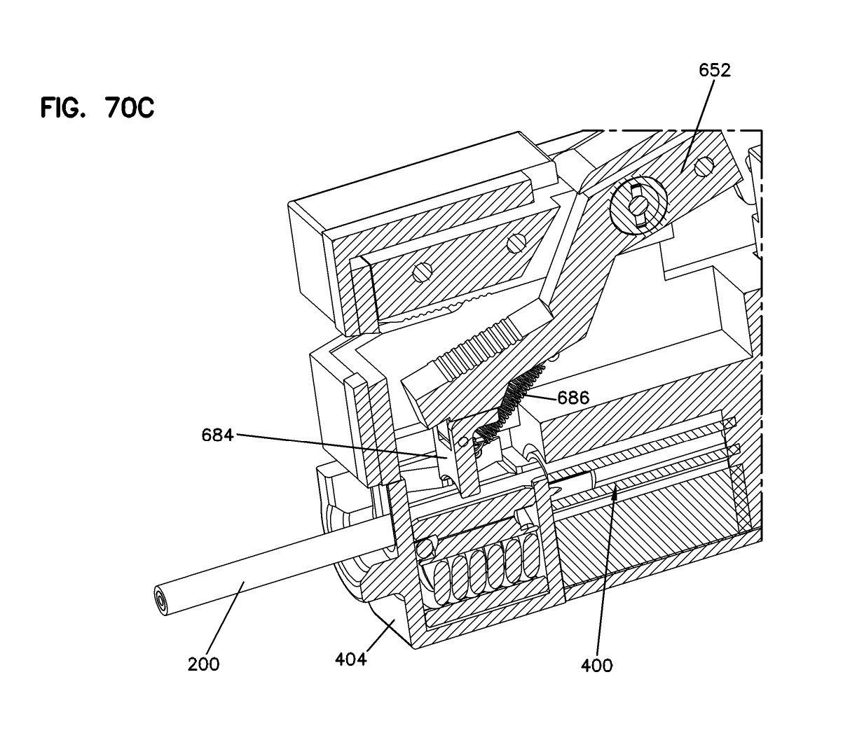

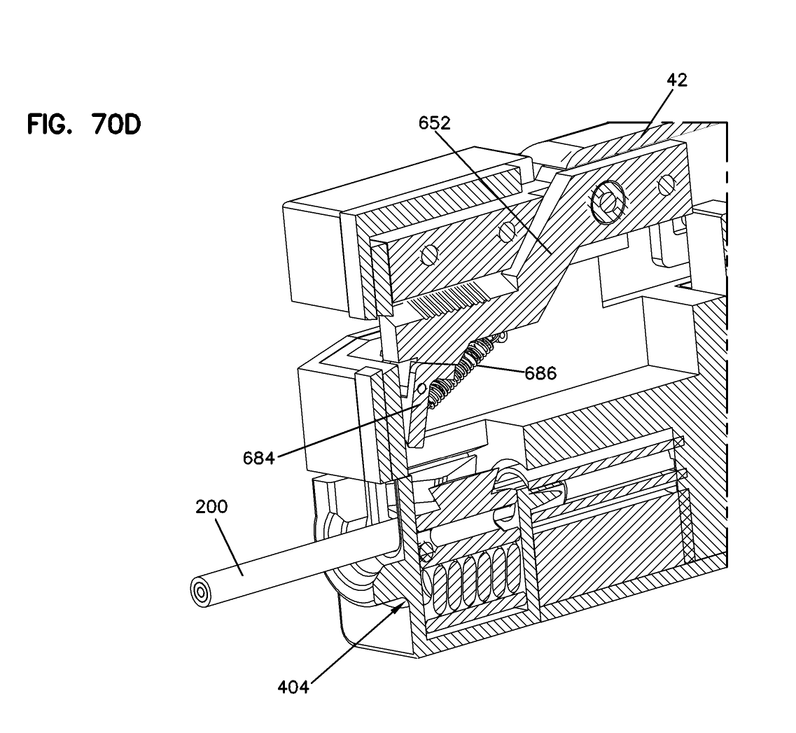

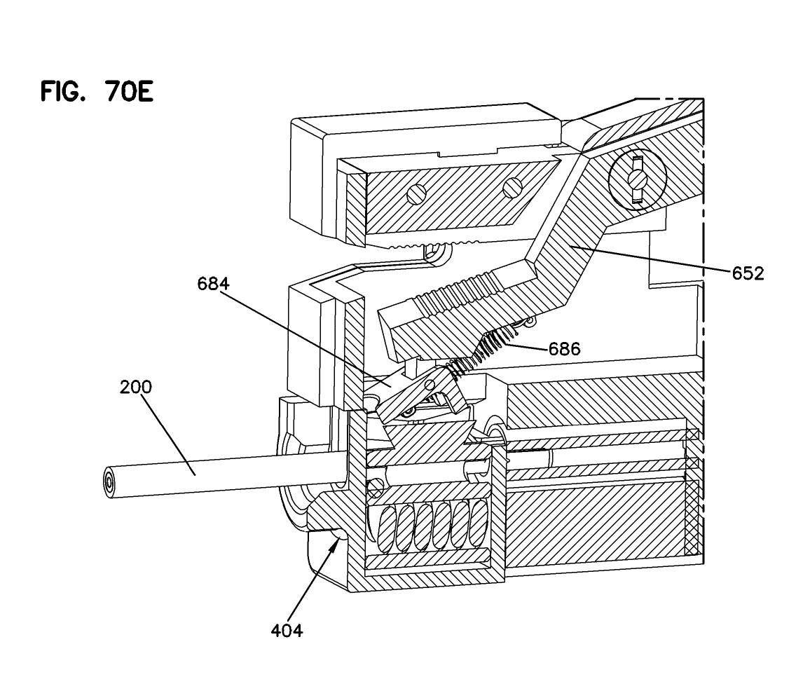

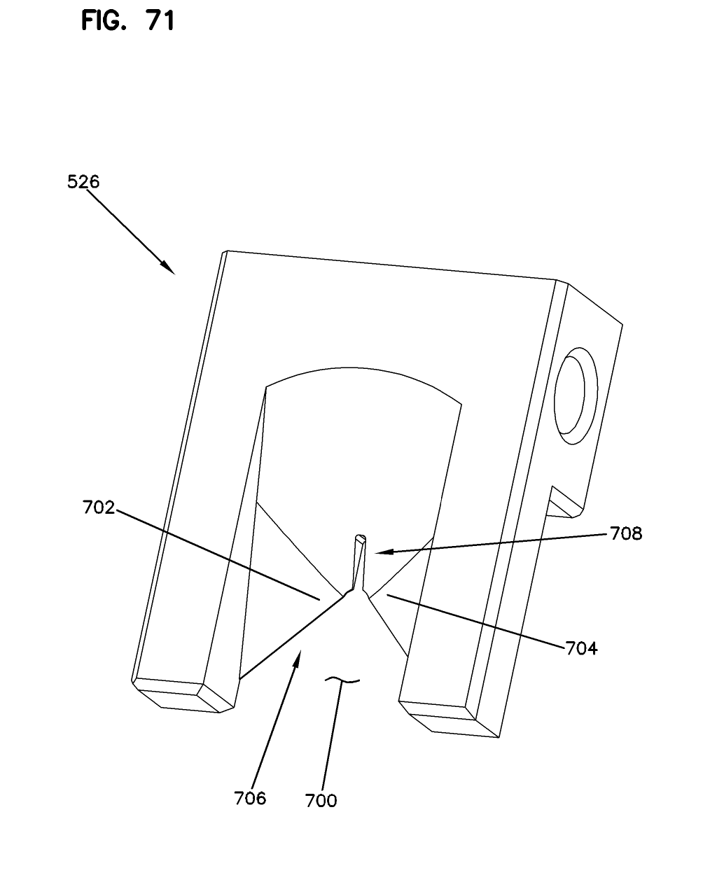

Referring to FIGS. 70A-E, example operations of the cable clamp 404 is described and illustrated in more detail. The operations of the cable clamp 404 are substantially the same as illustrated in FIGS. 15-31. The cable preparation tool 20 operates to move the cable clamp 404 from the clamping position to the open position and holds the cable clamp 404 in the open position when the cable clamp is loaded into the cable clamp mounting pocket.

As illustrated in FIG. 70A, before the cable clamp 404 is loaded into the cable clamp mounting pocket 30 of the housing 22, the heat-shrink sleeve 400 is loaded into the sleeve receptacle 29 of the cable preparation tool 20. In this stage, the actuator 42 remains in the non-depression orientation, and the cable clamp 404 is in the clamping position. The cable clamp 404 is then loaded at the clamp mounting pocket 30 directly above the pre-loaded heat-shrink sleeve 400. As the cable clamp 404 slides into the cable clamp mounting pocket 30, the clamp engagement element 684 remains in a first position relative to the movable scissor blade 652 by the spring element 686, and engages between the two prongs 676 and 678 of the cable clamp 404 to spread out the prongs 676 and 678, resulting in the open position of the cable clamp 404. As illustrated in FIG. 70B, the cable clamp 404 is in the open position to provide the cable passageway 679 through which the cable 200 passes within the housing 22. As illustrated in FIG. 70C, the cable 200 is inserted through the cable port 677 and the cable passageway 679 defined by the cable clamp 404 that is in the open position. The cable 200 is further inserted into the cable preparation tool 20. In some embodiments, the cable 200 is inserted into the cable receiving passage until the pre-cut end of the cable 200 is visible through the cable viewing location 36 adjacent the first cutting structure 510. In some embodiments, before the cable 200 is loaded, the connector boot 406 can be loaded into the cable clamp 404, as illustrated in FIG. 18.

As illustrated in FIG. 70D, when the actuator 42 is depressed, the cable preparation tool 22 releases the cable clamp 404 and allows the cable clamp 404 to move from the open position to the clamping position. For example, as the actuator 42 is depressed, the clamp engagement element 684 is raised and separated from the prongs 676 and 678 of the cable clamp 404, thereby enabling the cable clamp 404 to return to the clamping position. As the actuator 42 is released to return to the non-depression orientation, the clamp engagement element 684 does not change the cable clamp 404 back to the open position. Thus, the cable clamp 404 remains at the clamping position. As illustrated in FIG. 70E, although the clamp engagement element 684 remains abutted with the closed prongs 676 and 678 by the spring element 686, the spring element 686 does not exert sufficient force to make the clamp engagement element 684 to spread the closed prongs 676 and 678 apart and return the cable clamp 404 to the open position. The spring element 686 operates to return the clamp engagement element 684 to its initial position as shown in FIG. 70A after the cable clamp 404 is removed from the cable preparation tool 20. As illustrated in FIG. 21, the cable clamp 404 stays on the cable 200 for subsequent processes as illustrated in FIGS. 22-31. In some embodiments, the cable clamp 404 continues to hold the heat-shrink sleeve 400 and the boot 406, as illustrated in FIGS. 22-31.

Referring to FIGS. 61-63 and 71-72, an example structure is described to prevent the cable 200 (e.g., the jacket thereof) from being caught in the fixed blade 526 of the scoring structure 512 when the cable 200 is removed from the cable preparation tool 20.

As described above, the scoring structure 512 includes the first scoring blade 524 and the second scoring blade 526, which cooperate to score the jacket of the cable 200. As illustrated in FIG. 71, the second scoring blade 526 can include a scoring slot 700 defined at least partially by opposing scoring edges 702 and 704. The scoring slot 700 has a tapered transition portion 706 and an elongated portion 708. The tapered transition portion 706 is configured to transition to the elongated portion 708. The opposing scoring edges 702 and 704 are angled relative to one another at the tapered transition portion 706 and are parallel to one another at the elongated portion 708.

In addition, or alternatively, to the scoring slot 700 of the second scoring blade 526, the cable preparation tool 20 can include a resilient cable support 720 positioned adjacent the cable scoring structure 512. The resilient cable support 720 operates to push the cable 200 out of the second scoring blade 526 after scoring. In some examples where it is used with the scoring slot 700, the resilient cable support 720 can be configured to resiliently yield to allow the cable 200 to move into the elongated portion 708 of the scoring slot 700 during cable scoring, and the resilient cable support 720 is configured to push the cable 200 out of the elongated portion 708 of the scoring slot 700 after scoring. Thus, when the cable 200 is manually withdrawn from the cable preparation tool 20, the scored jacket does not catch on the elongated portion 708 of the scoring slot 700. The scored jacket is therefore prevented from becoming jammed in the cable preparation tool 20.

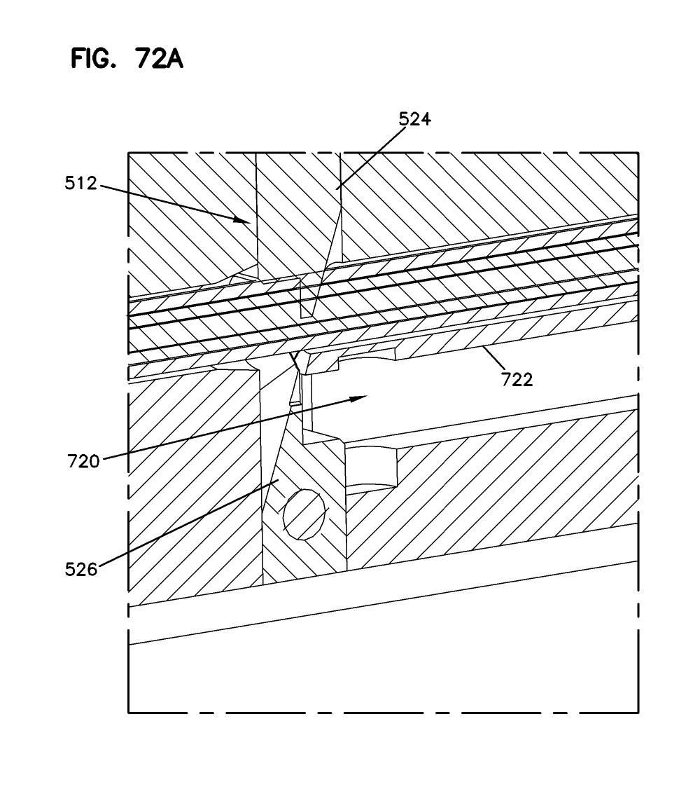

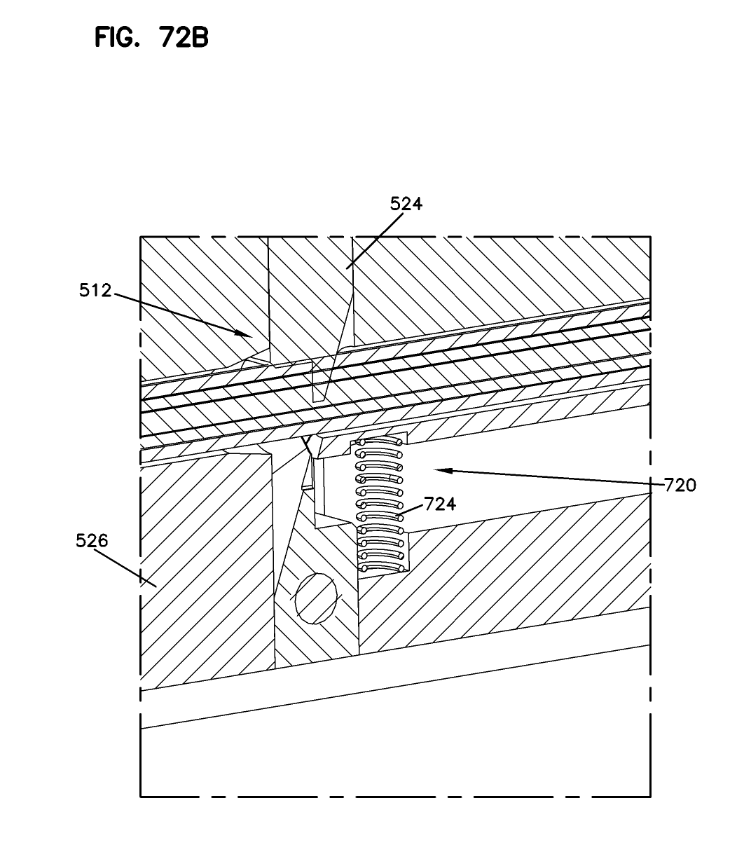

In some examples, the resilient cable support 720 can include an elastic deformation beam on a bottom side of the housing 22, as illustrated in FIG. 72A. In other examples, the resilient cable support 720 can include a spring element 724 for supporting the cable 200. In yet other examples, the elastic deformation beam and the spring element 724 can be used together.

Referring again to FIGS. 61-63, the cable preparation tool 20 can include a debris collection box 740 for collecting debris from cutting the cable 200. In some embodiments, the debris collection box 740 is also used as the cable viewing location 36.

As described herein, the cable preparation tool 20 can include a plurality of cutting and/or scoring structures to perform multiple functions. The cable preparation tool 20 is also configured to be used for cables with various dimensions. For example, the cable preparation tool 20 is adapted to cut fiber optic cables with a diameter from 0.5-5.0 mm. In other examples, the cable preparation tool 20 can be used for fiber optic cables with a diameter from 1.2-3.0 mm. The cable preparation tool 20 eliminates need of measuring a length of cable before cutting and/or scoring, and allows cutting and scoring a cable to a length as necessary. The cable preparation tool 20 includes the counter 501 for measuring cutting times and indicating life cycle of the tool. By using the actuator 42 having the primary and secondary pivotal actuator levers, the cable preparation tool 20 reduces force required to sever and/or score a cable, thereby making it easy to operate the tool.

The various examples and teachings described above are provided by way of illustration only and should not be construed to limit the scope of the present disclosure. Those skilled in the art will readily recognize various modifications and changes that may be made without following the example examples and applications illustrated and described herein, and without departing from the true spirit and scope of the present disclosure.

### LIST OF REFERENCE NUMERALS AND CORRESPONDING FEATURES

20 cable preparation tool
22 housing
24 first end
26 second end
28 component pre-assembly location
29 sleeve receptacle
30 clamp mounting location
31 dovetail-shaped projection
32 clamp storage
34 cable receiving passage
36 cable viewing location
38 second cutting station
40 slot
42 actuator
44 docking receptacle or station
45 receptacle
50 heating component
51 heating elements
51A heating elements
51B heating elements
52 base
54 connector receptacle
56 cover
58 slot
115 connectorization tool
120 cable preparation tool
122 main body
124 axis
125 cable passage
126 first end
128 second end
130 cable scoring structure
132 cable cutting structure
134 rotary actuator
136 pivotal handle
138 pivot axis
200 cable
202 optical fiber
204 buffer layer
206 jacket
208 strength layer
300 cable
302 optical fiber
304 buffer layer
306 cable jacket
310 strength layer
312 first reinforcing strands
314 second reinforcing strands
320 stripped segment
400 heat-shrink sleeve
402 viewing window
404 cable clamp
406 boot
408 end portion
409 end
410 ring-cut
412 end
414 hook
415 connector installation tool or connectorization tool
416 fiber optic connector
418 clamp disengagement tool
501 counter
502 handle portion
504 support portion
510 first cutting structure
512 scoring structure
514 second cutting structure
517 hinge
518 first movable blade
520 first fixed blade
521 intermediate slide link
522 first hinge
523 serrated edge
524 second movable blade
525 serrated edge
526 second fixed blade
528 second hinge
536 rearward end
538 forward end
542 first actuator hinge
544 forward end
546 rearward end
548 second actuator hinge
552 spring member
602 batteries
604 fans
606 loading tray
608 first solenoid control system
610A rounded contact surfaces
610B rounded contact surfaces
611 control boar
612 second solenoid control system
622 handle
624 cable clips
626 first mounting device
628 second mounting device
630 cable clips
652 movable scissor blade
654 fixed scissor blade
670 cable clamp
672 cable clamp mounting pocket
675 clamp body
676 prong
677 cable port
678 prong
679 cable passageway
680 spring element
682 release mechanism
684 clamp engagement element
686 spring element
700 scoring slot
702 scoring edge
704 scoring edge
706 tapered transition portion
708 elongated portion
720 resilient cable support
724 spring element
740 debris collection box

What is claimed is:

1. A cable preparation tool (20, 120) comprising:
a tool body (22, 122) defining a passage (34, 125) for receiving a fiber optic cable;
a first cutting structure (132, 38, 510, 514) integrated with the tool body for severing the fiber optic cable while the fiber optic cable is received within the passage; and
a scoring structure (130, 512) integrated with the tool body for scoring the fiber optic cable while the fiber optic cable is received within the passage, the scoring structure scoring the cable at a predetermined spacing from a cable severing location defined by the first cutting structure.

2. The cable preparation tool of claim 1, further comprising an actuator (42, 136) integrated with the tool body that simultaneously actuates the first cutting structure and the scoring structure.

3. The cable preparation tool of claim 2, wherein the actuator includes a pivotal actuator member configured to be depressed into the tool body.

4. The cable preparation tool of claim 2, wherein the actuator includes a primary pivotal actuator lever (502) and a secondary pivotal actuator lever (504) that are configured to be depressed into the tool body, the primary and secondary pivotal actuator levers being relatively positioned such that depression of the primary pivotal actuator lever causes simultaneous depression of the secondary pivotal actuator lever, the primary pivotal actuator lever being pivotally coupled to a first scoring blade (524) of the scoring structure (512) and the second pivotal actuator lever being pivotally coupled to the first cutting structure (510).

5. The cable preparation tool of claim 4, wherein the primary and secondary pivotal actuator levers are spring biased toward a non-depressed orientation.

6. The cable preparation tool of claim 4, wherein the primary pivotal actuator lever linearly moves the first scoring blade between a retracted position and a scoring position, and wherein the secondary pivotal actuator lever is pivotally coupled to a scissor blade (518) of the first cutting structure by an intermediate slide link (521) and pivotally moves the scissor blade of the first cutting structure between a retracted position and a cutting position.

7. The cable preparation tool of claim 6, wherein the scissor blade of the first cutting structure includes a serrated edge (523).

8. The cable preparation tool of claim 2, further comprising a counter (501) that is actuated each time the actuator is actuated.

9. The cable preparation tool of claim 6, further comprising a second cutting structure (514) including a scissor blade (652) pivotally coupled to the primary pivotal actuator lever such that the second cutting structure is actuated when the primary pivotal actuator lever is depressed, the second cutting structure being positioned adjacent to an open ended notch (40) defined by the tool body wherein strength members of a cable can be inserted into the open ended notch and severed by the second cutting structure.

10. The cable preparation tool of claim 9, further comprising a cable clamp mounting pocket (30) in alignment with the passage, the cable clamp mounting pocket being configured for receiving a cable clamp (404).

11. The cable preparation tool of claim 10, wherein the cable clamp is movable between an open position and a clamping position, wherein the cable clamp is spring biased toward the clamping position, and wherein the cable preparation tool moves the cable clamp from the clamping position to the open position and holds the cable clamp in the open position when the cable clamp is loaded into the cable clamp mounting pocket.

12. The cable preparation tool of claim 11, wherein the cable preparation tool releases the cable clamp and allows the cable clamp to move from the open positon to the clamping position when the actuator is depressed.

13. The cable preparation tool of claim 12, wherein the cable preparation tool includes a cable clamp holding and release mechanism (682) that moves the cable clamp to the open position when the cable clamp is loaded into the cable clamp mounting pocket, that holds the cable clamp in the open position and that releases the cable clamp to allow the cable clamp to move to the clamping position when the actuator is depressed, the cable clamp holding and release mechanism being integrated with the second cutting structure and including a clamp engagement element (684) coupled to the second cutting structure.

14. The cable preparation tool of claim 13, wherein the clamp engagement element is pivotally coupled to the scissor blade of the second cutting structure.

15. The cable preparation tool of claim 6, wherein the cable scoring structure includes a second scoring blade (526) that cooperates with the first scoring blade to score a cable jacket, the second scoring blade including a scoring slot (700) having tapered transition (706) that transitions to an elongated portion (708), wherein opposing scoring edges (702, 704) of the second scoring blade are angled relative to one another at the tapered transition and are parallel to one another at the elongated portion of the scoring slot.

16. The cable preparation tool of claim 15, further comprising a resilient cable support (720) positioned adjacent the cable scoring structure, the resilient cable support being configured to resiliently yield to allow the cable to move into the elongated portion of the scoring slot during cable scoring, and the resilient cable support being configured to push the cable out of the elongated portion of the scoring slot after scoring.

17. The cable preparation tool of claim 4, further comprising a second cutting structure coupled to the primary pivotal actuator lever such that the secondary cutting structure is actuated when the primary pivotal actuator lever is depressed, the second cutting structure being positioned adjacent to an open ended notch defined by the tool body wherein strength members of a cable can be inserted into the open ended notch and severed by the second cutting structure, the first and second cutting structures each including a pivotal scissor blade that cooperates with a fixed scissor blade to provide a cutting action, the pivotal scissor blade of the first cutting structure being pivotally connected to the secondary pivotal actuator lever by an intermediate slide link and the pivotal scissor blade of the second cutting structure being directly pivotally coupled to the primary pivotal actuator lever.

18. The cable preparation tool of claim 1, further comprising a staging location for holding a heat-shrink sleeve (400), a cable clamp (404), and a connector boot (406) in alignment with the passage.

19. The cable preparation tool of claim 1, wherein the tool body defines a viewing location (36, 402) for providing a visual indication when the cable has been inserted a sufficient distance into the passage.

20. The cable preparation tool of claim 18, wherein the staging location includes a receptacle (29) for receiving the heat-shrink sleeve.

21. The cable preparation tool of claim 18, wherein the staging location includes an interlock interface for retaining the cable clamp relative to the tool body.

22. The cable preparation tool of claim 18, wherein the boot mounts on the cable clamp.

23. The cable preparation tool of claim 1, wherein the cutting structure includes a first cutting structure (510), wherein the cable preparation tool includes a second cutting structure (38, 514) integrated with the tool body, the second cutting structure being configured to sever strength members of the fiber optic cable.

24. The cable preparation tool of claim 23, wherein the second cutting structure includes a slot (40) defined at an end of the tool body.

25. The cable preparation tool of claim 24, wherein the tool body defines an exterior clamp docking station (44) that aligns with the second cutting structure.

26. The cable preparation tool of claim 1, wherein the tool body is rectangular and includes opposite first and second ends, opposite major sides and opposite minor sides, wherein the tool body is sized to be hand-held and is elongated, wherein a staging location is provided at the first end of the tool body for staging a cable clamp (404), a heat shrink tube (400) and a connector boot (406) in co-axial alignment with the passage of the tool body, wherein the cutting structure includes a first cutting structure (510), wherein a second cutting structure (514) is provided at the first end of the tool body, and wherein a clamp docking station (44) is provided at one of the major sides in longitudinal alignment with the second cutting structure.

27. The cable preparation tool of claim 26, further comprising an actuator (42, 136) for actuating the first cutting structure, the second cutting structure, and the scoring structure.

28. The cable preparation tool of claim 27, wherein the actuator includes a pivot member (136, 502, 504) integrated into one of the minor sides of the tool body.

29. The cable preparation tool of claim 1, wherein the scoring structure includes a rotary actuator (134).

30. The cable preparation tool of claim 29, wherein the first cutting structure includes a pivotal actuator (42, 136).

31. The cable preparation tool of claim 1, wherein the tool body is elongated along a length, and the passage extends along the length.

32. The cable preparation tool of claim 31, wherein the passage extends completely through the length of the tool body.

33. A heating unit (50) comprising:
a main housing (52, 56) defining an interior heating chamber (54) configured to receive a fiber optic connector arrangement, the fiber optic connector arrangement including a connector body (416) attached to a fiber optic cable (200) and a heat shrink tube (400) for attaching the connector body to a cable jacket of the fiber optic cable, the main housing including passage for routing the fiber optic cable from the interior heating chamber out of the main housing; and
a heating arrangement (51) positioned at the interior heating chamber, the heating arrangement being configured to heat the heat shrink tube without heating the connector body.

34. The heating unit of claim 33, further comprising a slidable loading tray (606) for moving the fiber optic connector arrangement in and out of the interior heating chamber.

35. The heating unit of claim 34, wherein the loading tray is driven by a solenoid (608).

36. The heating unit of claim 35, wherein the loading tray is spring biased toward an ejected position and is moved to or held in a loaded position by the solenoid.

37. The heating unit of claim 33, wherein the heating arrangement includes positive temperature coefficient heaters.

38. The heating unit of claim 33, wherein the heating arrangement includes opposing heating elements (51A and MB) between which the heat shrink tube fits during heating, the opposing heating elements being movable between a closed position and an open position.

39. The heating unit of claim 38, wherein the heating elements are spring biased toward the closed position such that the heating elements can automatically move together as the heat shrink tube shrinks.

40. The heating unit of claim 39, further comprising a solenoid (612) for moving the heating elements toward the open position.

41. The heating unit of claim 40, wherein one of the heating elements is movable and the other heating element is fixed.

42. The heating unit of claim 39, wherein the heating elements have cylindrical contact surfaces (610A and 610B).

43. The heating unit of claim 33, further comprising a fan (604) for cooling the heat shrink tube before the loading tray can be moved from a loaded position to an ejected position.
